(19) United States
(12) Patent Application Publication
(10) Pub. No.: US 2024/0173682 A1
(43) Pub. Date: May 30, 2024

(54) CAPSULES AND METHODS FOR MIXING MULTIPLE SUBSTANCES

(71) Applicant: Capsulab Ltd, Ramat Gan (IL)

(72) Inventors: Dov MEIRZON, Even-Yehuda (IL); Gal SAAR, Shoham (IL)

(73) Assignee: Capsulab Ltd, Ramat Gan (IL)

(21) Appl. No.: 18/283,227

(22) PCT Filed: Mar. 22, 2022
(86) PCT No.: PCT/IL2022/050320

§ 371 Date: Sep. 21, 2023

Related U.S. Application Data
(60) Provisional application No. 63/163,990, filed on Mar. 22, 2021.
(60) Provisional application No. 63/167,691, filed on Mar. 30, 2021.

(30) Foreign Application Priority Data
Feb. 16, 2022 (WO) 113652
Feb. 16, 2022 (WO) 113663

(51) Int. Cl. B01F 25/90; B01F 27/1123; B01F 35/22; B01F 35/71

(52) U.S. Cl. CPC B01F 25/90; B01F 27/1123; B01F 35/2207; B01F 35/7162

(57) ABSTRACT

A capsule for mixing substances includes a chamber having first and second ends. A piston is fitted in the chamber. The piston has a proximal end facing the first end, and a distal end facing the second end. A mixer element is arranged within the chamber between the piston and the second end. The mixer element is disposed at a distal end of a mixer rod. The piston has an aperture through which the mixer rod passes. The piston and mixer element are separately displaceable relative to the first and second ends and relative to each other. The piston includes a plurality of cavities within the piston, such that one cavity is separated from another cavity and filled with a different ingredient substance.

### RELATED APPLICATIONS

This application claims the benefit of priority of U.S. Provisional Patent Application No. 63/163,990 filed on 22 Mar. 2021, U.S. Provisional Patent Application No. 63/167,691 filed on 30 Mar. 2021, International Design Application No. WIPO113663 filed 16 Feb. 2022 and International Design Application No. WIPO113652 filed 16 Feb. 2022, the contents of which are incorporated herein by reference in their entirety.

### FIELD AND BACKGROUND OF THE INVENTION

The present invention, in some embodiments thereof, relates to capsules and methods of mixing multiple substances therein, and more specifically, but not exclusively, to systems and methods for mixing and preparing formulations for consumer use.

In recent years, consumers of toiletries, personal care items, food additives, nutritional supplements, and pharmaceutical compositions are expressing a growing need for custom-made, personalized, modular, and/or do-it-yourself preparations of ingredients. To meet this need, various capsules have been designed that contain separate compartments for different substances and a mechanism for mixing those substances when desired. Examples of such capsules are disclosed in International Patent Publication WO2020/105053, entitled Capsule, Device and Method for Mixing Multiple Substances, and U.S. Provisional Application 63/030,580, filed May 27, 2020, entitled Capsule, Device and Method for Mixing Multiple Substances, both of which were invented by the same inventors and are assigned to the same assignee as the present application. The contents of these applications are incorporated by reference as if fully set forth herein.

The capsules described in the above-mentioned applications generally feature a main chamber and a plurality of repository tubular chambers that are peripheral to the main chamber. The repository tubular chambers include separate ingredient substances. To prepare a custom-made composition, a user attaches the capsule to a mixing machine, uses a pushing rod from the mixing machine to displace each of the desired substances from the repository tubular chamber into the main chamber, and mixes the substances within the main chamber.

### SUMMARY OF THE INVENTION

The capsules described in the above-referenced disclosures feature separate repository tubular chambers, peripheral to a central mixing chamber, for each substance. This arrangement introduces a certain degree of complexity into the design of the capsule, and also requires the capsule to have a comparatively large size. It is accordingly an object of the present disclosure to describe a capsule having a single chamber that may be used to prepare and mix custom-made formulations.

According to an aspect of some embodiments of the present invention there is provided a capsule for mixing substances. The capsule includes a chamber having a first end and a second end. A piston is fitted in the chamber. The piston has a proximal end facing the first end, and a distal end facing the second end. A mixer element is arranged within the chamber between the piston and the second end. The mixer element is disposed at a distal end of a mixer rod. The piston has an aperture through which the mixer rod passes. The piston and mixer element are separately displaceable relative to the first and second ends and relative to each other. At least one ingredient receptacle is filled with an ingredient substance and configured within the chamber between the proximal end of the piston and the mixer element. Advantageously, each ingredient substance may be removed from its receptacle due to displacement of the piston and mixer element relative to each other, without requiring storage of the ingredient substances in a separate chamber.

Optionally, the piston comprises a plurality of cavities, each cavity containing a different ingredient substance. The cavities provide a location for separate storage of each ingredient substance within the chamber, prior to mixing.

More optionally, each cavity is an ingredient receptacle. In such an implementation, each ingredient substance is stored loosely within the cavity.

More optionally, each ingredient receptacle comprises a frangible container arranged within a respective cavity. The substance is released when the frangible container is burst.

According to an aspect of some embodiments of the present invention there is provided a capsule for mixing substances. The capsule includes a chamber having a first end and a second end. A piston is fitted in the chamber. The piston has a proximal end facing the first end, and a distal end facing the second end. A mixer element is arranged within the chamber between the piston and the second end. The mixer element is disposed at a distal end of a mixer rod. The piston has an aperture through which the mixer rod passes. The piston and mixer element are separately displaceable relative to the first and second ends and relative to each other. The piston has a plurality of cavities within the piston, such that one cavity is separated from another cavity and filled with a different ingredient substance.

Optionally, each of the plurality of cavities is a cylindrical aperture having a proximal opening at a proximal end of the piston and a distal opening at a distal end of the piston.

More optionally, at least one of the proximal opening and the distal opening of each of the plurality of cavities is sealed by a frangible seal.

Optionally, each cavity comprises a frangible container containing an ingredient substance and arranged within the cavity.

Optionally, the mixer rod having an adapter disposed at a proximal end thereof which is adapted to connect to an arm of a mixer device and transfer motion from the mixer device to the mixer rod.

Optionally, the capsule comprises a proximal pistons arrangement closer to the first end than the piston. The proximal pistons arrangement includes a plurality of proximal pistons. Each proximal piston is aligned with a respective cavity, such that depression of the proximal pistons relative to the piston causes the proximal pistons to enter the cavities. As a result of the entering of the proximal pistons into the cavities, the ingredient substances are expelled out of the cavities and into the chamber.

More optionally, at least one sharp tip is disposed on a distal face of each proximal piston, a proximal face of the mixer element, or a proximal face of a plate arranged between the piston and the mixer element. Each sharp tip is configured to puncture a frangible container when the proximal pistons arrangement and mixer element are compressed relative to each other. Use of sharp tips allows for frangible containers that are sufficiently resilient to remain closed when the capsule is subjected to typical pressure forces.

More optionally, the proximal pistons arrangement comprises a plate, and the plurality of proximal pistons are attached the plate, such that the plurality of proximal pistons are movable in sync relative to the plurality of cavities. Advantageously, a mixing machine used to move the plate need not be configured to move individual proximal pistons separately, allowing for a simpler construction.

More optionally, the plurality of proximal pistons comprises a plurality of separate pistons. Each separate piston is separately movable relative to a respective cavity. Advantageously, separate movement of the pistons allows for greater control over which ingredients are inserted into the chamber.

Optionally, the at least one ingredient receptacle comprises a plurality of frangible containers arranged between the distal end of the piston and the mixer element. Advantageously, the frangible containers are comparatively easy to fill and insert into the chamber, and may be inserted in any orientation between the piston and the mixer element.

Optionally, the capsule further comprises a plurality of frangible containers arranged between the distal end of the piston and the mixer element, each filled with an ingredient substance.

Optionally, when the piston and mixer element are compressed relative to each other, the plurality of frangible containers burst, releasing the ingredient substances into the chamber. Advantageously, pressure may be sufficient to burst the frangible containers, without any additional piercing elements.

Optionally, the capsule further comprises at least one sharp tip disposed on a distal face of the piston, a proximal face of the mixer element, or a proximal face of a plate arranged between the piston and the mixer element. Each sharp tip is configured to puncture a frangible container when the piston and mixer element are compressed relative to each other. Use of sharp tips allows for frangible containers that are sufficiently resilient to remain closed when the capsule is subjected to typical pressure forces.

Optionally, either the piston or the mixer element comprises at least one cavity, each cavity shaped to receive a corresponding sharp tip when the piston and mixer element are compressed relative to each other. Advantageously, the cavities provide a backstop for the sharp tips, allowing for complete penetration of the frangible containers by the sharp tips.

Optionally, a protective layer is arranged between the at least one sharp tip and the plurality of frangible containers. The protective layer is pierceable by the at least one sharp tip only upon application of a predetermined pressure. Advantageously, the protective layer prevents accidental piercing of the containers.

Optionally, the plurality of frangible containers are stacked one on top of the other between the piston and the mixer element. Optionally, the plurality of frangible containers are arranged alongside one another between the piston and the mixer element. Optionally, the plurality of frangible containers comprises an accordion-shaped receptacle, and folds of the accordion-shaped receptacle demarcate between a plurality of storage pockets, each storage pocket containing a different ingredient substance. Advantageously, the frangible containers may take any such suitable shape.

Optionally, each of the frangible containers is configured to burst when subjected to a predetermined pressure, wherein the predetermined pressure is greater than an ambient pressure exerted by other contents of the capsule on the frangible containers. This requirement of a minimum bursting pressure prevents accidental bursting of the containers.

Optionally, the mixer rod is moving helically relative to the piston and thereby rotating the mixer element.

More optionally, the capsule further comprises a screw-like arrangement of helical grooves and helical ridges which is converting movement of an arm of a mixer device into helical movement of the mixer rod.

More optionally, helical movement of the mixer rod is created using one of helical grooves and helical ridges of the mixer rod.

More optionally, helical movement of the mixer rod is created using one of helical grooves and helical ridges rigidly connected to the mixer rod.

More optionally, the mixer rod is engaged with an arm of a mixer device, wherein the arm is moving helically and thereby causing the mixer rod to move helically.

More optionally, the aperture includes one of helical grooves, helical ridges, and at least one protrusion; and the mixer rod includes a corresponding one of helical grooves, helical ridges, and at least one protrusion; so that force applied on the mixer rod in the direction of the axis of the mixer rod causes the mixer rod to move helically inside the aperture.

More optionally, the capsule further comprises a plate disposed at the proximal end of a mixer rod which includes an adapter aligned to receive therein an arm of a mixer device and an outer screw thread on an outer edge of the plate, wherein when the arm is rotating, the outer screw thread is engaged with an internal screw thread disposed at an inner surface of the main chamber, thereby causing the plate and the mixer rod to move helically.

More optionally, when the plate is moving helically, the plate is pushing at least one elongated chamber piston into the at least one elongated chamber to extract the ingredient substance into the main chamber.

Optionally, the mixer element and the mixer rod are separately displaceable relative to each other.

In another implementation according to the first aspect, a base substance is arranged within the chamber between the distal end of the piston and the second end. The base substance may be a relatively inert material, such as a cream, into which other ingredients are mixed. Because the base substance is part of all formulations made with the capsule, it may be stored in the chamber, without requiring an additional step to insert the cream into the chamber.

In another implementation according to the first aspect, a removable cover is arranged at the first end. The removable cover has a recess that is sized to retain the mixer element therein when the piston and mixer element are removed from the chamber. Advantageously, a user may easily remove the cover and internal parts of the capsule, storing the internal parts within the cover, and access the mixed formulation within the chamber.

Optionally, the cover further comprises a central perforation aligned with the mixer rod for receiving therein a torque arm adapted to rotate the mixer rod, and a plurality of peripheral perforations, each peripheral perforation aligned to receive therein a pushing rod for pushing the piston from the first end toward the second end. The perforations are designed to allow the torque arm and pushing rods through without causing shedding of the material of the cover into the chamber.

In another implementation according to the first aspect, the capsule includes at least one proximal piston closer to the first end than the piston. The recess is further sized to retain the proximal piston when the piston, mixer element, and proximal piston are removed from the chamber. Advantageously, the cover may be configured to include all internal components of the capsule, regardless of how many internal components are present.

Optionally, the mixer rod includes a barcode disposed on the surface of the mixer rod, wherein the barcode is detected by optical sensors of a mixer device when the mixer rod is moved.

More optionally, the barcode includes circumferential stripes around the mixer rod.

More optionally, the information encoded in the barcode includes information regarding at least one of the structure of the capsule and content of the capsule.

Optionally, the capsule further comprises a detachable container attached to an exit opening of the chamber.

More optionally, the exit opening includes a screw thread for attaching the container to the exit opening.

More optionally, the container includes is flexible and has a squeeze tube shape.

More optionally, the container body includes a flexible inner part and a rigid outer shell.

Optionally, the capsule further comprises a hand-operated reciprocating pump which is extracting substance from the chamber and out of the capsule.

More optionally, the capsule further comprises a roll-on ball disposed at a distal end of the chamber which is transferring substance from the chamber onto a user's skin.

According to an aspect of some embodiments of the present invention there is provided a method of mixing substances in a capsule. The method includes fixing a capsule to a mixer device having a linear actuator. The capsule includes a chamber having a first end and a second end. A piston is fitted in the chamber, having a proximal end facing the first end, and a distal end facing the second end. A mixer element is arranged in the chamber between a distal end of the piston and the second end. The mixer element is disposed at a distal end of a mixer rod. The piston has an aperture through which the mixer rod passes. The piston and mixer element are separately displaceable relative to the first and second ends and relative to each other. The capsule further includes a plurality of cavities within the piston, each filled with an ingredient substance. The method further includes, with the linear actuator, compressing the piston and the mixer element relative to each other to thereby extract the ingredient substances from the plurality of cavities and release the ingredient substance into the chamber.

Optionally, the capsule further comprises a proximal pistons arrangement closer to the first end than the piston, and the proximal pistons arrangement comprises a plurality of proximal pistons, each proximal piston aligned with a respective cavity. The method further comprises moving the proximal pistons and the piston relative to each other, thereby causing each of the proximal pistons to enter the respective cavity. As a result of the entering of the proximal pistons into the cavities, the ingredient substances are expelled out of the cavities and into the chamber.

More optionally, each cavity comprises a frangible container containing an ingredient substance and arranged within the cavity, and at least one sharp tip is disposed on a distal face of each proximal piston, a proximal face of the mixer element, or a plate arranged between the piston and the mixer element. The method further comprises puncturing a frangible container when a proximal piston and the mixer element are compressed relative to each other. Use of sharp tips allows for frangible containers that are sufficiently resilient to remain closed when the capsule is subjected to typical pressure forces.

More optionally, the proximal pistons arrangement comprises a plate, and the plurality of proximal pistons are attached to the plate. The method further comprises moving the plurality of proximal pistons and plurality of cavities relative to each other simultaneously Advantageously, a mixing machine used to move the plate need not be configured to move individual proximal pistons separately, allowing for a simpler construction.

More optionally, the plurality of proximal pistons comprises a plurality of separate pistons, and the method further comprises moving each separate piston separately relative to a respective cavity. Advantageously, separate movement of the pistons allows for greater control over which ingredients are inserted into the chamber.

Optionally, the compressing step comprises withdrawing the mixer element towards the first end. Advantageously, withdrawing of the mixer element towards the first end provides a greater space near the second end for collection of the released substances, without causing undue buildup of pressure in the chamber.

Optionally, the method further comprises rotating the mixer rod to thereby mix the released ingredient substances. Mixing is performed so as to provide an even distribution of ingredients in the formulation.

More optionally, the method further comprises, between the compressing and rotating steps, extending the mixer element toward the second end relative to the piston, to allow sufficient space within the chamber for mixing. The mixer element is thus extended to a central location within the chamber, allowing access to substances in the upper and lower portions of the chamber for mixing.

More optionally, the method further comprises, while rotating the mixer rod, pushing and pulling the mixer rod to move the mixer element inside the chamber. Advantageously, this pushing and pulling enables access to substances that are at the top and bottom of the chamber.

Optionally, the capsule further comprises a removable cover at the first end comprising a recess, the recess sized to retain the piston and mixer element therein when the cover is removed from the capsule. The method further comprises inserting the piston and mixer element into the cover, and removing the cover with the piston and mixer element retained therein. Advantageously, a user may easily remove the cover and internal parts of the capsule, storing the internal parts within the cover, and access the mixed formulation within the chamber.

According to an aspect of some embodiments of the present invention there is provided a method of mixing substances in a capsule. The method includes fixing a capsule to a mixer device having a linear actuator. The capsule includes a chamber having a first end and a second end. A piston is fitted in the chamber, having a proximal end facing the first end, and a distal end facing the second end. A mixer element is arranged in the chamber between a distal end of the piston and the second end. The mixer element is disposed at a distal end of a mixer rod. The piston has an aperture through which the mixer rod passes. The piston and mixer element are separately displaceable relative to the first and second ends and relative to each other. The capsule further includes at least one ingredient receptacle with an ingredient substance and configured within the chamber between the proximal end of the piston and the mixer element. The method further includes, with the linear actuator, compressing the piston and the mixer element relative to each other to thereby extract the ingredient substances from the at least one ingredient receptacle and release the ingredient substance into the chamber. Advantageously, each ingredient substance may be removed from its receptacle due to displacement of the piston and mixer element relative to each other, without requiring storage of the ingredient substances in a separate chamber.

Optionally, the piston comprises a plurality of cavities, each cavity containing a different ingredient substance, and the compressing step comprises extracting the ingredient substances from the cavities. The cavities provide a location for separate storage of each ingredient substance within the chamber, prior to mixing.

Optionally, the at least one ingredient receptacle comprises a plurality of frangible containers arranged between the distal end of the piston and the mixer element, and the compressing step comprises bursting the frangible containers. Advantageously, the frangible containers are comparatively easy to fill and insert into the chamber, and may be inserted in any orientation between the piston and the mixer element.

More optionally, the method comprises, during the compressing step, applying at least a predetermined pressure onto the plurality of frangible ingredient receptacles, said predetermined pressure greater than an ambient pressure exerted by other contents of the capsule on the plurality of frangible containers. This requirement of a minimum bursting pressure prevents accidental bursting of the containers.

More optionally, the method further comprises, during the compressing step, puncturing the plurality of frangible containers with at least one sharp tip disposed on a proximal face of the miser element, a distal face of the piston, or a plate arranged between the piston and the mixer element. Use of sharp tips allows for frangible containers that are sufficiently resilient to remain closed when the capsule is subjected to typical pressure forces.

According to an aspect of some embodiments of the present invention there is provided a method of assembling a capsule for mixing substances. The method comprises: (i) forming a chamber having a first end and a second end; (ii) inserting a mixer element disposed at a distal end of the mixer rod into the chamber; (iii) inserting at least one frangible ingredient container, each containing an ingredient substance, into the chamber, proximal to the mixer element; and (iv) inserting a piston having an aperture into the chamber, such that the piston has a proximal end facing the first end, and a distal end facing the second end, the mixer rod passes through the aperture, and each of the at least one frangible ingredient containers is configured between the proximal end of the piston and the mixer element. In a capsule formed according to this method, each ingredient substance may be removed from its receptacle due to displacement of the piston and mixer element relative to each other, without requiring storage of the ingredient substances in a separate chamber.

Optionally, the method further comprises inserting each of the at least one frangible ingredient containers into a respective cavity in the piston, and performing steps (iii) and (iv) simultaneously by inserting the piston and the at least one frangible ingredient container into the chamber. Advantageously, locating the frangible ingredient containers within the piston allows for the frangible containers to be inserted simultaneously, and to be burst when a proximal piston is depressed relative to the mixer element.

According to an aspect of some embodiments of the present invention there is provided a method of mixing substances in a capsule. The method comprising: (i) fixing a capsule to a mixer device having an actuator, the capsule comprising a chamber having a first end and a second end, a piston fitted in the chamber and having a proximal end facing the first end, and a distal end facing the second end, and a mixer element arranged within the chamber between a distal end of the piston and the second end, wherein the mixer element is disposed at a distal end of a mixer rod, and the piston has an aperture through which the mixer rod passes, and wherein the piston and the mixer element are separately displaceable relative to the first and second ends and relative to each other, and a plurality of cavities within the piston, each filled with an ingredient substance; (ii) extracting the ingredient substances from the plurality of cavities and release the ingredient substances into the chamber; and (iii) with the actuator, moving the mixer rod helically relative to the piston to thereby rotate the mixer element and mix the ingredient substances in the chamber.

Optionally, step (iii) comprises stacking the plurality of frangible ingredient receptacles around the mixer rod. Advantageously, the receptacles may be formed separately and inserted before or after the piston is inserted.

According to an aspect of some embodiments of the present invention there is provided a method of assembling a capsule for mixing substances. The method comprises: (i) forming a chamber having a first end and a second end; (ii) inserting a mixer element into the chamber, wherein the mixer element is disposed at a distal end of a mixer rod; (iii) filling a plurality of ingredient substances into a plurality of cavities within a piston (or into a plurality of ingredient receptacles arranged in respective cavities within a piston), wherein the piston comprises an aperture; (iv) inserting the piston in the chamber such that the piston has a proximal end facing the first end, and a distal end facing the second end, the mixer rod passes through the aperture, and the plurality of ingredient receptacles are configured between the proximal end of the piston and the mixer element; and (v) arranging a proximal pistons arrangement between the distal piston and the first end, wherein the proximal pistons arrangement comprises a plurality of proximal pistons, each proximal piston aligned with a respective cavity. Advantageously, the capsule is arranged such that the ingredients may be dispensed from the receptacles when the proximal pistons enter the cavities, and then may be subsequently mixed with the mixer element.

Optionally, the plurality of ingredient substances are filled inside frangible containers, and the filling step comprises inserting filled frangible containers into the cavities. The frangible containers store the substances separately while sealed, and allow for release of the substances when they are burst.

According to an aspect of some embodiments of the present invention there is provided a container. The container comprising: a container body having a container opening; and a container closure attached to the container body via the container opening, the container closure comprising: a piston fitted in the container closure; a mixer element arranged within the container closure between the piston and the container opening, wherein the mixer element is disposed at an end of a mixer rod, and the piston has an aperture through which the mixer rod passes; and at least one ingredient receptacle filled with an ingredient substance and configured within the container closure.

Optionally, the piston and the mixer element are separately displaceable relative to the container closure and relative to each other.

Optionally, the container opening includes a screw thread for attaching the container closure to the container body.

Optionally, the container body is flexible and has a squeeze tube shape.

Optionally, the container body includes a flexible inner part and a rigid outer shell.

According to an aspect of some embodiments of the present invention there is provided a capsule for mixing substances. The capsule comprising: (i) a main chamber having a first end and a second end; (ii) at least one elongated chamber filled with an ingredient substance; (iii) a main piston fitted in the chamber, the piston having a proximal end facing the first end, and a distal end facing the second end; (iv) a mixer element arranged within the chamber between the piston and the second end, wherein the mixer element is disposed at a distal end of a mixer rod, and the piston has an aperture through which the mixer rod passes; wherein the mixer rod is moving helically relative to the piston and thereby rotating the mixer element.

Optionally, the capsule further comprises a screw-like arrangement of helical grooves and helical ridges which is converting movement of an arm of a mixer device into helical movement of the mixer rod.

Optionally, helical movement of the mixer rod is created using one of helical grooves and helical ridges of the mixer rod.

Optionally, helical movement of the mixer rod is created using one of helical grooves and helical ridges rigidly connected to the mixer rod.

Optionally, the mixer rod is engaged with an arm of a mixer device, wherein the arm is moving helically and thereby causing the mixer rod to move helically.

Optionally, the aperture includes one of helical grooves, helical ridges, and at least one protrusion; and the mixer rod includes a corresponding one of helical grooves, helical ridges, and at least one protrusion; so that force applied on the mixer rod in the direction of the axis of the mixer rod causes the mixer rod to move helically inside the aperture.

Optionally, the capsule further comprises a plate disposed at the proximal end of a mixer rod which includes an adapter aligned to receive therein an arm of a mixer device and an outer screw thread on an outer edge of the plate, wherein when the arm is rotating, the outer screw thread is engaged with an internal screw thread disposed at an inner surface of the main chamber, thereby causing the plate and the mixer rod to move helically.

Optionally, when the plate is moving helically, the plate is pushing at least one elongated chamber piston into the at least one elongated chamber to extract the ingredient substance into the main chamber.

Optionally, the at least one elongated chamber is peripheral to the main chamber.

Optionally, the main piston comprises a plurality of cavities, each cavity is one of the at least one elongated chambers.

Optionally, the mixer element and the mixer rod are separately displaceable relative to each other.

According to an aspect of some embodiments of the present invention there is provided a device for mixing multiple substances in a capsule. The device comprising: (i) a fixture for a single capsule, the capsule having at least one elongated chamber filled with an ingredient substance; (ii) at least one pushing rod adapted to linearly push a main piston fitted in the capsule; and (iii) a torque arm for transferring helical movement to a mixer rod of the capsule along an axis of the mixer rod, wherein the mixer rod passes through an aperture of the main piston; wherein the mixer rod is rotating a mixer element disposed at an end of the mixer rod, thereby mixing the ingredient substance in a main chamber of the capsule.

Optionally, the at least one pushing rod is adapted to push at least one piston sealing the at least one elongated chamber, thereby extracting the ingredient substance into the main chamber.

Optionally, the device further comprises a motor which is driving the torque arm and the at least one pushing rod.

Optionally, the torque arm and the at least one pushing rod are moving simultaneously.

Optionally, the device further comprises a leadscrew which is converting rotational motion of a motor into a linear component of the helical movement.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the present disclosure may be practiced.

### In the Drawings

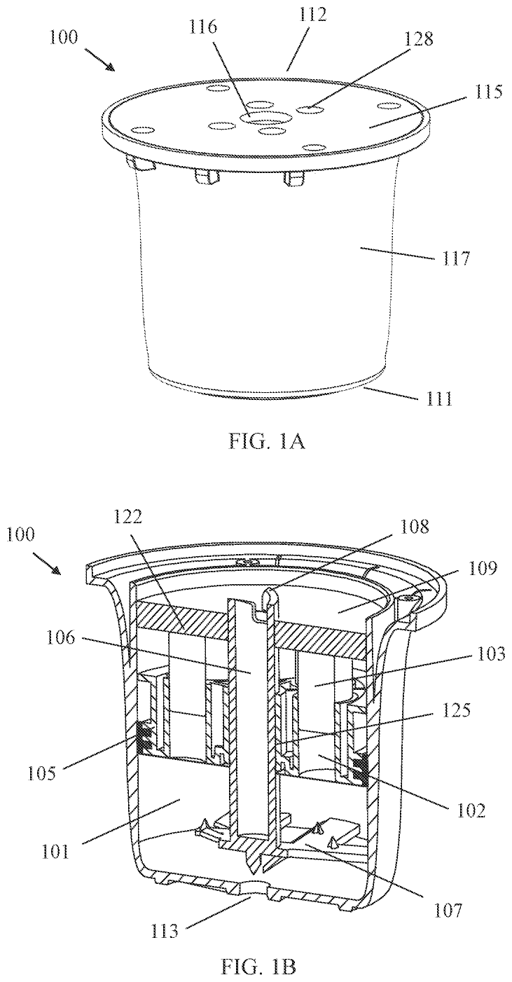

FIG. 1A is an upper perspective view of a first embodiment of a capsule, with a first end facing upward and a second end facing downward, and a flat cover, according to embodiments of the present disclosure;

FIG. 1B is an isometric view of a cross section of the capsule of FIG. 1A-B, with the cover removed, according to embodiments of the present disclosure;

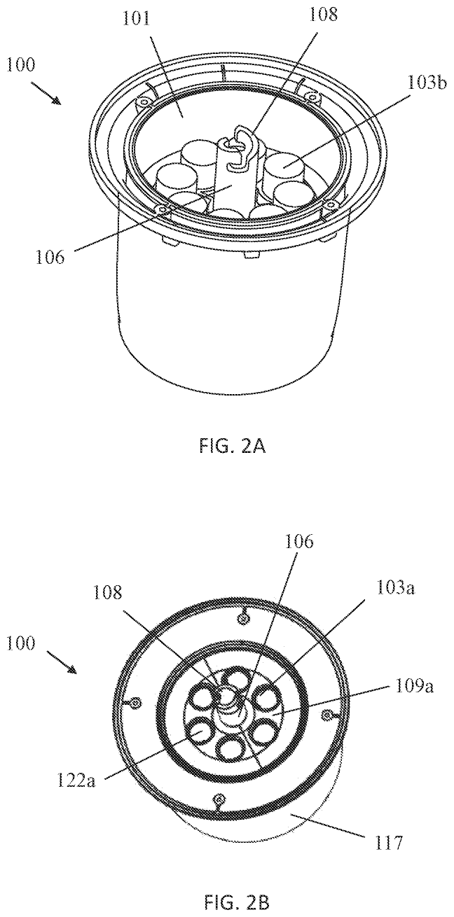

FIG. 2A is an upper perspective view of the capsule of FIG. 1A-B with the cover removed, and having a proximal pistons arrangement with eight separate proximal pistons, according to embodiments of the present disclosure;

FIG. 2B is an upper perspective view of the capsule of FIG. 1A-B with the cover removed, and having a proximal pistons arrangement with a plate and six proximal pistons, according to embodiments of the present disclosure;

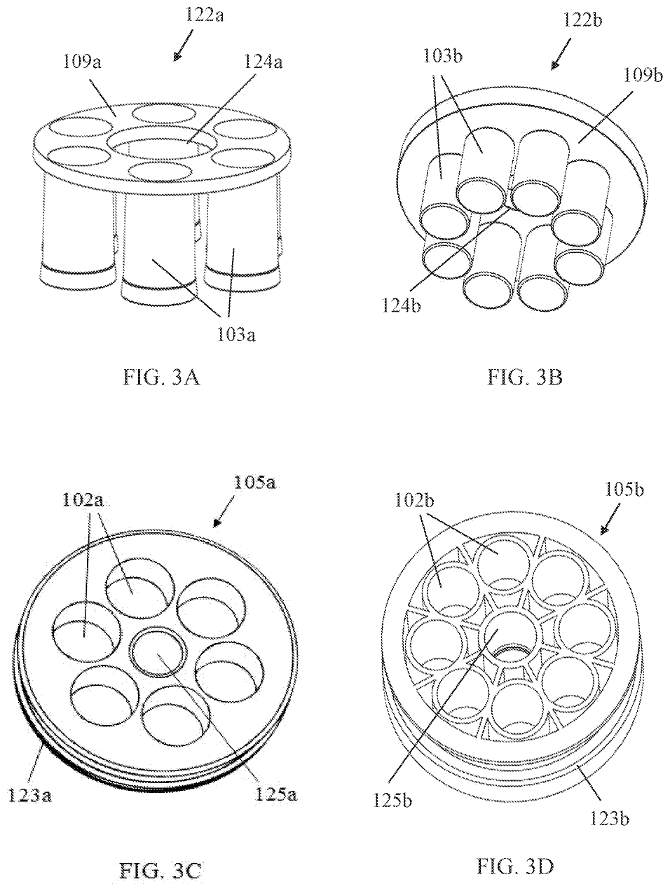

FIG. 3A is a perspective view of a proximal pistons arrangement with a plate and six proximal pistons, according to embodiments of the present disclosure;

FIG. 3B is a perspective view of a proximal pistons arrangement with a plate and eight proximal pistons, according to embodiments of the present disclosure;

FIG. 3C is a perspective view of a piston with six cavities for receiving therein the proximal pistons of FIG. 3A, according to embodiments of the present disclosure;

FIG. 3D is a perspective view of a piston with eight cavities for receiving therein the proximal pistons of FIG. 3B, according to embodiments of the present disclosure;

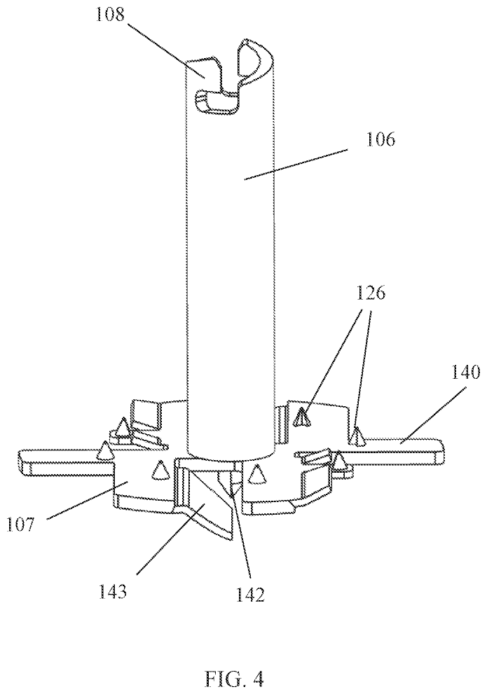

FIG. 4 is a perspective view of a mixer rod and mixer element, according to embodiments of the present disclosure;

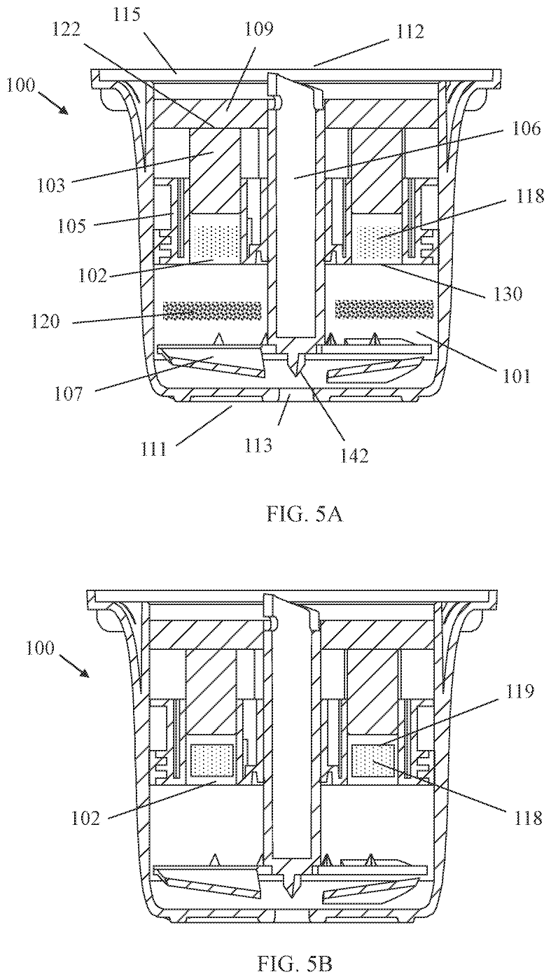

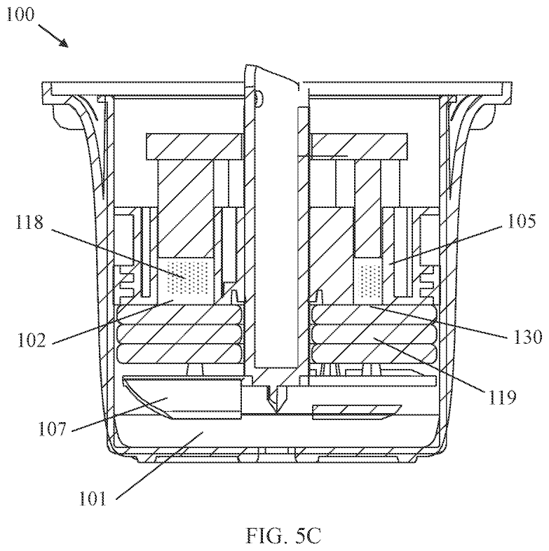

FIG. 5A is a cross-section view of the capsule of FIG. 1A-B, with ingredient substances stored in cavities in the piston, and with a base substance in the chamber, according to embodiments of the present disclosure;

FIG. 5B is a cross-section view of the capsule of FIG. 1A-B, with ingredient substances in frangible containers stored in cavities in the piston, according to embodiments of the present disclosure;

FIG. 5C is a cross-section view of the capsule of FIG. 1A-B, with ingredient substances stored in cavities in the piston and additionally stored in frangible containers between the piston and the mixer element, according to embodiments of the present disclosure;

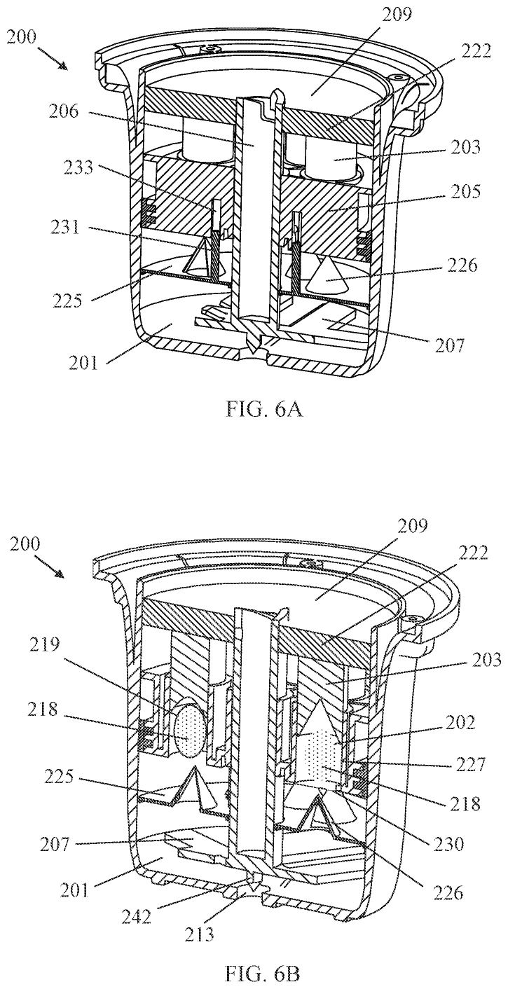

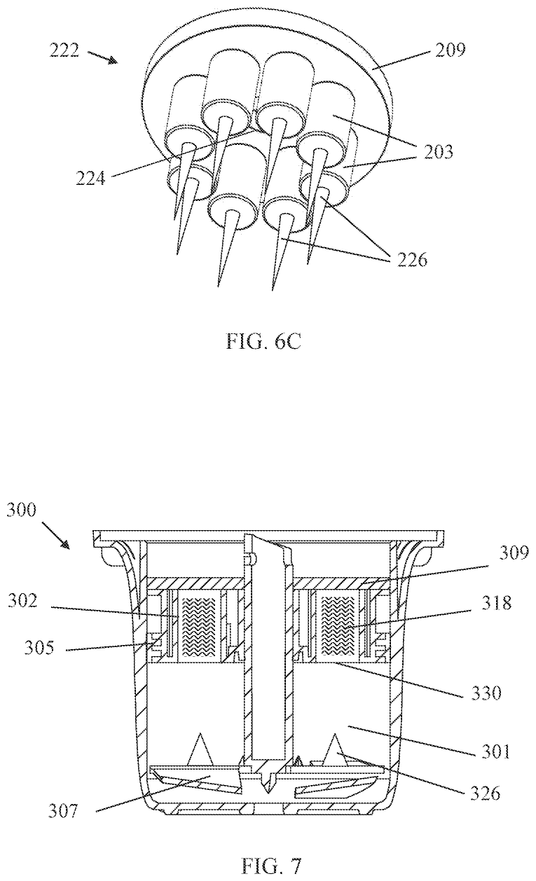

FIGS. 6A and 6B illustrate cross section views of a second embodiment of a capsule, showing sharp tips for piercing frangible receptacles, and cavities corresponding to the sharp tips, according to embodiments of the present disclosure;

FIG. 6C illustrates sharp tips on proximal pistons, according to embodiments of the present disclosure;

FIG. 7 illustrates a third embodiment of a capsule, showing sharp tips for piercing frangible receptacles, and cavities corresponding to the sharp tips, and without proximal pistons, according to embodiments of the present disclosure;

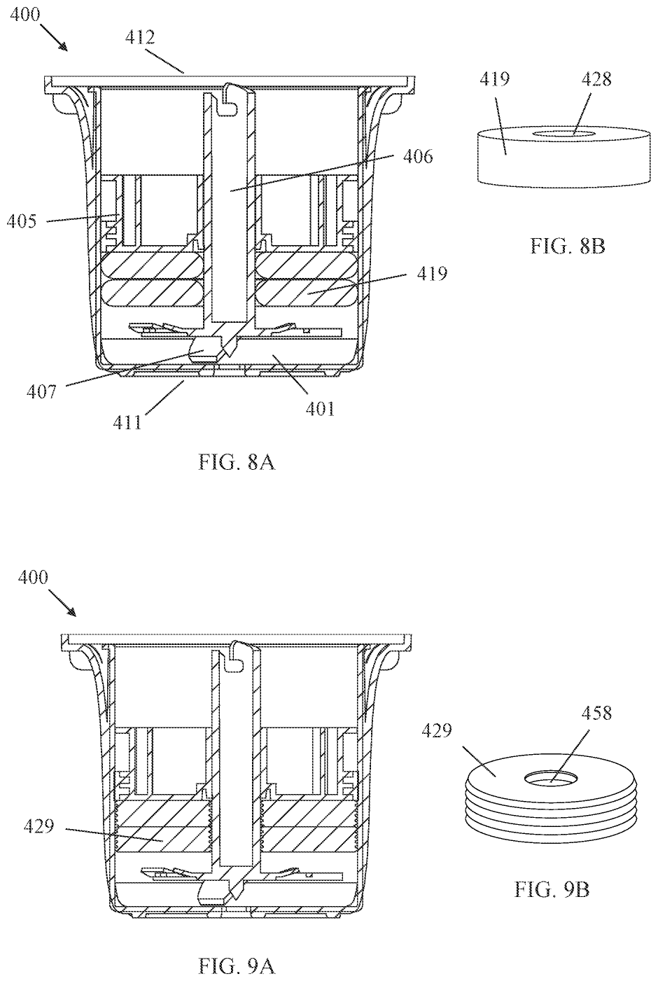

FIG. 8A is a cross-section view of a fourth embodiment of a capsule, having a plurality of bagel-shaped frangible ingredient receptacles stacked on top of each other between a piston and a mixer element, according to embodiments of the present disclosure;

FIG. 8B is a schematic depiction of the bagel-shaped receptacles of FIG. 8A, according to embodiments of the present disclosure;

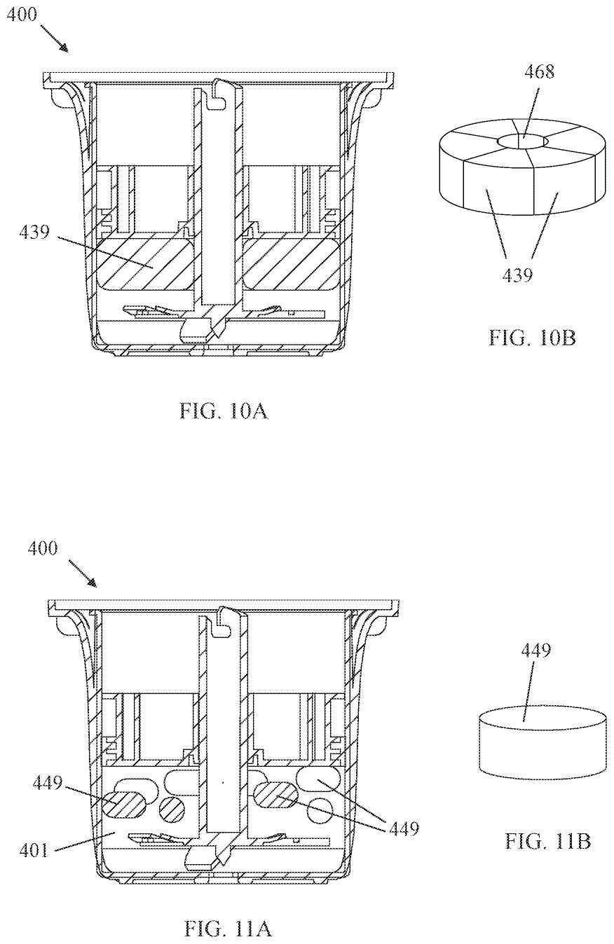

FIG. 9A is a cross-section view of a fifth embodiment of a capsule, having an accordion-shaped frangible ingredient receptacle, according to embodiments of the present disclosure;

FIG. 9B is a cross-section view of the accordion-shaped receptacle of FIG. 9A, according to embodiments of the present disclosure;

FIG. 10A is a cross-section view of a sixth embodiment of a capsule, having a plurality of wedge-shaped receptacles arranged alongside each other, according to embodiments of the present disclosure;

FIG. 10B is a cross-section view of the wedge-shaped receptacles of FIG. 10A, according to embodiments of the present disclosure;

FIG. 11A is a cross-section view of a seventh embodiment of a capsule, having a plurality of spherule-shaped receptacles arranged alongside each other, according to embodiments of the present disclosure;

FIG. 11B is a schematic depiction of the spherule-shaped receptacles of FIG. 11A, according to embodiments of the present disclosure;

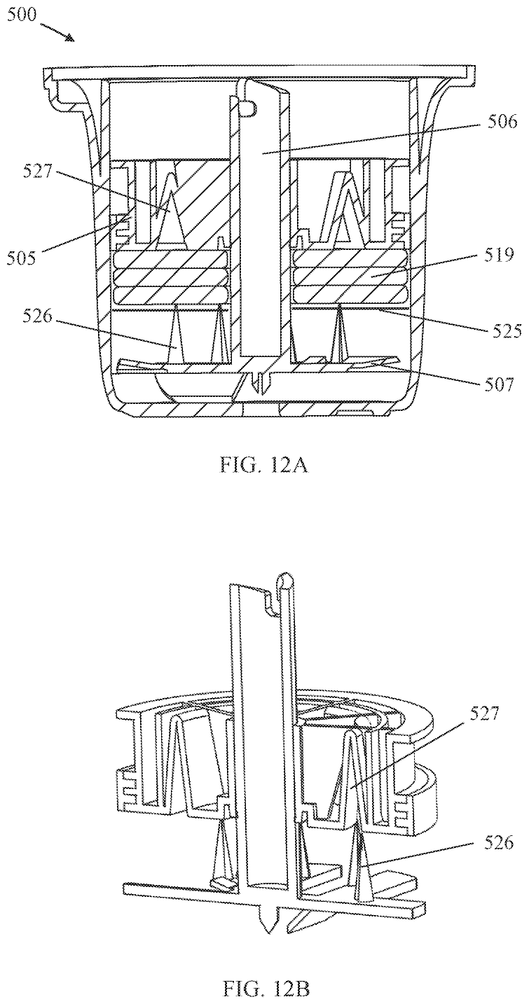

FIG. 12A is a cross-section view of an eighth embodiment of a capsule, showing sharp tips on the mixer element and corresponding cavities on the piston, according to embodiments of the present disclosure;

FIG. 12B is a cross-section view of the mixer element and piston of FIG. 12A;

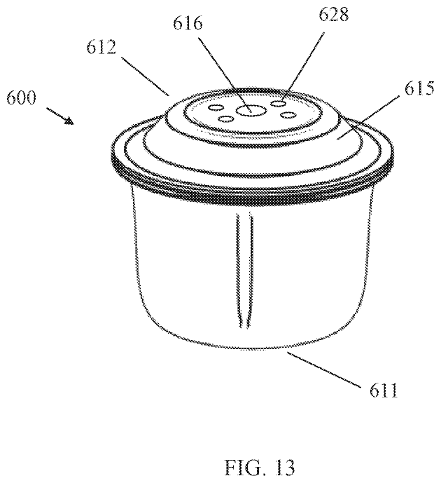

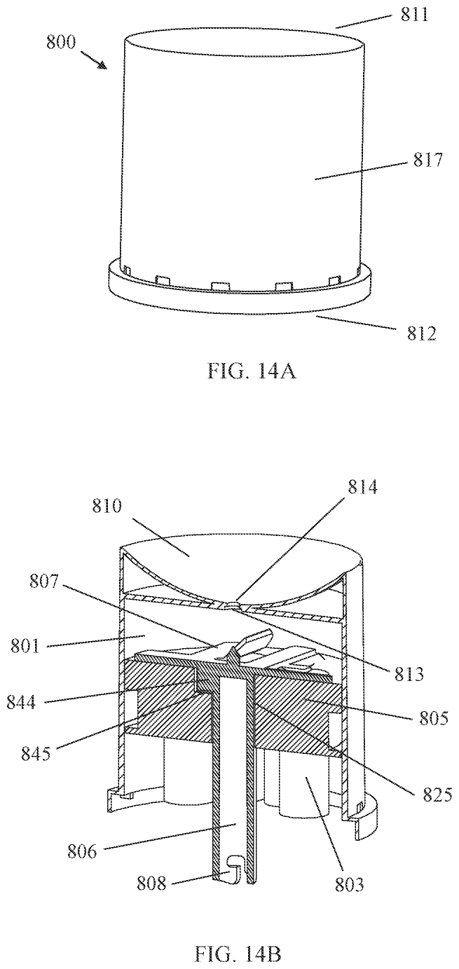

FIG. 13 is an upper perspective view of a ninth embodiment of a capsule, with a first end facing upward and a second end facing downward, and a rounded cover, according to embodiments of the present disclosure;

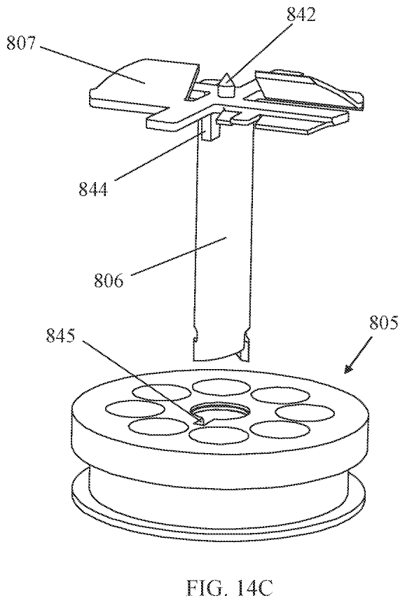

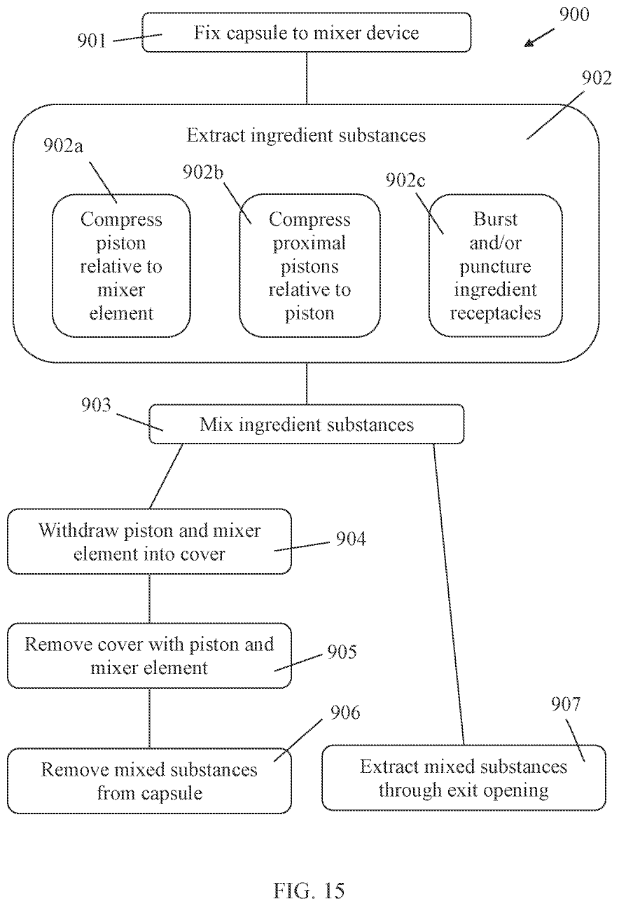

FIG. 14A is a side view of a tenth embodiment of a capsule, with a first end facing downward and a second end facing upward, according to embodiments of the present disclosure;

FIG. 14B is a cross section view of the capsule of FIG. 14A;

FIG. 14C is a partial exploded view of the mixer rod, mixer element, and piston of the capsule of FIGS. 14A and 14B, showing a slot in the piston and corresponding nub in the mixer element for rotationally fixing the piston to the mixer element, according to embodiments of the present disclosure;

FIG. 15 depicts a flow chart for a method of mixing ingredient substances in a capsule, according to embodiments of the present disclosure;

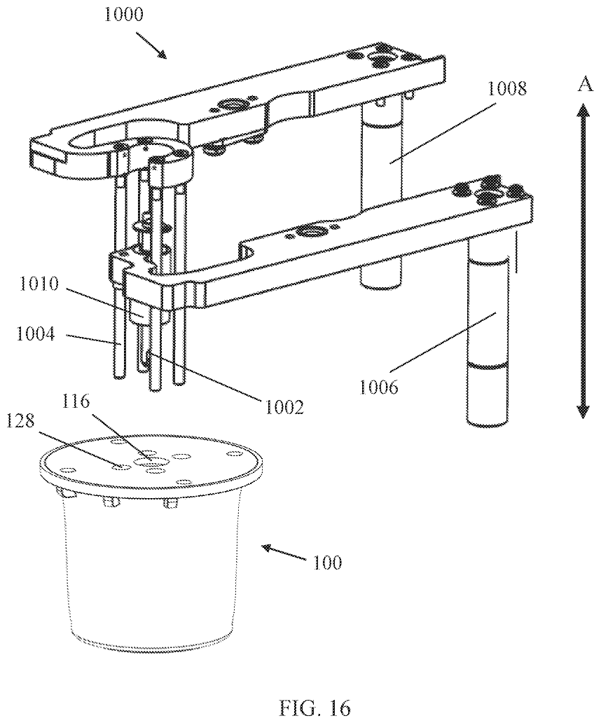

FIG. 16 is a schematic illustration of operative components of a mixer device for mixing ingredient substances within a capsule, according to embodiments of the present disclosure;

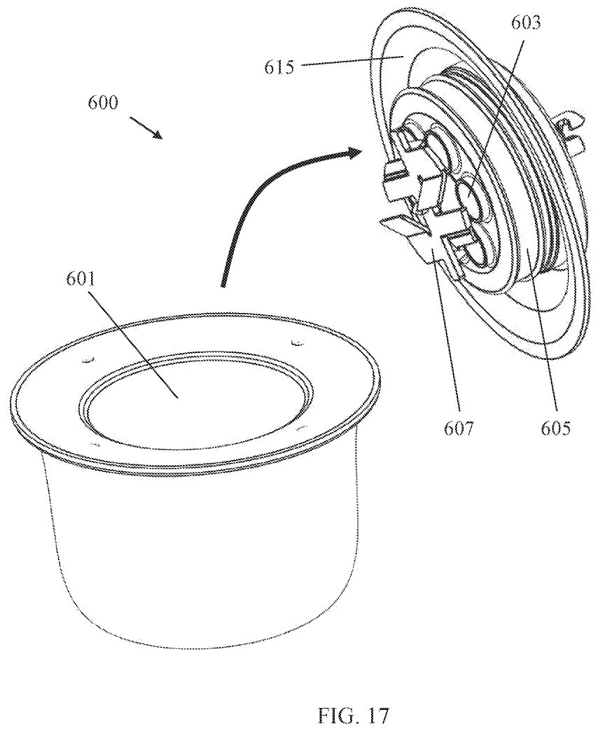

FIG. 17 depicts removal of the cover of the capsule of FIG. 13 with internal components attached to the cover, according to embodiments of the present disclosure;

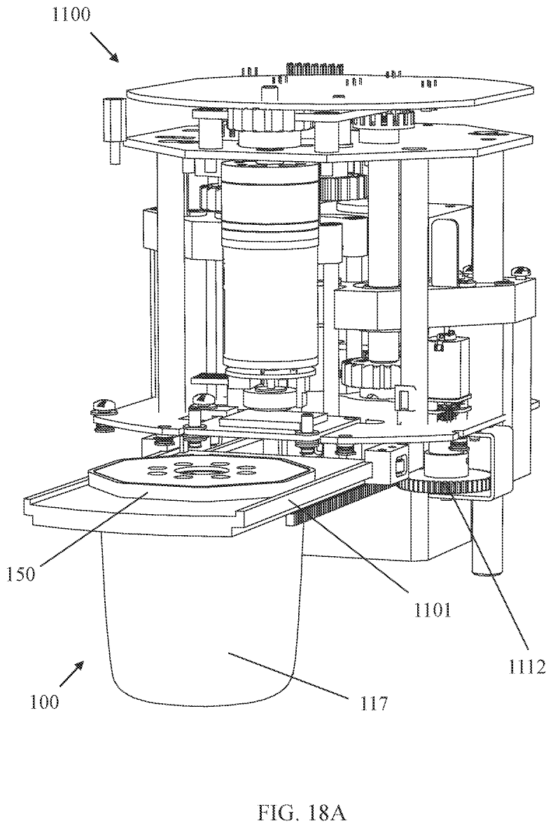

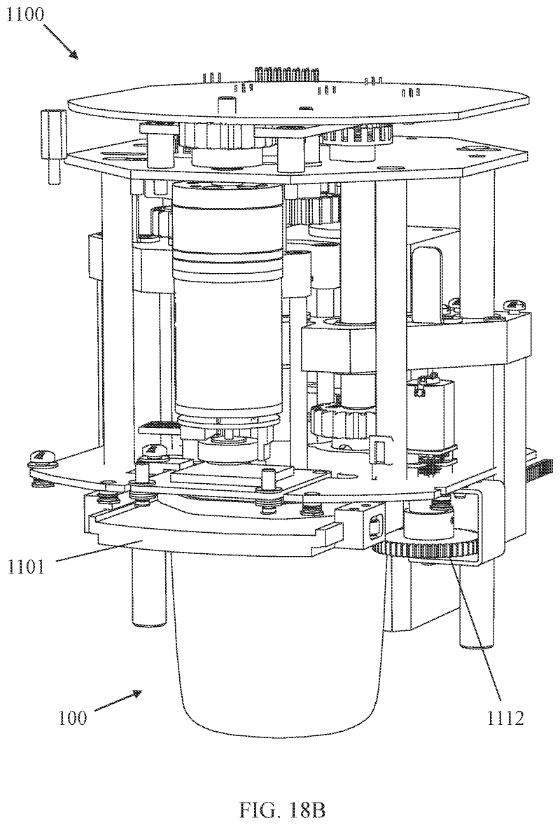

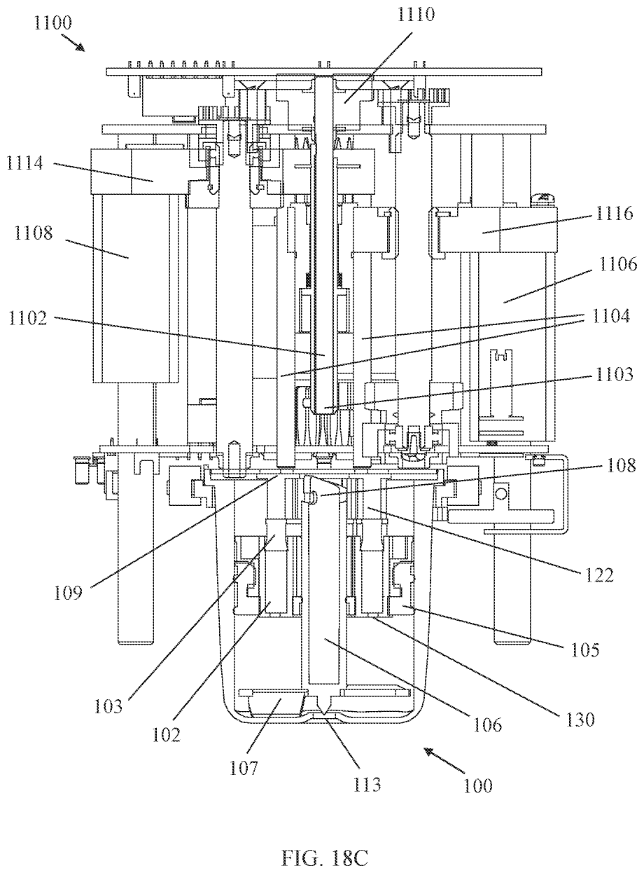

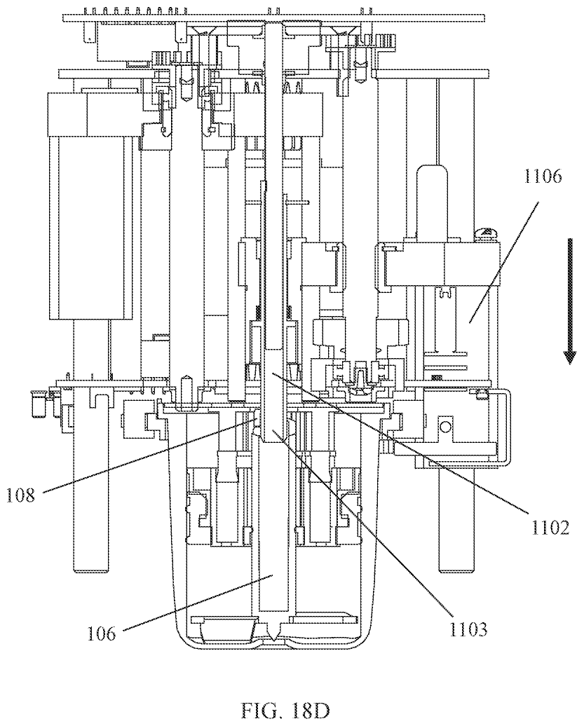

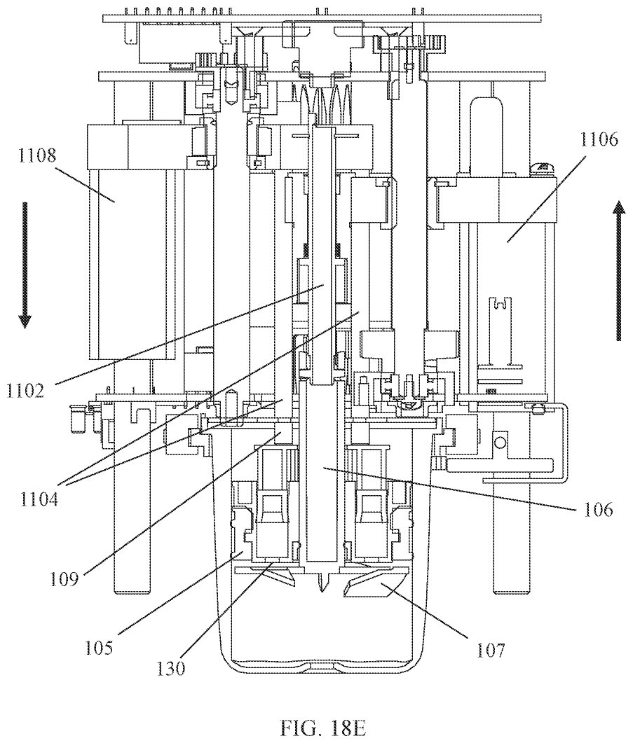

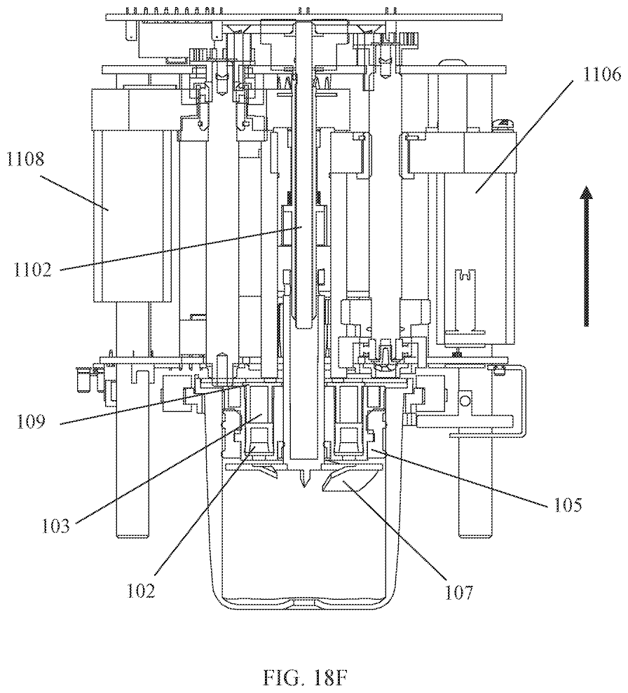

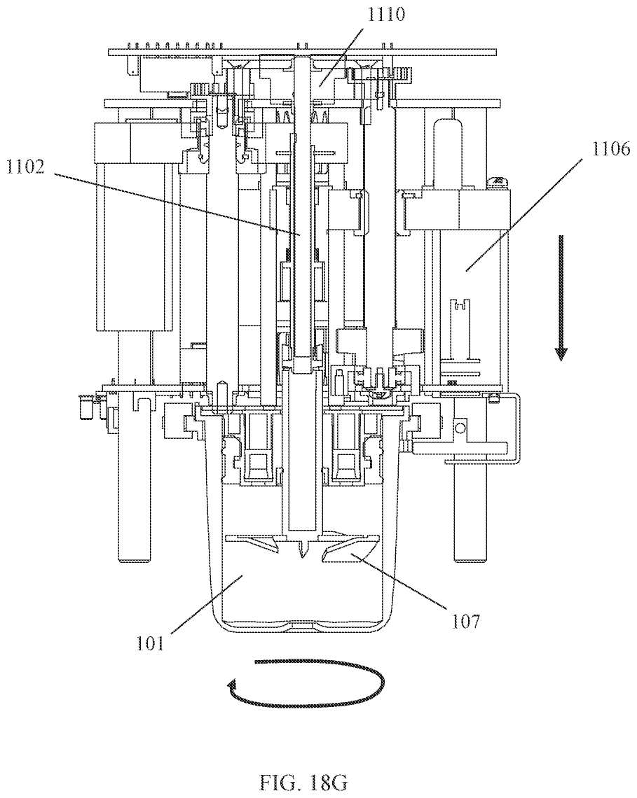

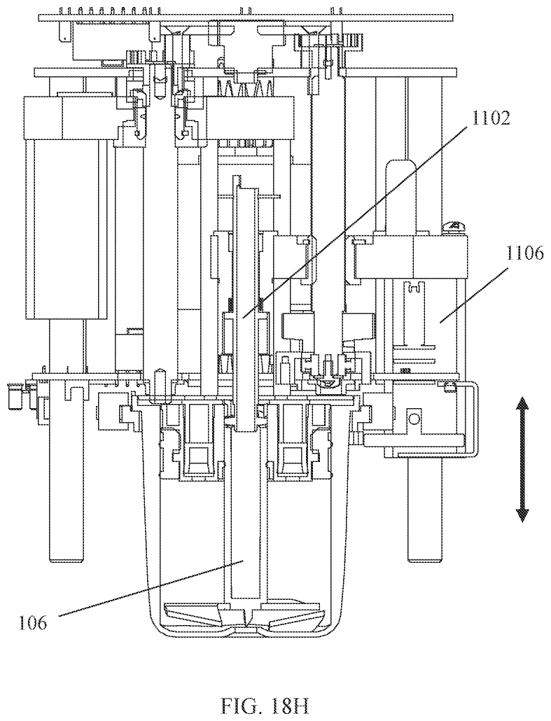

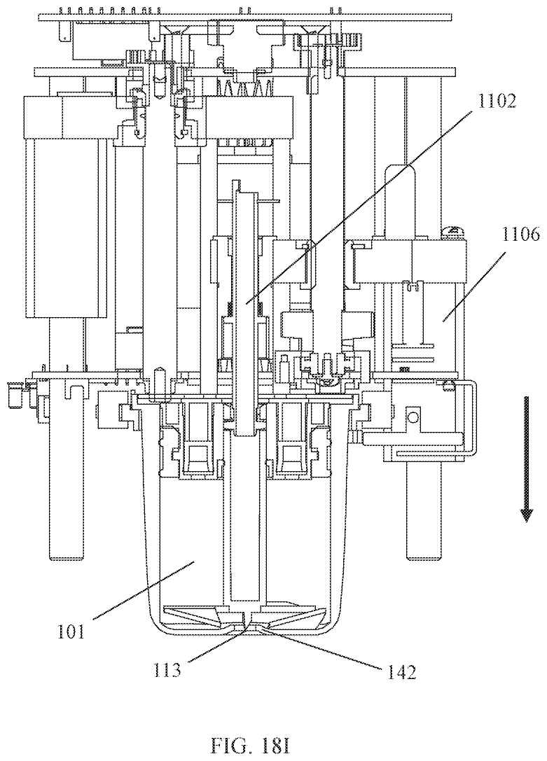

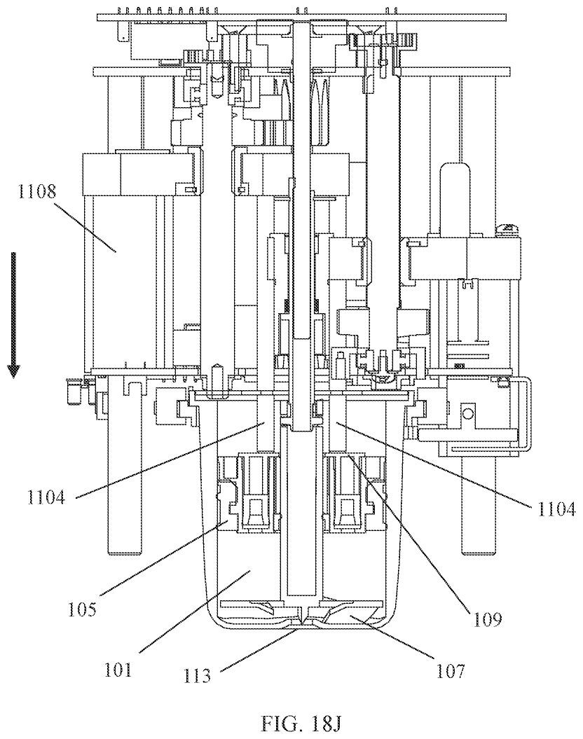

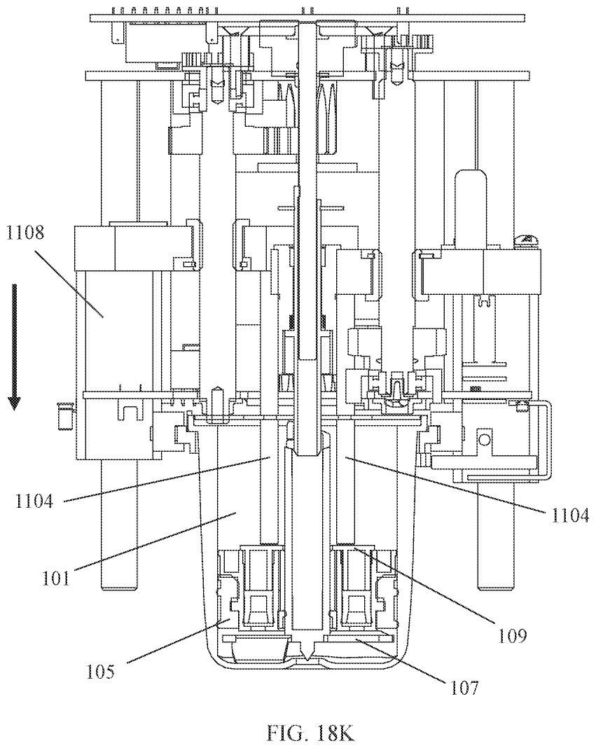

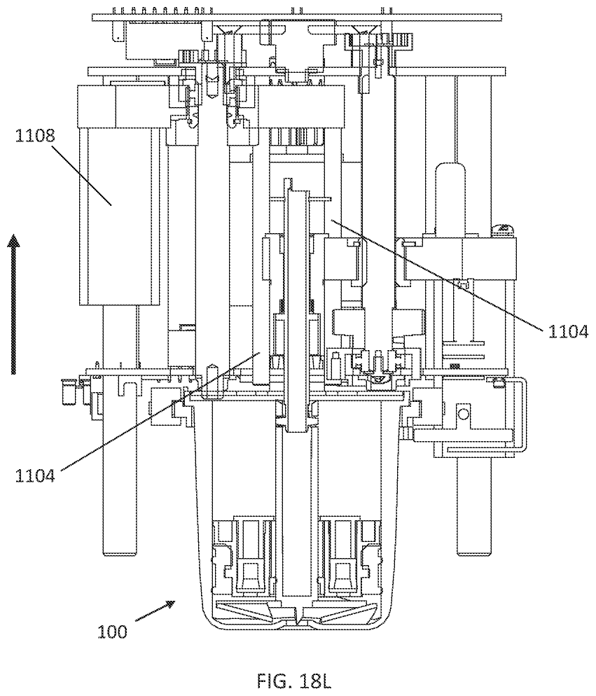

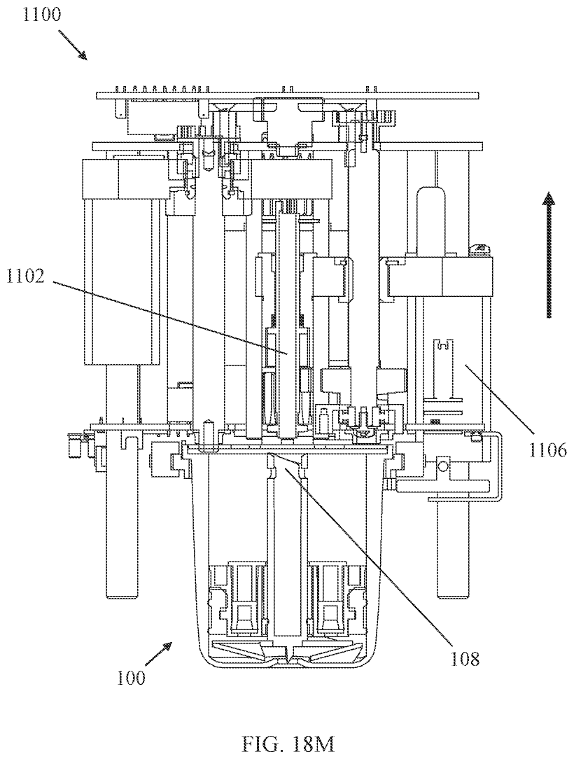

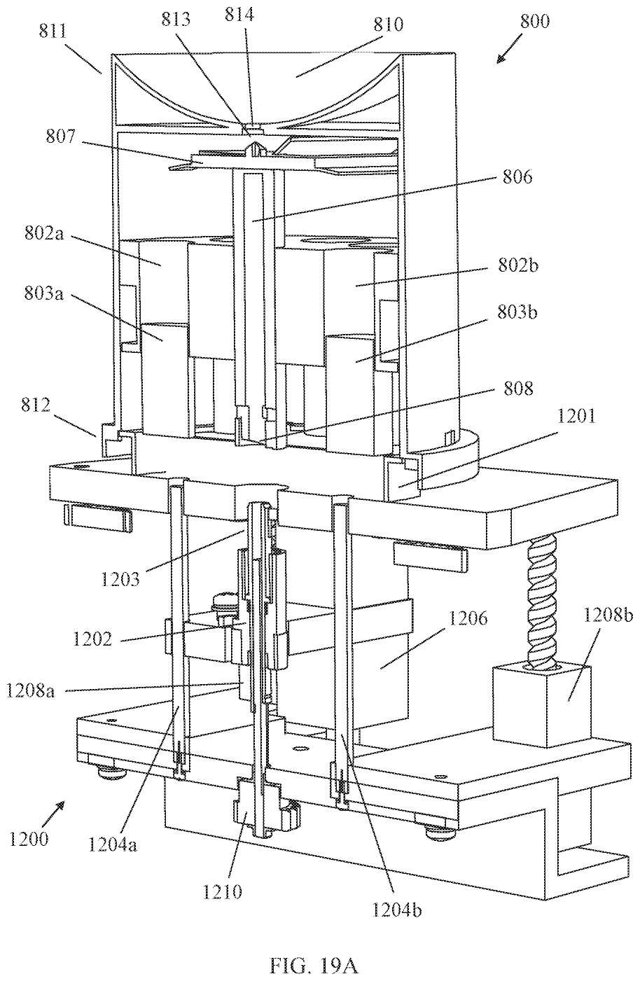

FIGS. 18A-M illustrate stages of use of a mixer device to mix and extract substances from the capsule of FIG. 1A, according to embodiments of the present disclosure;

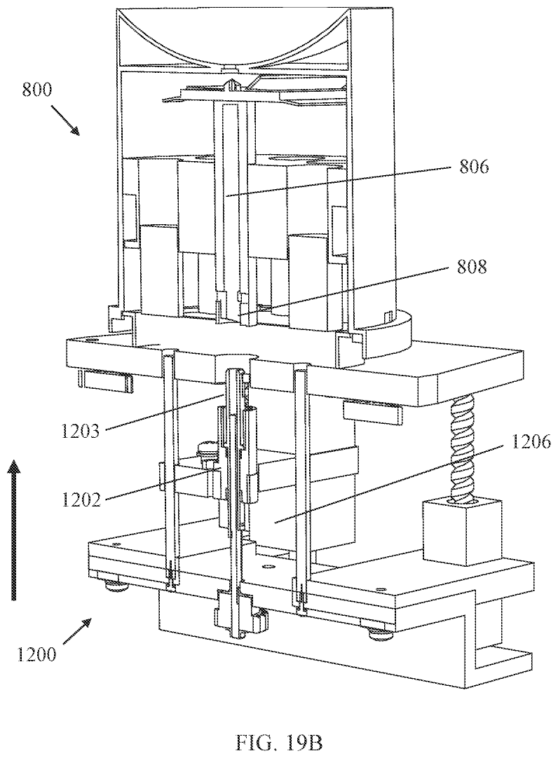

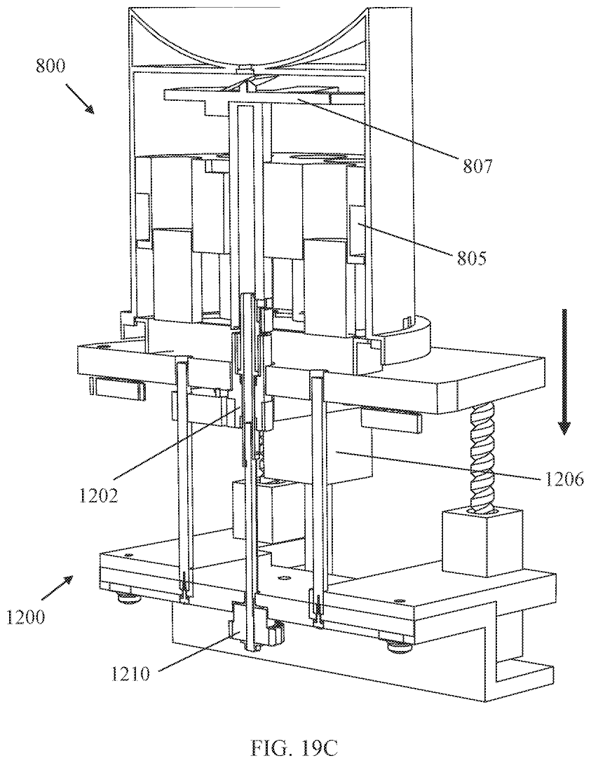

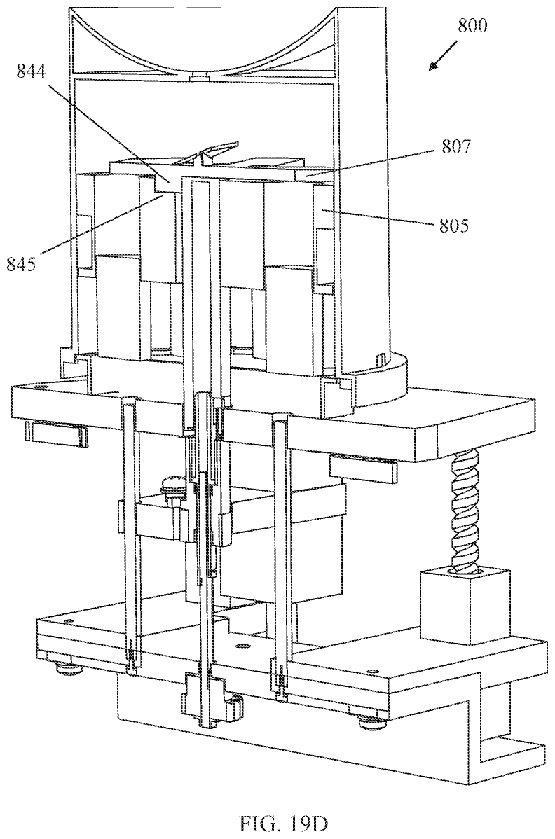

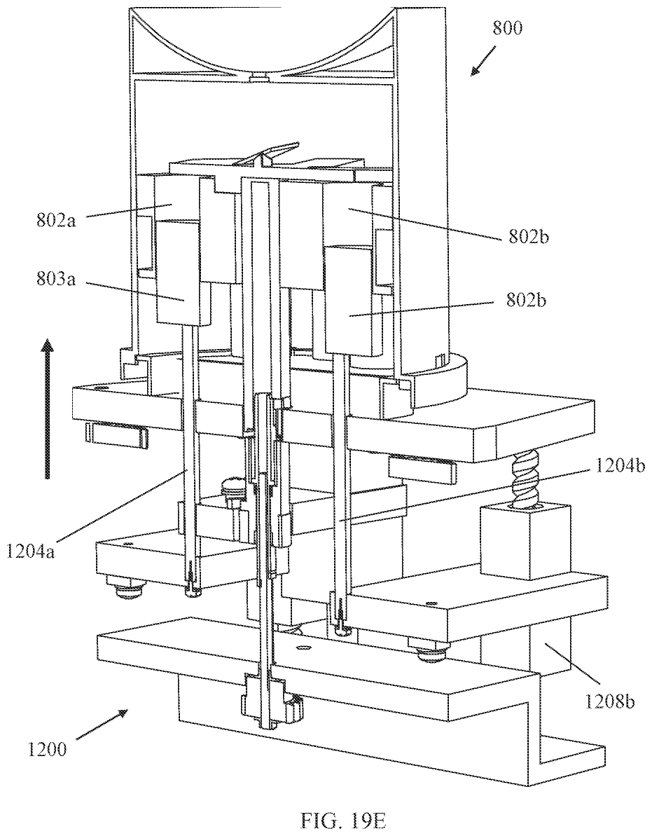

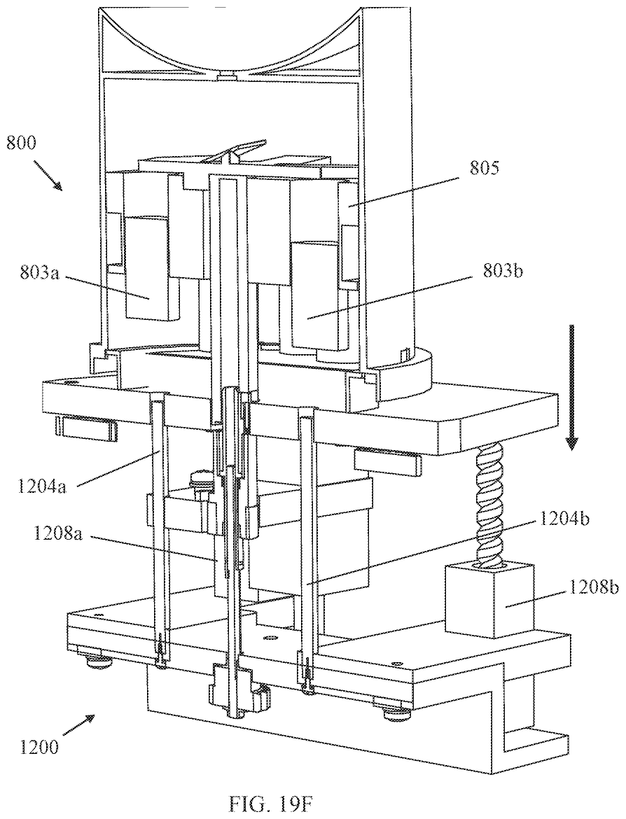

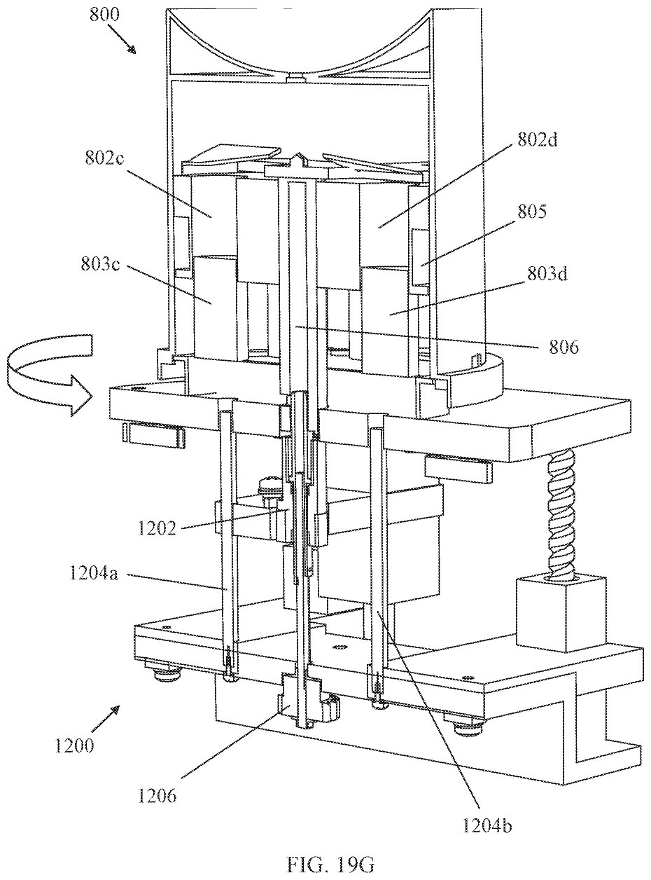

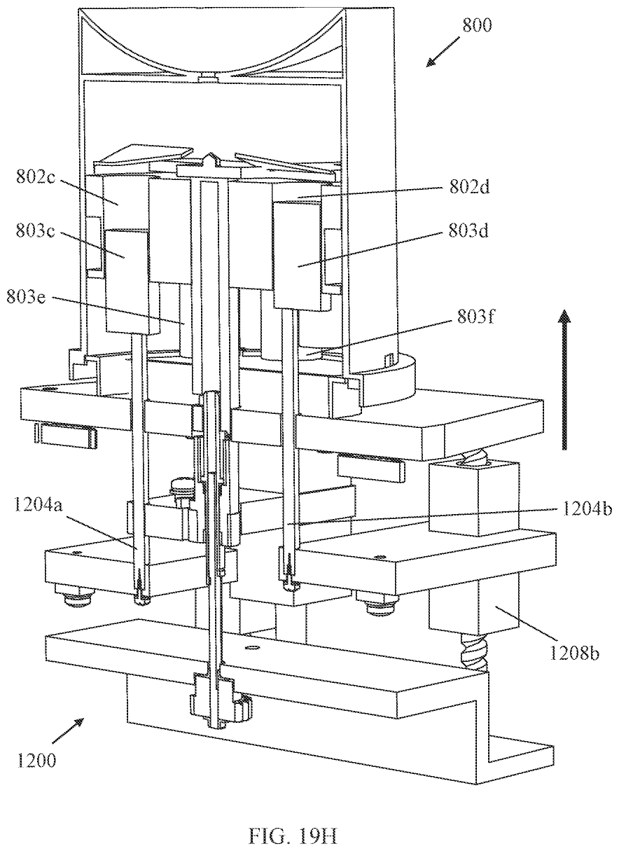

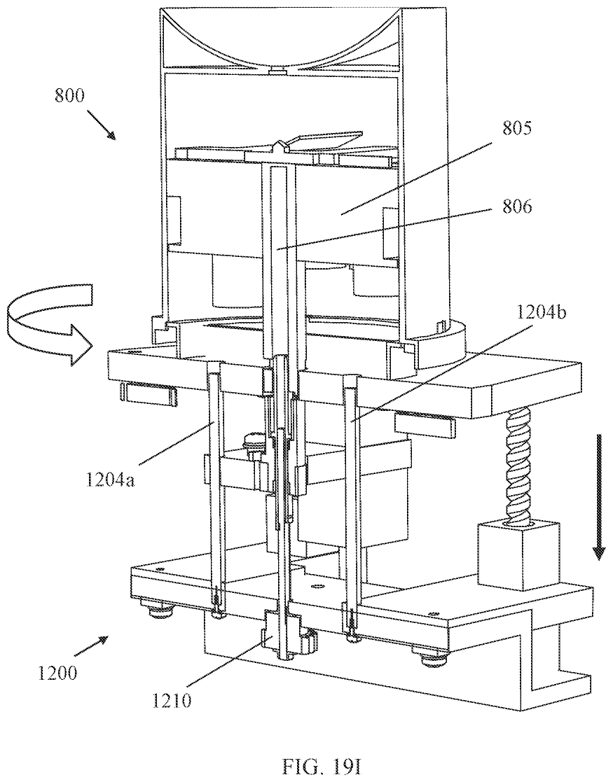

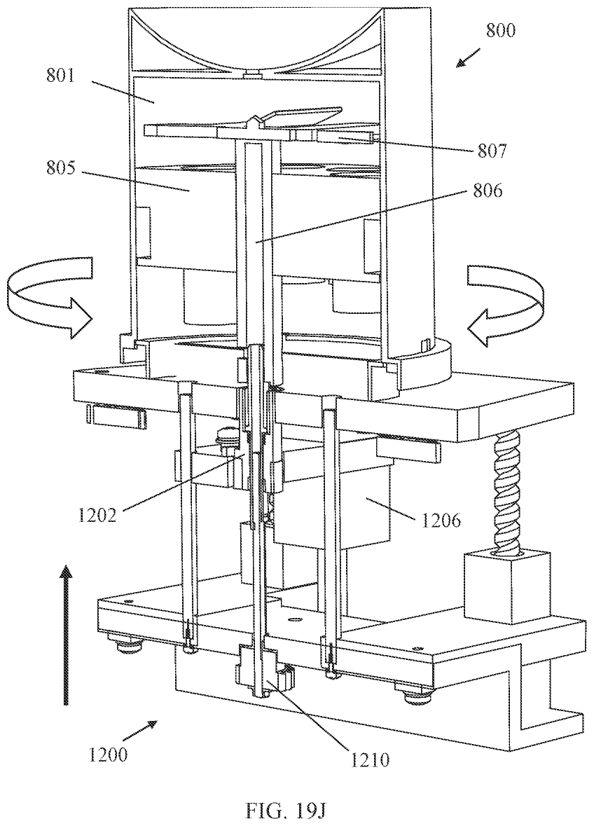

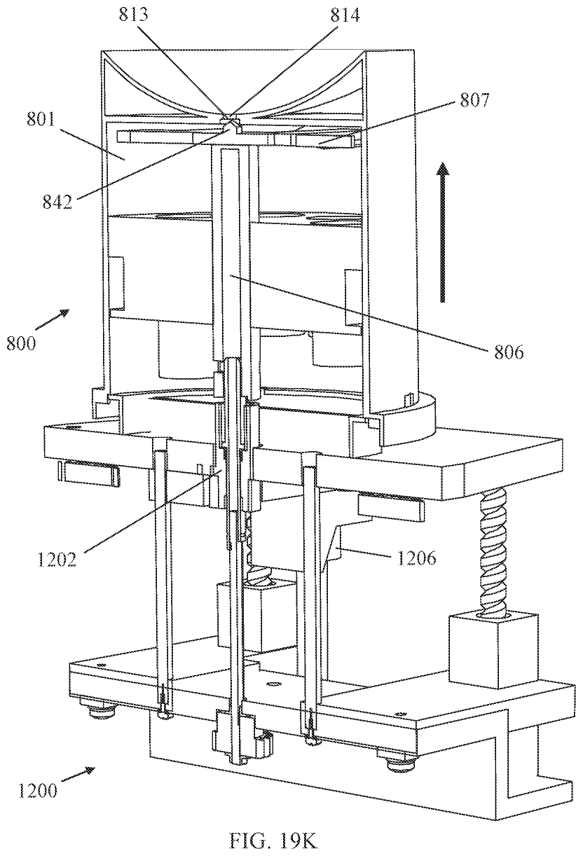

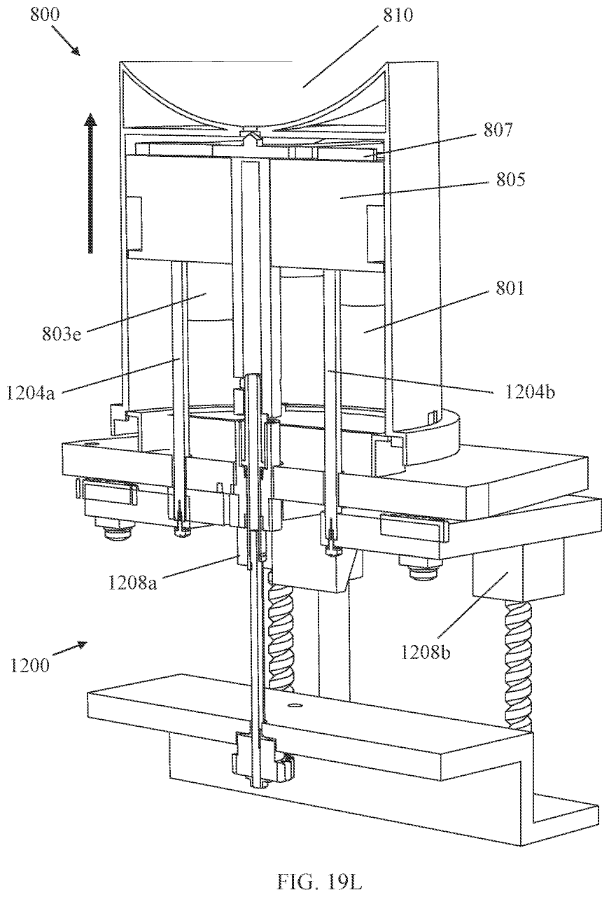

FIGS. 19A-L illustrate stages of use of a different mixer device to mix and extract substances from the capsule of FIG. 14A, in which different substances may be selectively extracted, according to embodiments of the present disclosure;

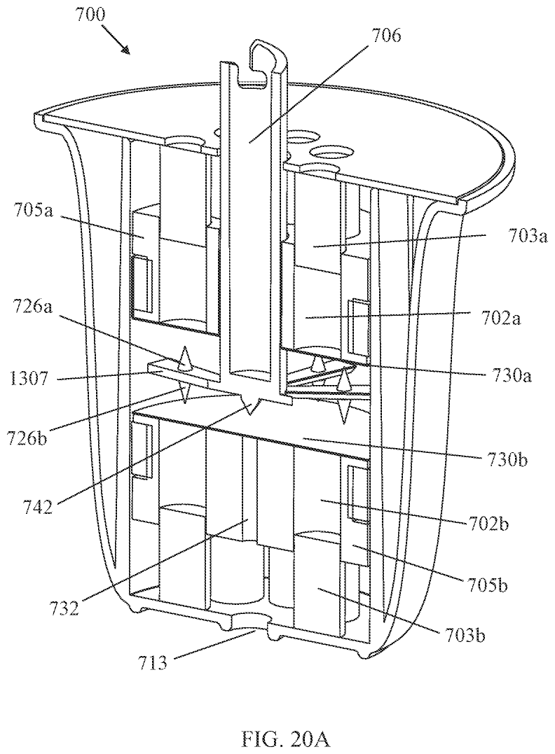

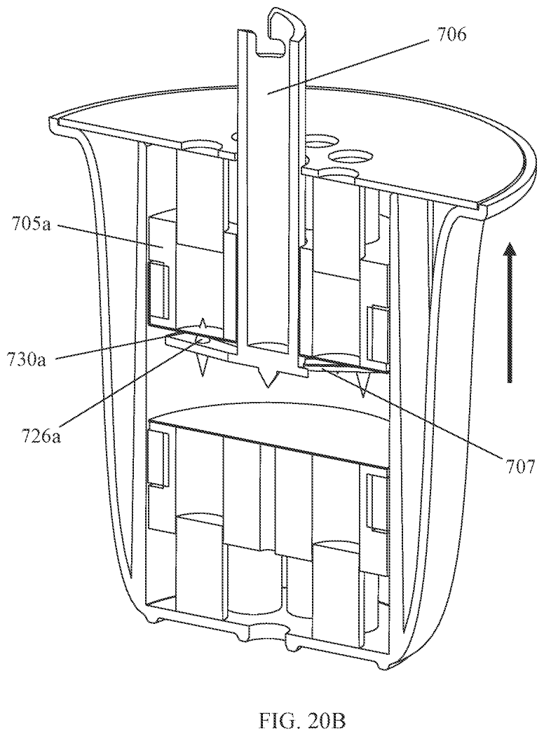

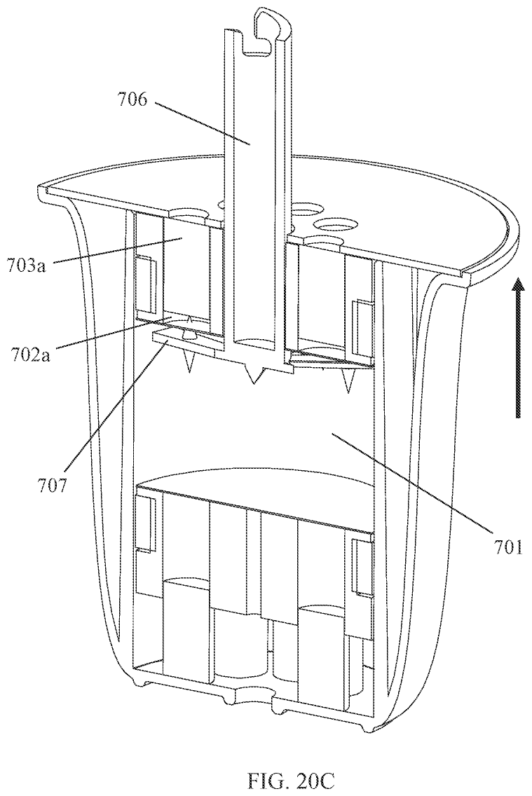

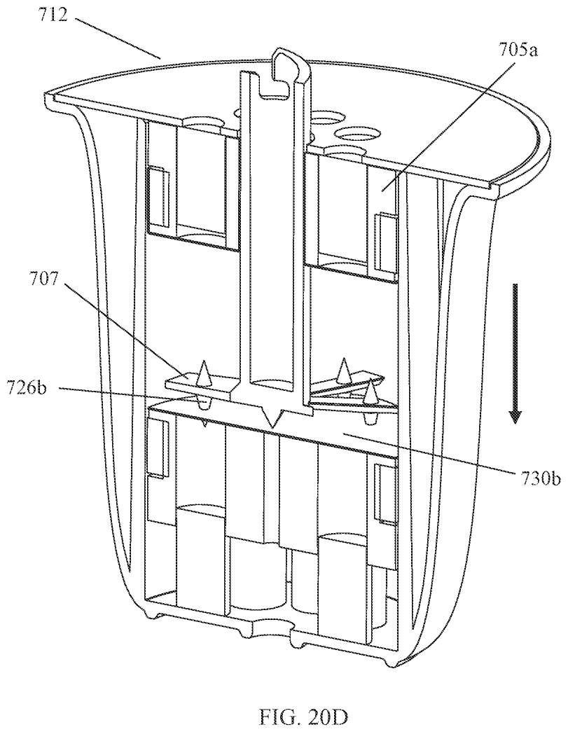

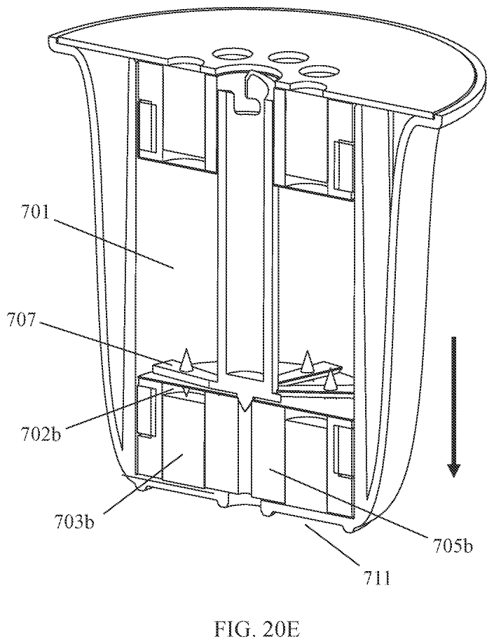

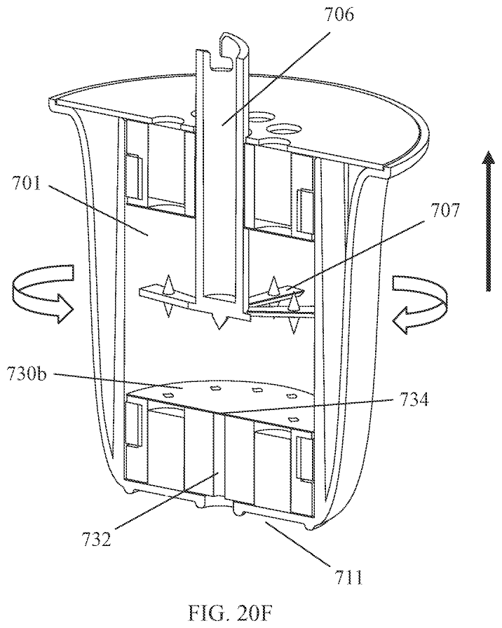

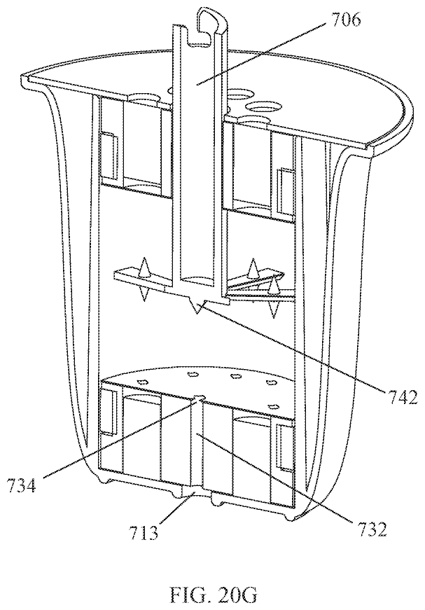

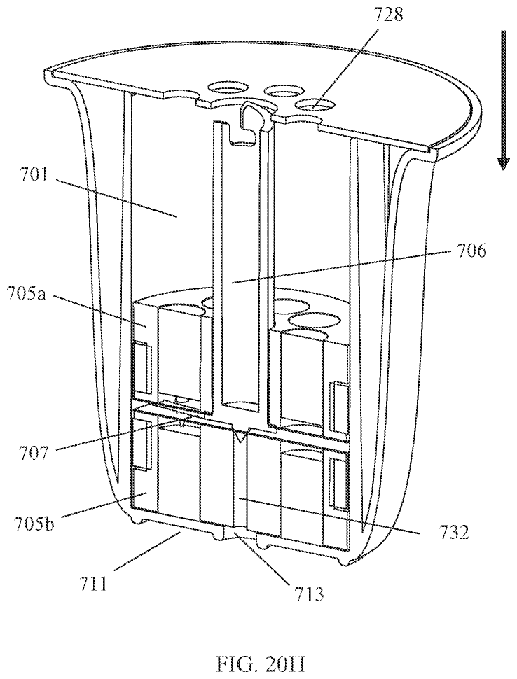

FIGS. 20A-H illustrate a cross-section view of an eleventh embodiment of a capsule, having two internal pistons, and stages of mixing and extracting ingredient substances within this capsule, according to embodiments of the present disclosure;

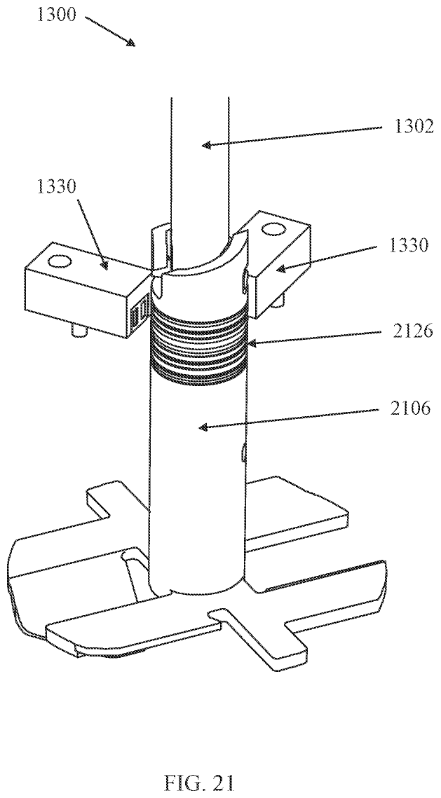

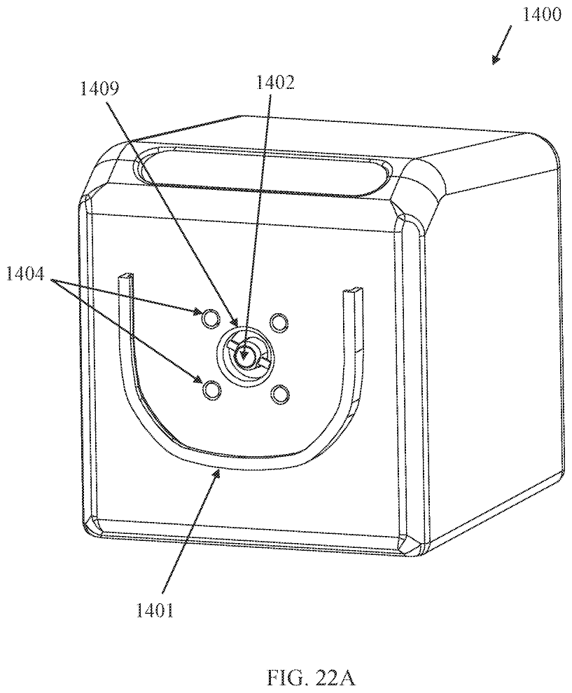

FIG. 21 depicts a mixer rod having a barcode thereon, according to embodiments of the present disclosure;

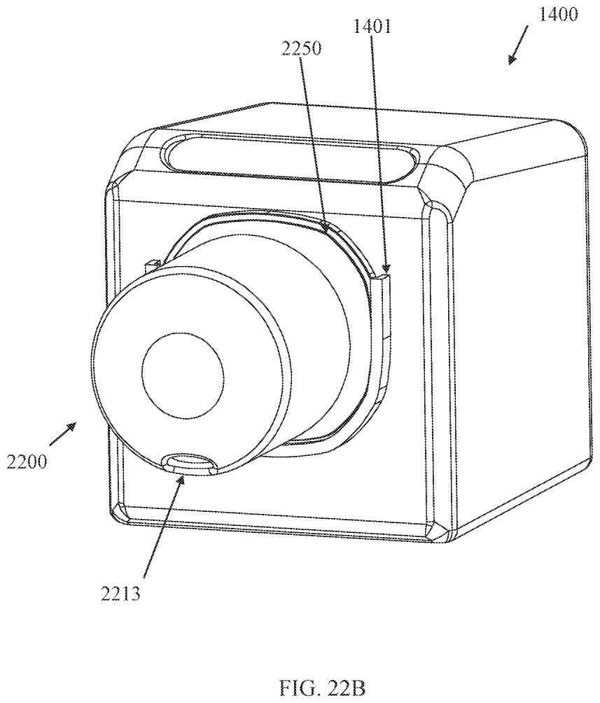

FIGS. 22A and 22B depict a horizontal mixer device, and the horizontal mixer device with a capsule attached, respectively, according to embodiments of the present disclosure;

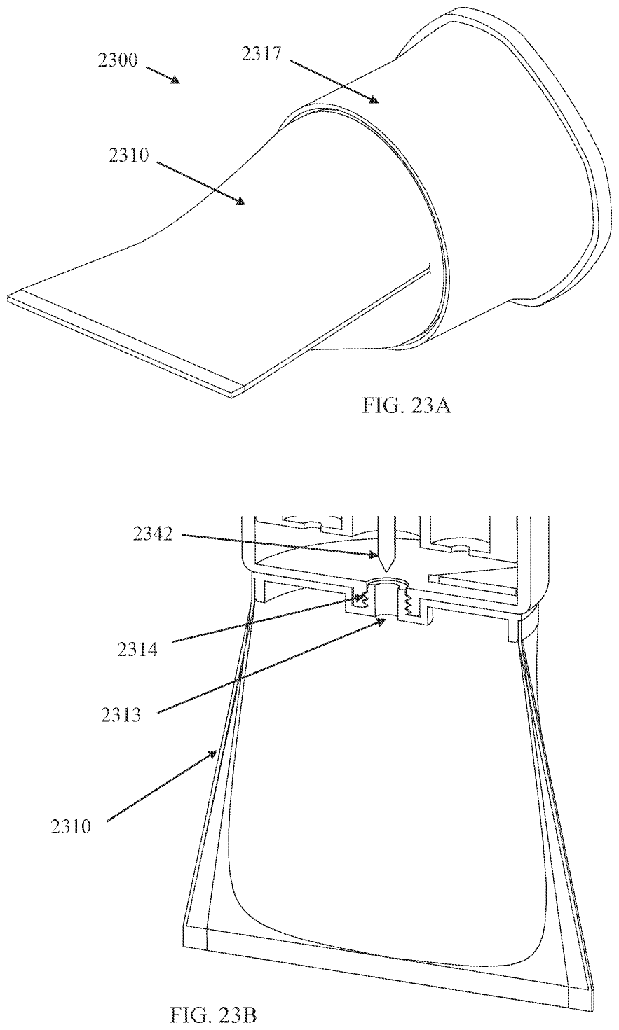

FIGS. 23A and 23B depict a capsule having a squeeze tube, according to embodiments of the present disclosure;

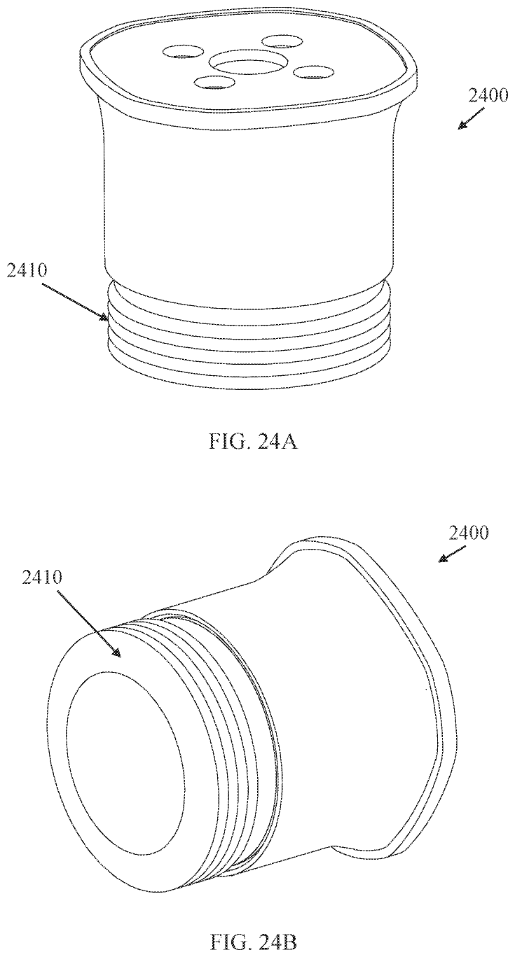

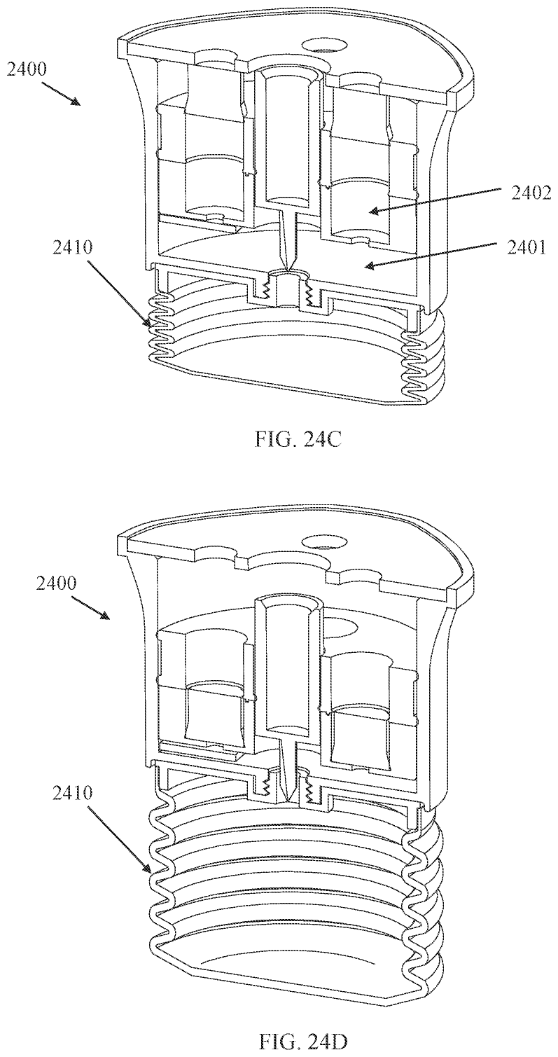

FIGS. 24A, 24B, 24C and 24D depict a capsule having a detachable container which has a stretchable accordion structure, according to embodiments of the present disclosure;

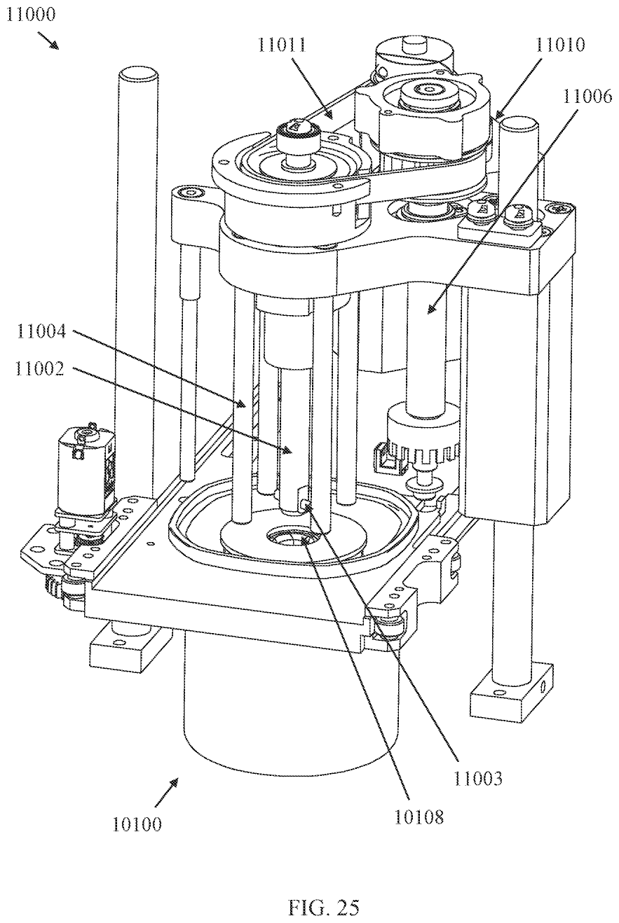

FIG. 25 depicts a capsule and a mixer device which is driving a torque arm in helical motion, according to embodiments of the present disclosure;

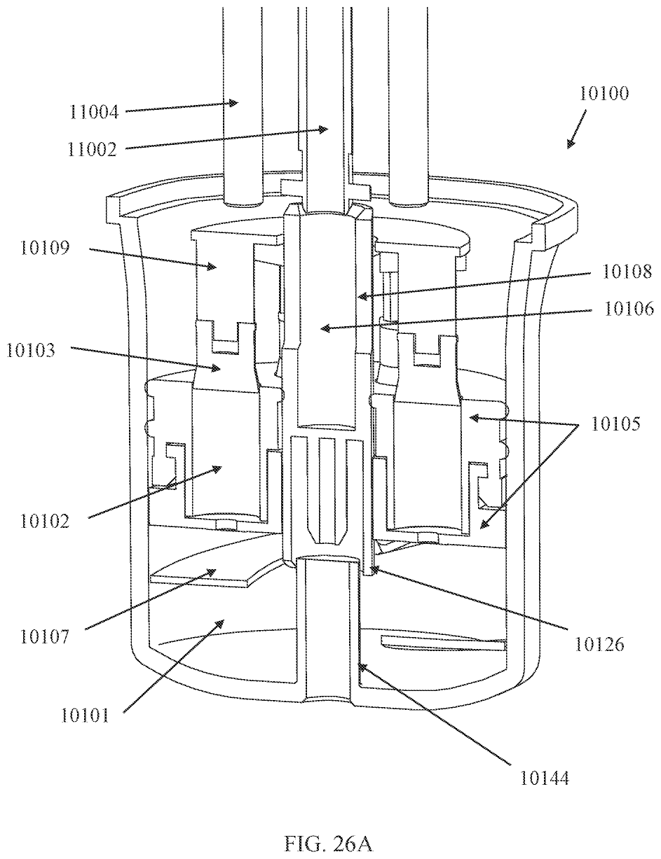

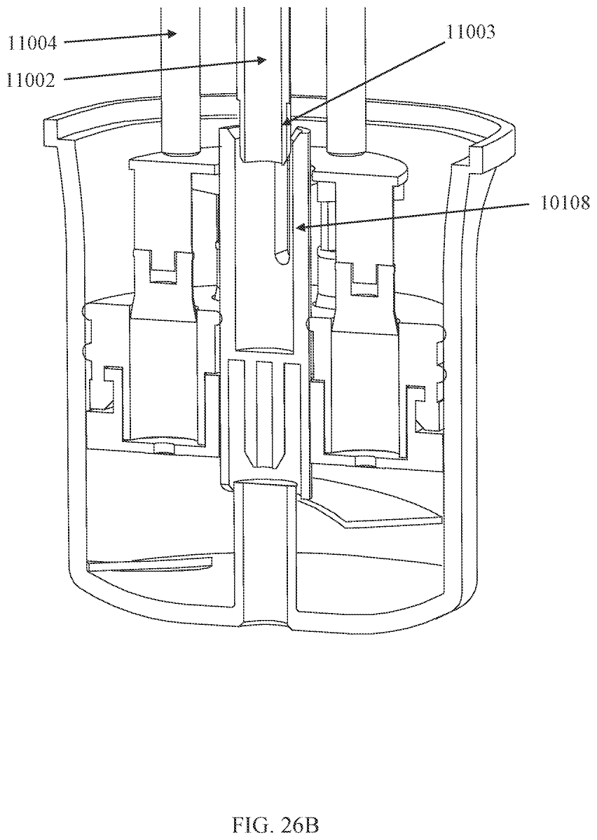

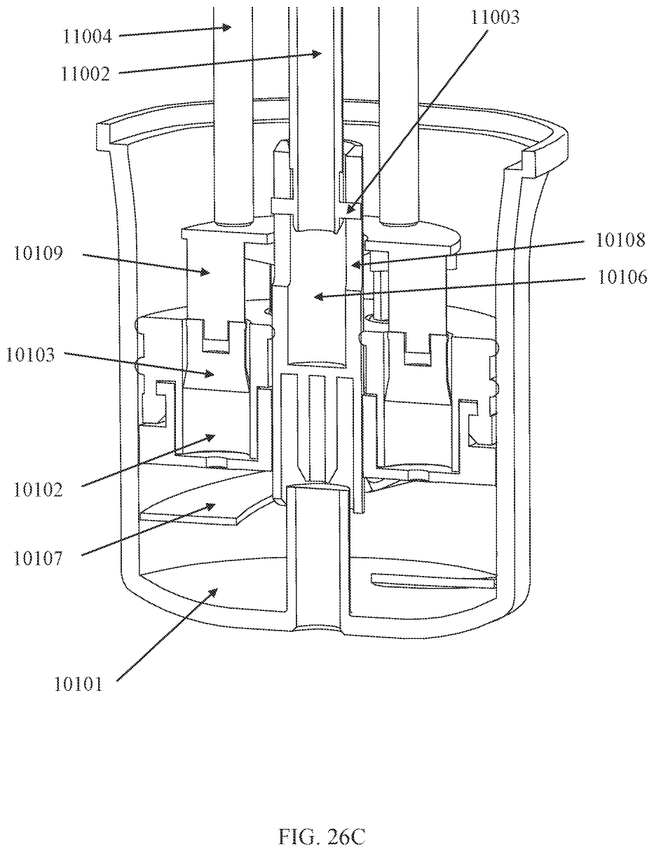

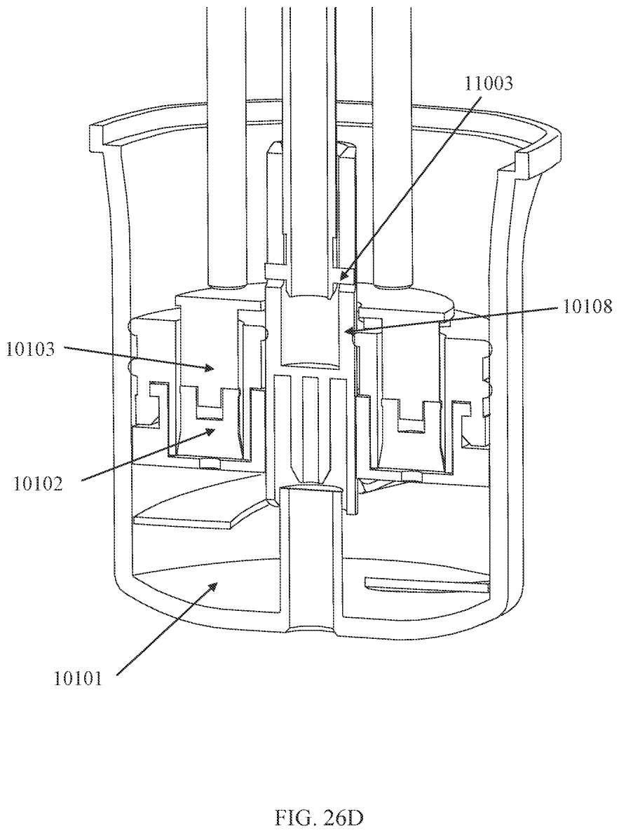

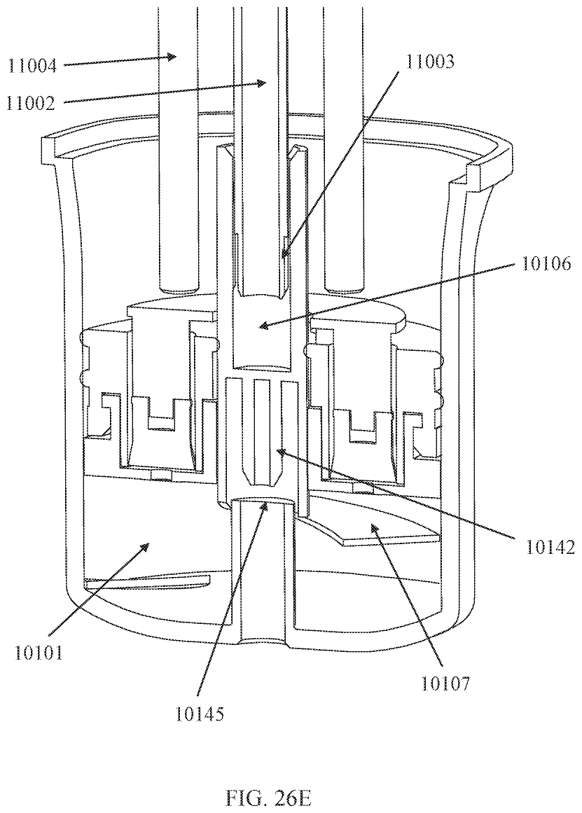

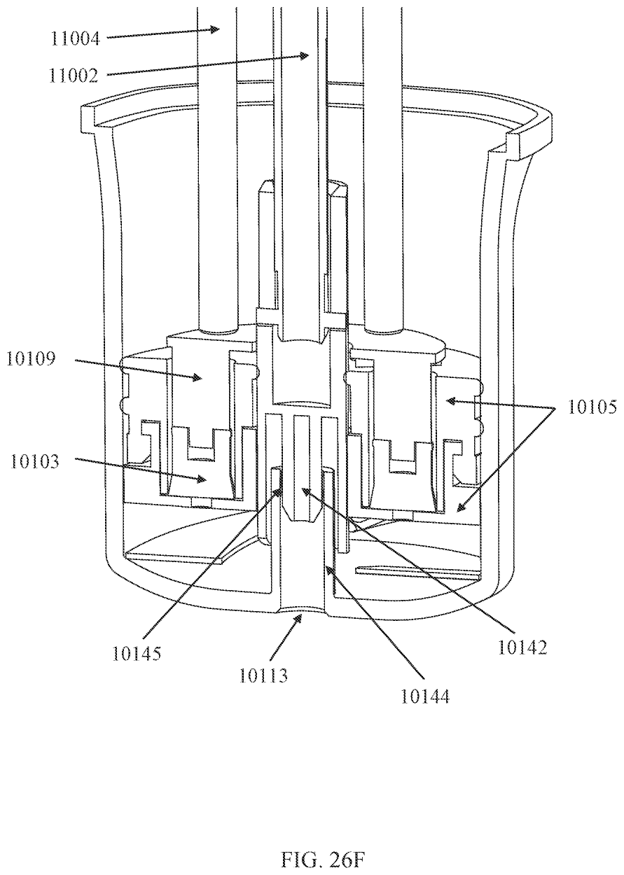

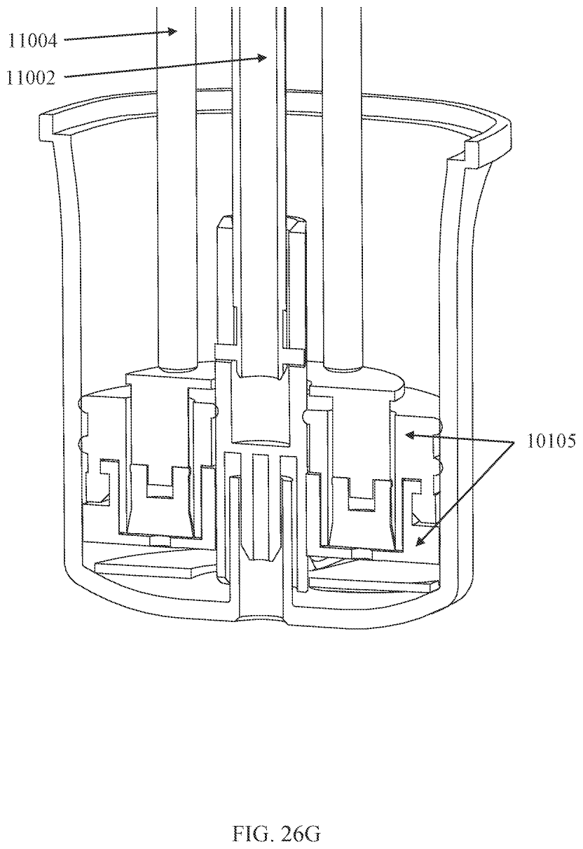

FIGS. 26A-26G illustrate the capsule of FIG. 25 and a process of mixing and extracting formulations using mixer device of FIG. 25, according to embodiments of the present disclosure;

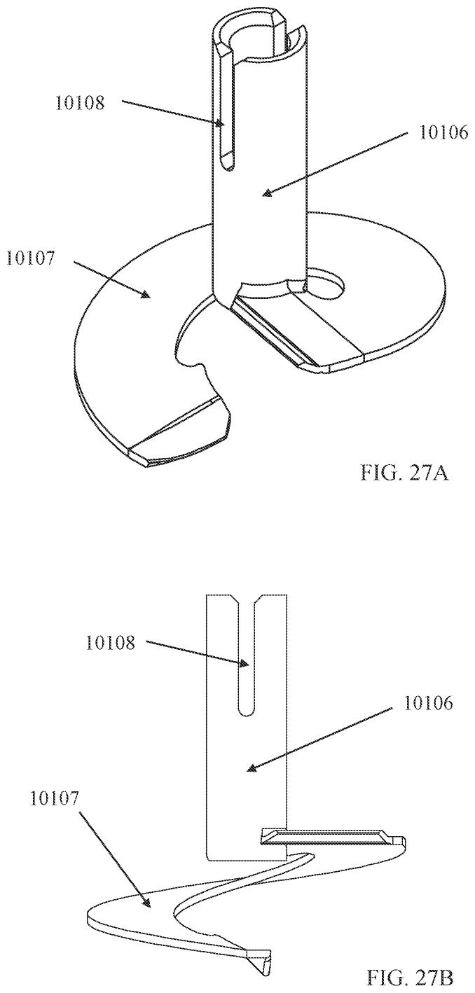

FIGS. 27A and 27B are perspective and side drawings of the mixer rod, torque adapter, and mixer element of the capsule of FIG. 25, according to embodiments of the present disclosure;

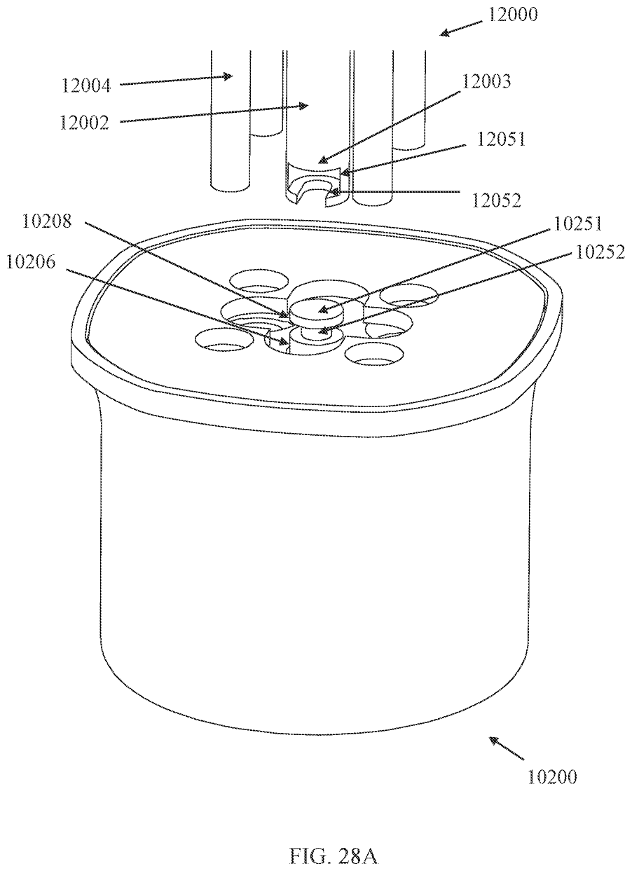

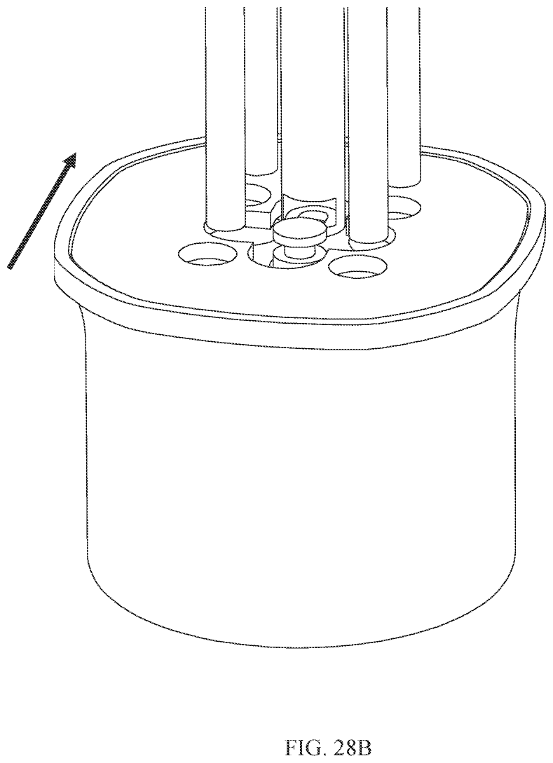

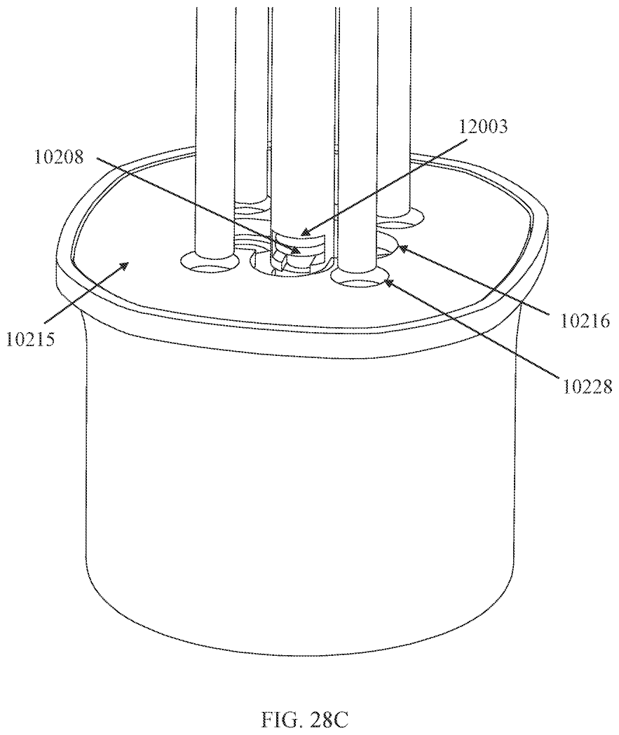

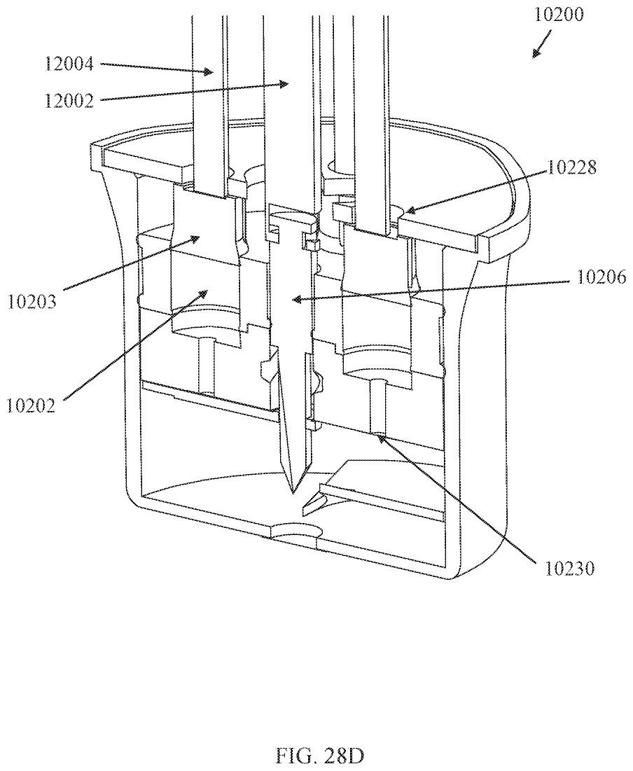

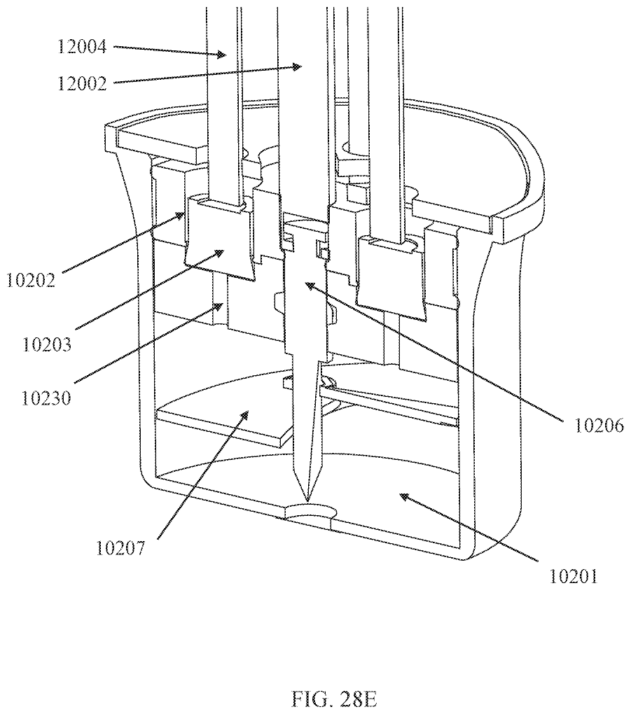

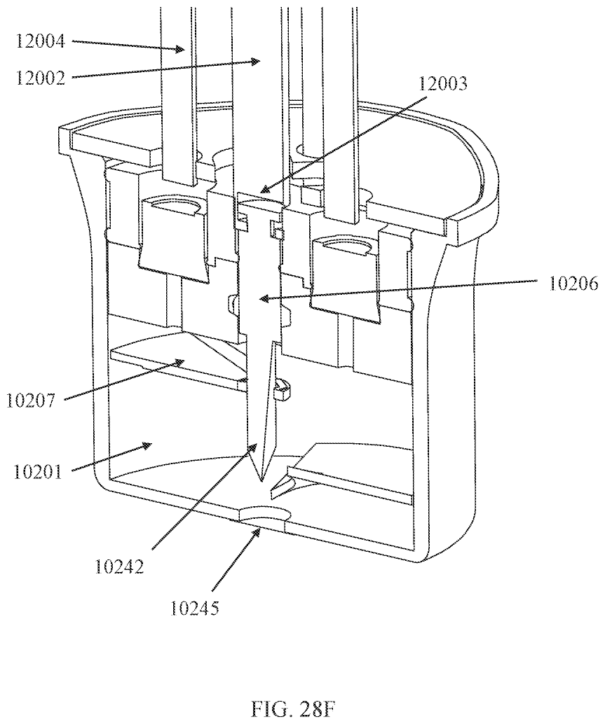

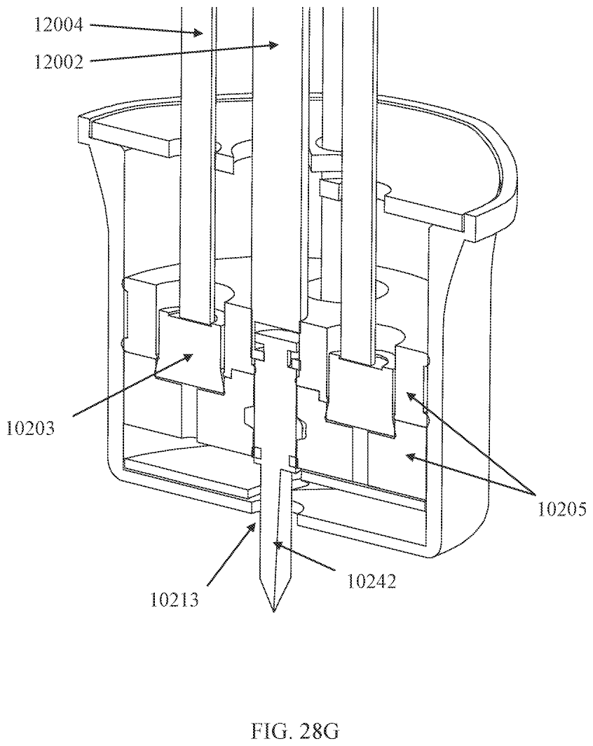

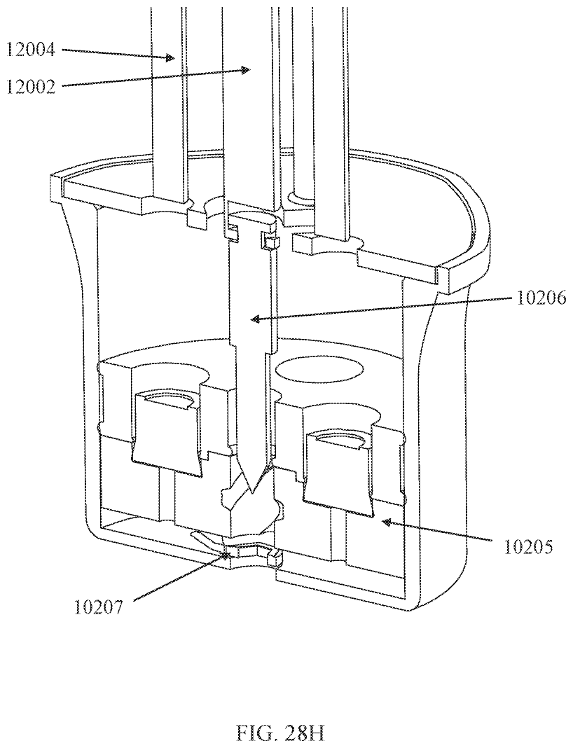

FIGS. 28A-28H illustrate a capsule and elements of a mixer device which is driving an arm in linear motion, and a process of mixing and extracting formulations using the mixer device and capsule, according to embodiments of the present disclosure;

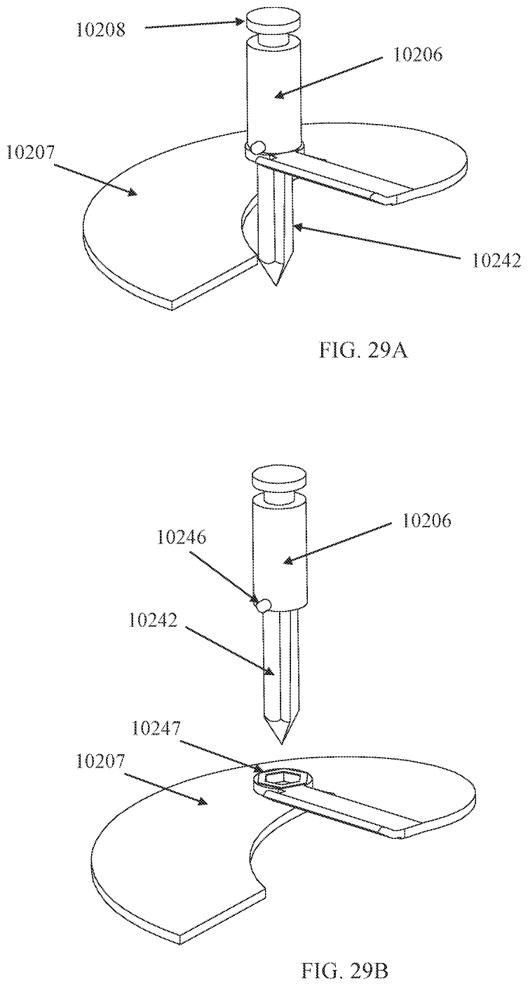

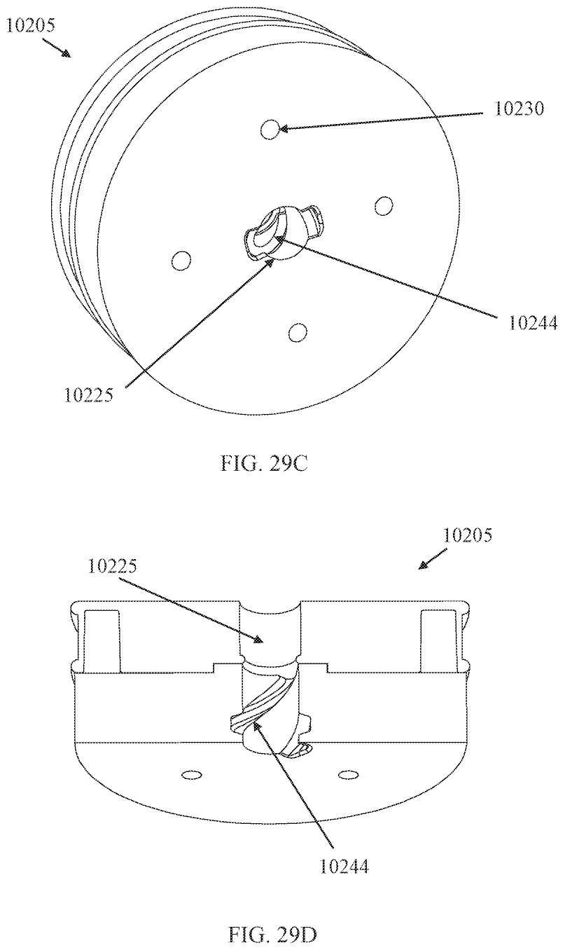

FIGS. 29A and 29B are illustrations depicting the mixer rod and the mixer element of the capsule of FIGS. 28A-28H, according to embodiments of the present disclosure;

FIGS. 29C and 29D are illustrations depicting the main piston of the capsule of FIGS. 28A-28H, according to embodiments of the present disclosure;

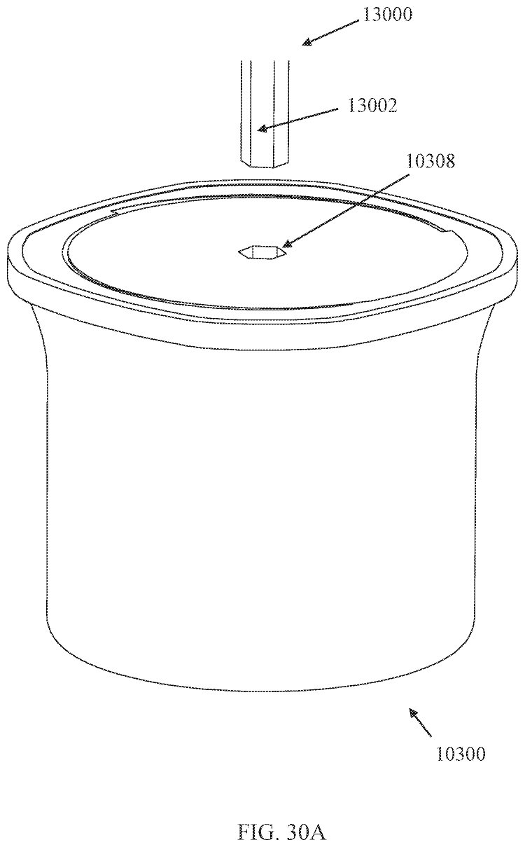

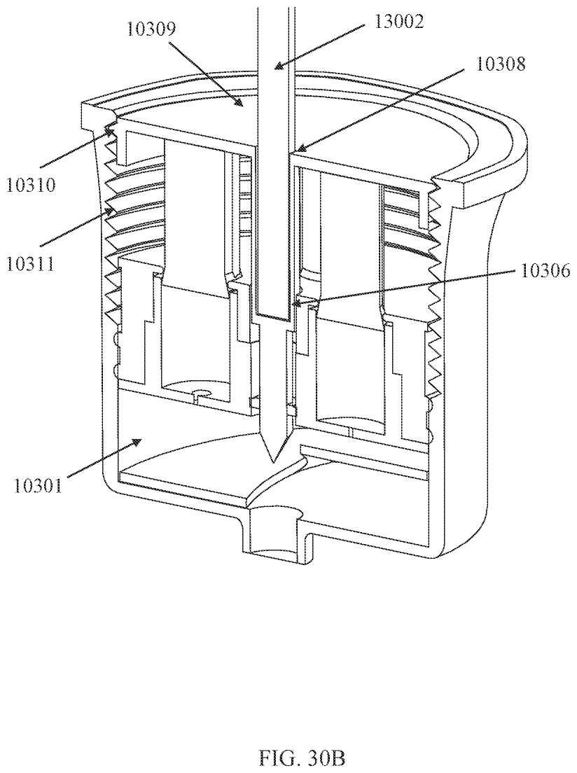

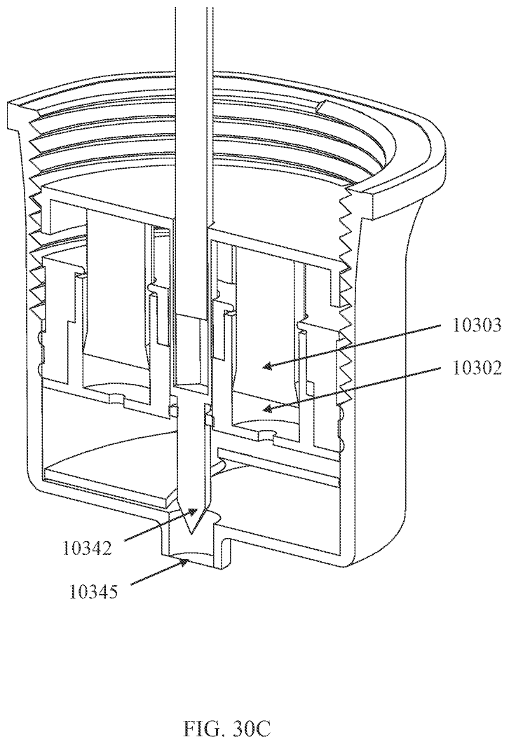

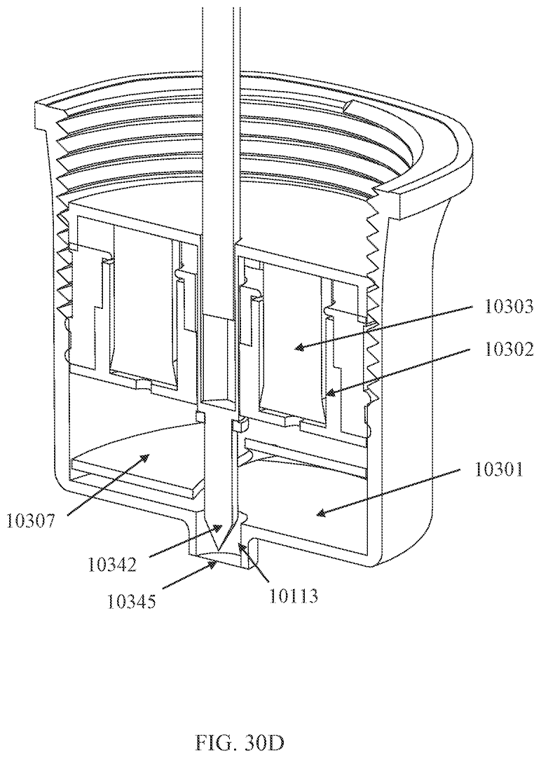

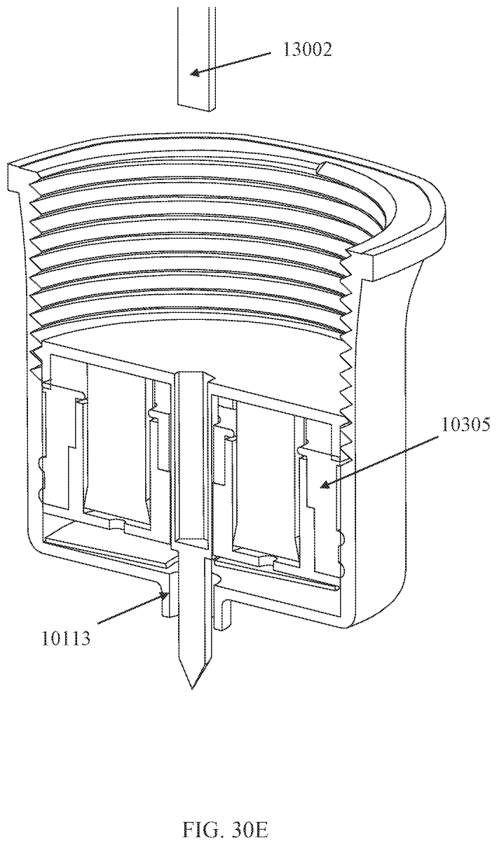

FIGS. 30A-30E illustrate a capsule and a process of mixing and extracting formulations using mixer device driving a torque arm in rotary motion, according to embodiments of the present disclosure;

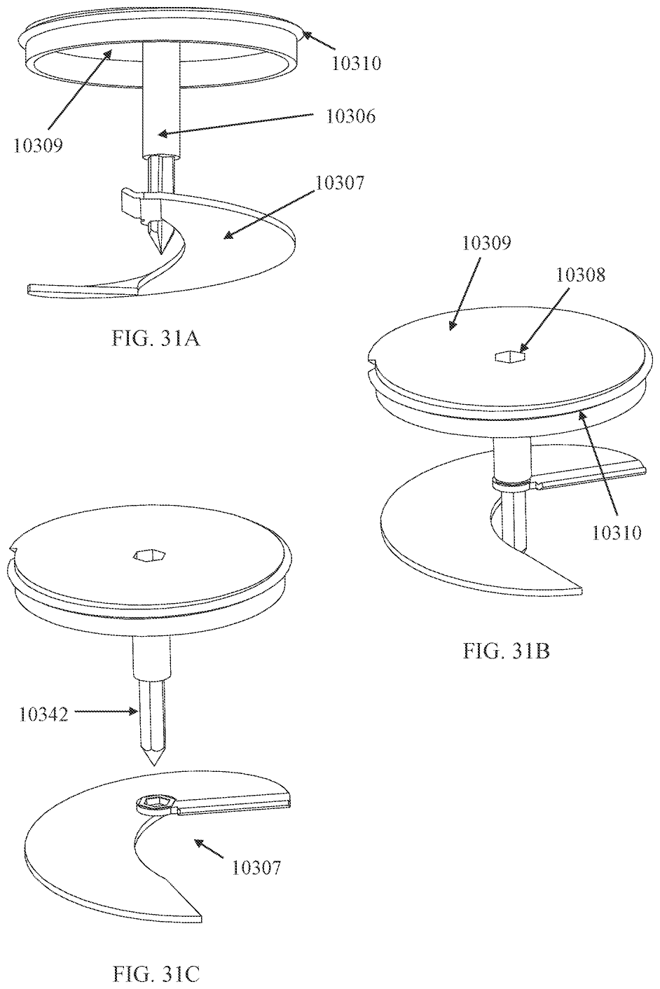

FIGS. 31A-31C are illustrations depicting the plate, the mixer rod, and the mixer element of the capsule of FIGS. 30A-30E, according to embodiments of the present disclosure;

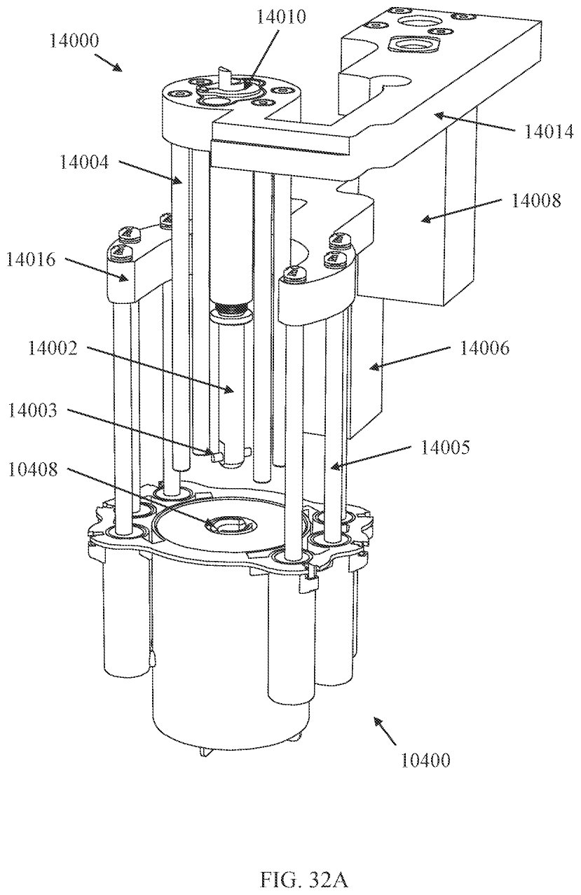

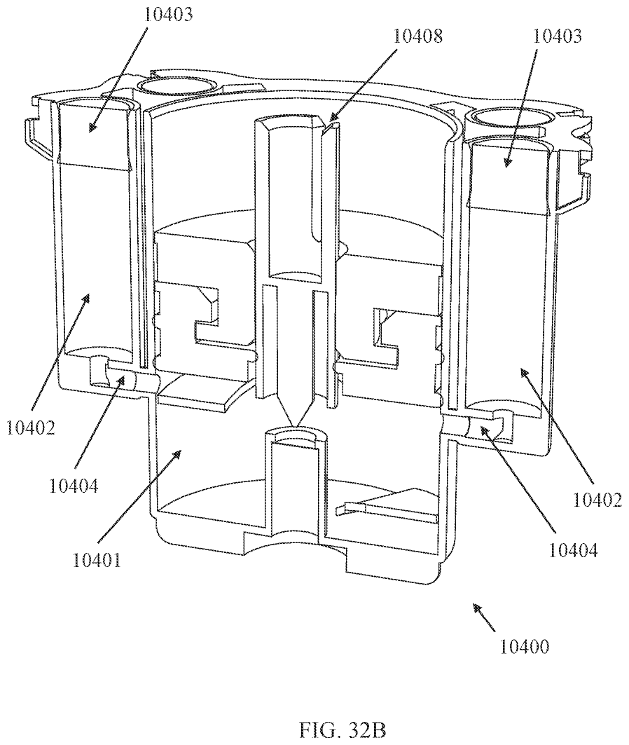

FIGS. 32A and 32B illustrate a mixer device and a capsule having peripheral repository tubular chambers, according to embodiments of the present disclosure;

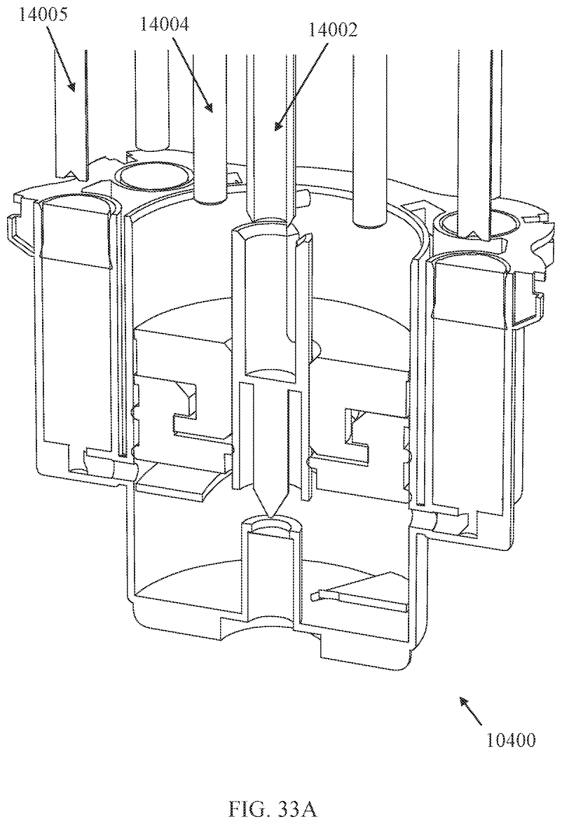

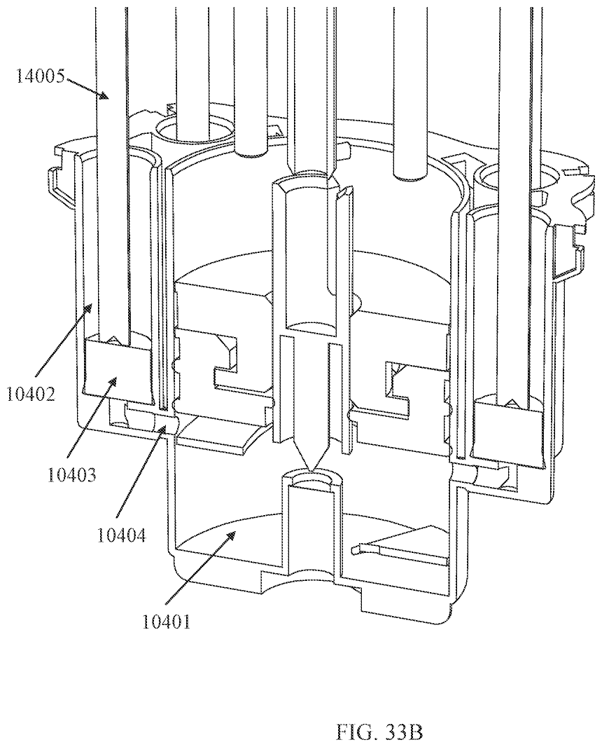

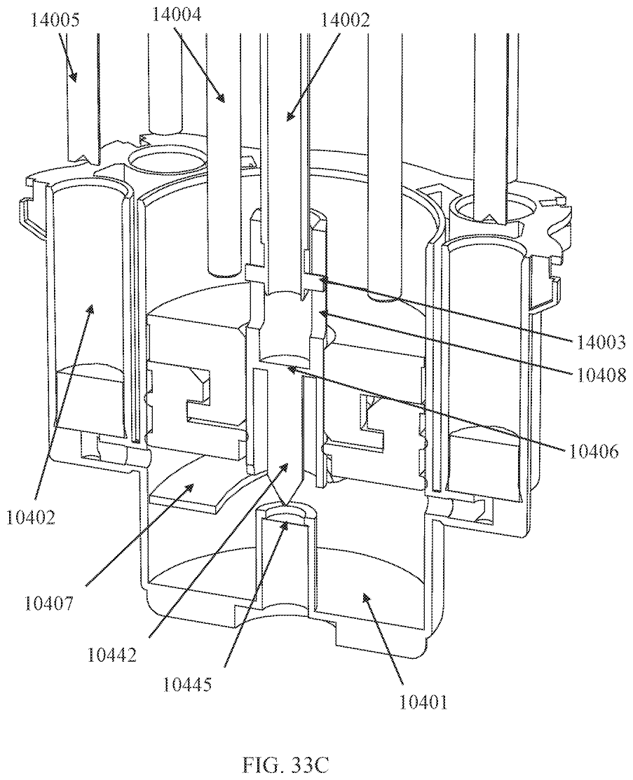

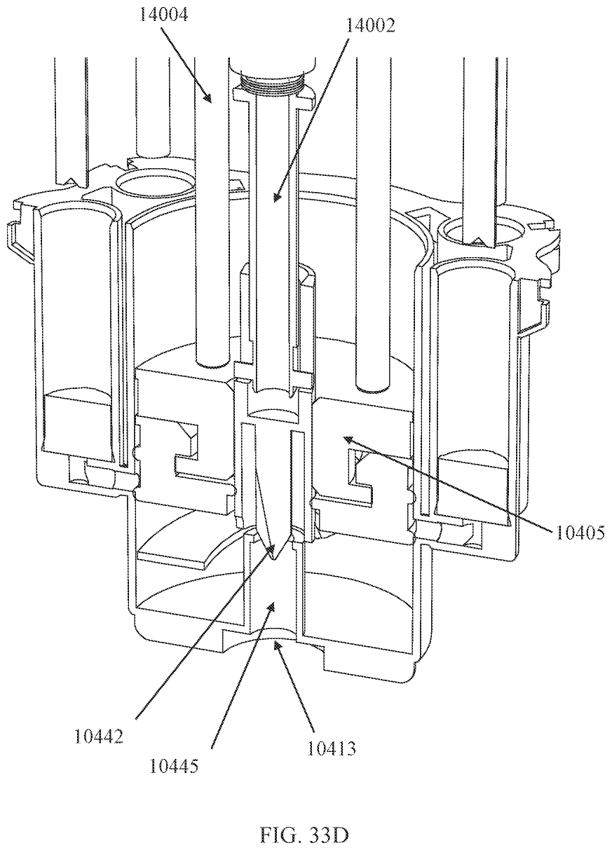

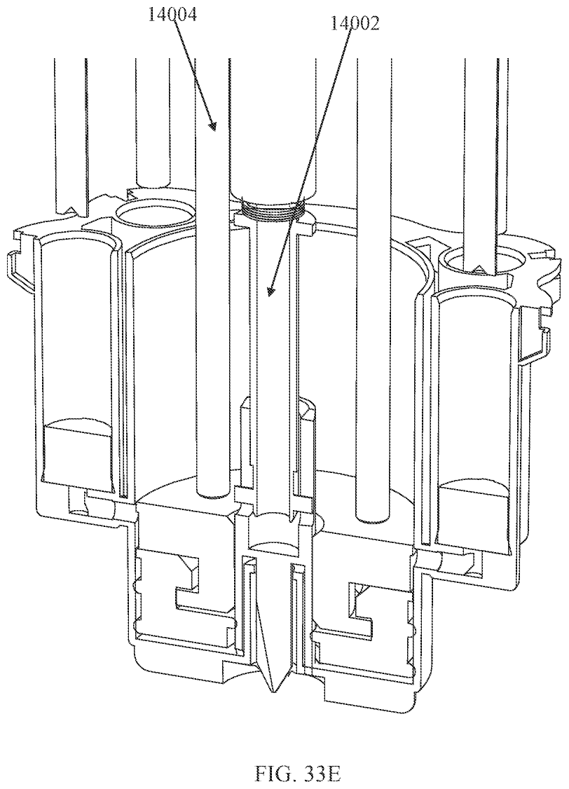

FIGS. 33A-33E illustrate a process of mixing and extracting formulations using the mixer device and the capsule of FIGS. 32A and 32B, according to embodiments of the present disclosure;

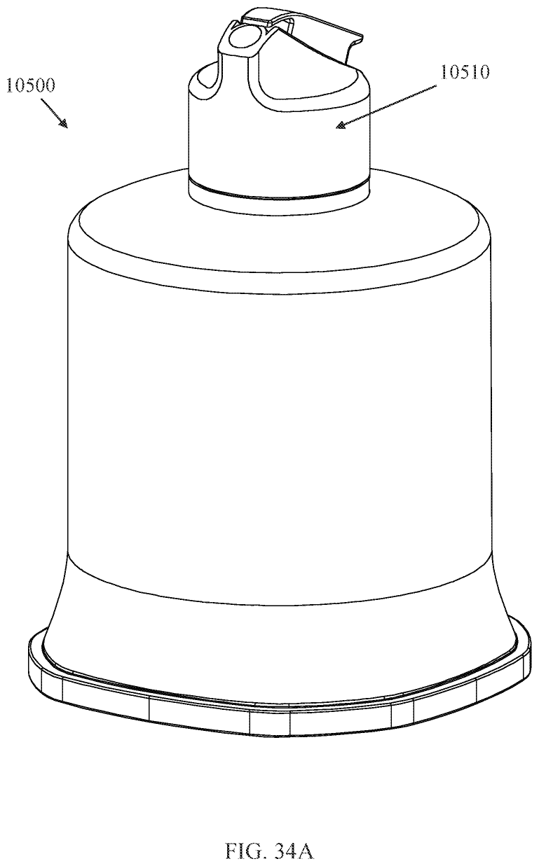

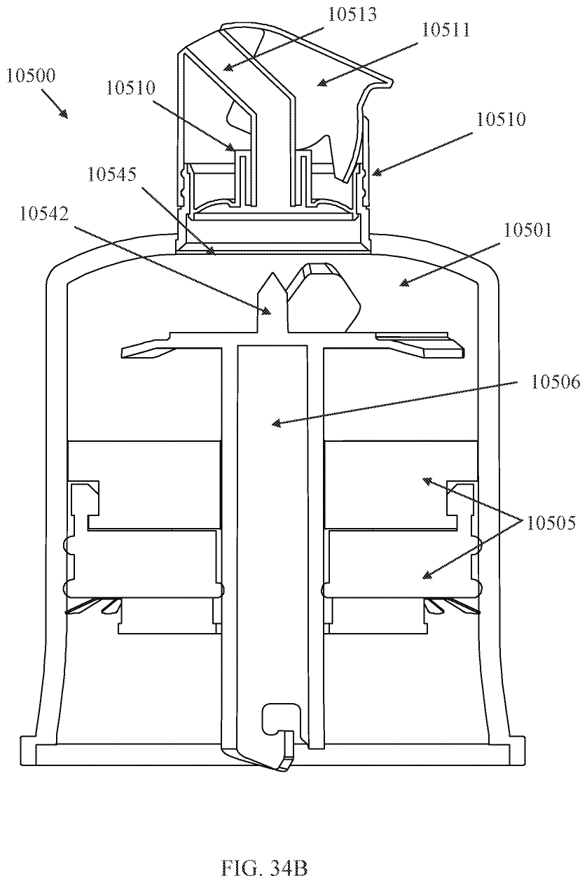

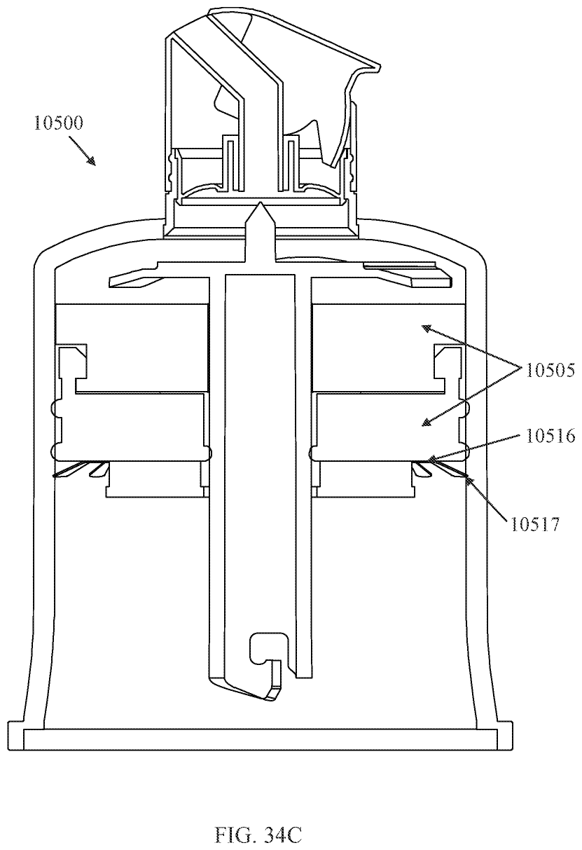

FIGS. 34A, 34B and 34C are side illustration and two section illustrations, respectively, of a capsule which includes an airless pump, according to embodiments of the present disclosure;

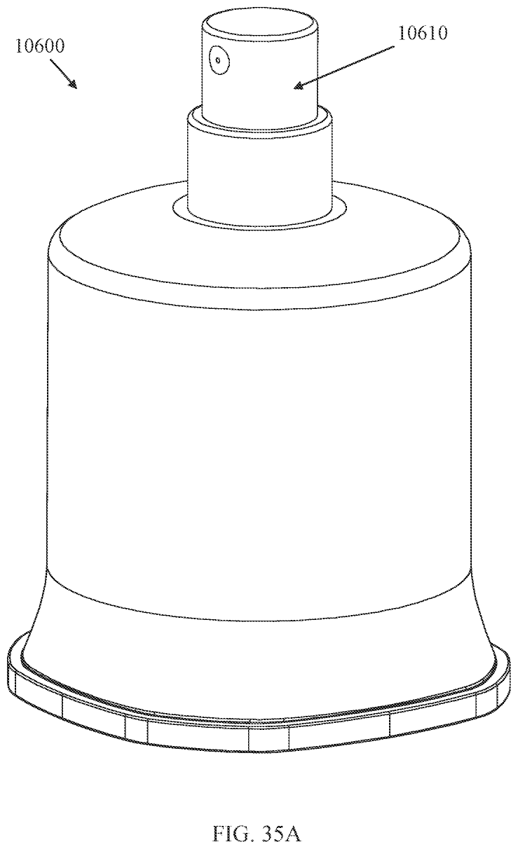

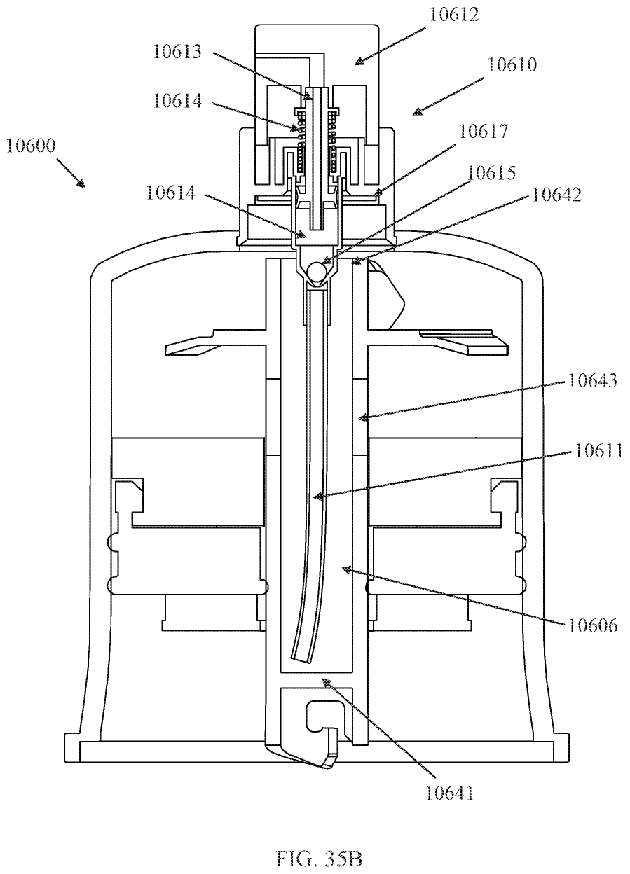

FIGS. 35A and 35B are side and section illustrations, respectively, of a capsule which includes a mist spray pump, according to embodiments of the present disclosure; and

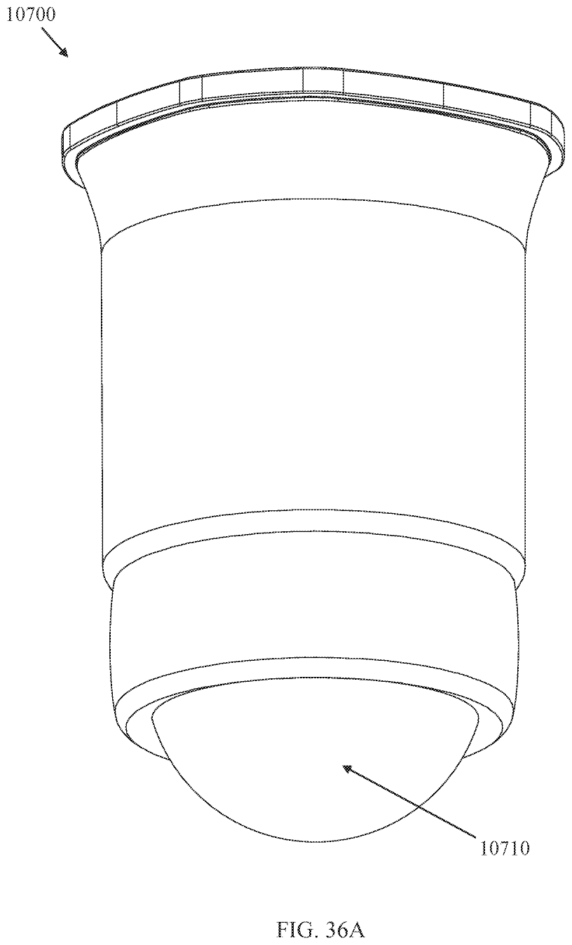

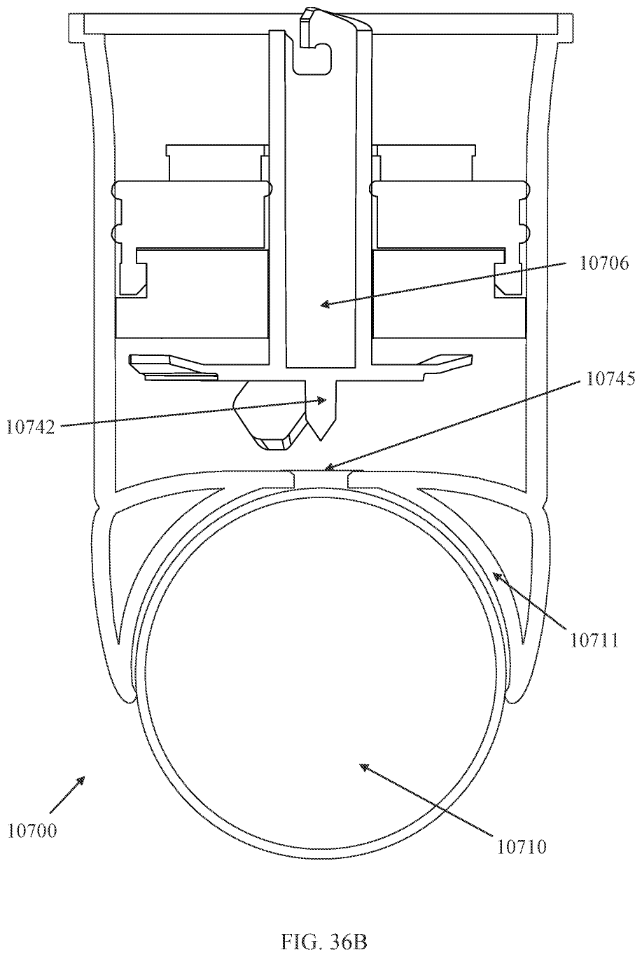

FIGS. 36A and 36B are side and section illustrations, respectively, of a capsule which includes a Roll-on ball, according to embodiments of the present disclosure.

### DESCRIPTION OF SPECIFIC EMBODIMENTS OF THE INVENTION

The present invention, in some embodiments thereof, relates to capsules and methods of mixing multiple substances therein, and more specifically, but not exclusively, to systems and methods for mixing and preparing formulations for consumer use.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, will control. In addition, the materials, methods, and examples are illustrative only and are not intended to be necessarily limiting.

According to embodiments of the present disclosure, a capsule is provided for mixing substances. The capsule includes a chamber. A mixer element for mixing fluids in the chamber is disposed at a distal end of a mixer rod. At least one piston is fitted in the chamber, having an aperture through which the mixer rod passes. The capsule also includes at least one ingredient receptacle, each containing a substance. The ingredient receptacles contain different substances that are ingredients of a formulation. The ingredient receptacles may be cavities within the piston and/or frangible containers arranged between the piston and the mixer element. The cavities are separated from one another, and each is filled with a different ingredient substance. Advantageously, the capsule includes all of the ingredient receptacles within the chamber, without requiring any peripheral chambers for storing the ingredients, enabling the capsule to be compact.

The capsule is fixable to a mixer device. According some embodiments, the mixer device includes a torque arm configured for linear and rotational movement. The torque arm may include a clamp or other connection mechanism for connecting with the mixer rod. When the clamp is engaged, the torque arm is capable of moving the mixer rod, both linearly and rotationally. The mixer device also comprises one or more pushing rods, which are configured to engage with the piston. Using the torque arm and pushing rods, the mixer device is capable of displacing the piston and mixer element relative to each other. This, in turn causes removal of the ingredients from the ingredient receptacles. Specifically, the ingredients are removed through extracting of the ingredients from the cavities, and/or through bursting the frangible containers. Once the ingredients are within the chamber, they are mixed with the mixer element, to form a formulation. The formulation may either be extracted from an exit opening of the chamber, may be accessed via removal of the piston/s from the chamber, or may be extracted via a dispensing mechanism.

According some embodiments, the mixer rod is moving helically relative to the piston and thereby rotating the mixer element. The rotational movement may be created by helical movement of an arm of the mixer device connected to the mixer rod, may be created by rotational movement of the arm which is converted to helical movement by a screw-like arrangement of helical grooves and helical ridges within the capsule, or may be created by linear movement of the torque arm which is converted to helical movement by a screw-like arrangement of helical grooves and helical ridges within the capsule. Optionally, the mixer device also comprises one or more pushing rods which are moving simultaneously to the arm of the mixer device. Optionally, the mixer device does not include pushing rods, and the ingredients are extracted from the ingredient receptacles by an element inside the capsule, which may be moving helically or linearly. These embodiments allow an implementation of a mixer device which includes only two or only one engine. Such a mixer device may be more compact and less expensive, which is significant for consumer use. Also, the operation of such a mixer device may be more reliable, produce less noise, and/or include simpler control mechanism(s).

Personalization of any type of preparation and/or customized mixture may be set-up by user preferences (manually or automatically by diagnosis) or may be set-up by an integrated diagnostic tool recommendation. For example, a capsule may contain 9 different raw substances that are stored separately and hermetically. In such examples, 8 substances are stored in the ingredient receptacles and a base substance is stored in the chamber. The final product that is produced may be any one of thousands of different final compositions of formulation, made from the same capsule.

Since the capsule provides, in exemplary embodiments, hermetic storage and full separation between the ingredients with sealed containers (prevention of exposure to oxygen nor light before use and between uses), many kinds of ingredients that are unstable and regularly may not be used in such preparations (since they are not functional and practically do not give any value), may be used effectively with the capsule's fresh preparation. Users may personalize and determine mixture-ratios of any supportable mixable raw-materials (powder, liquid and gas).

Unlike pre-prepared mixtures, in which the exact ratios are undisclosed, the formulation may be transparent to customers and may be viewed (when applicable) on the capsule or by platform-application.

The capsule design supports a wide range of raw materials and ingredients, liquids, semisolids (gels), gases and solids (powders), some of which are potentially unstable or incompatible. For example, these ingredients are sensitive to oxidation (air), to light (photosensitive) or may react and/or alter solubility of each other.

In some embodiments, the capsule design supports changeable quantities of raw materials inside each ingredient receptacle. It is also possible to partially fill in advance tubes with smaller quantities of ingredients. The capsule and mixer device design supports flexible and changeable feed-tube dimensions (even without seale-up or seale-down considerations). In some embodiments, the device allows preparation of small fresh batches (continuously) by mixing each time only part of each ingredient according to a user's parameters, and/or creation of different preparation types by selectively using only some of the ingredients. The mixer device allows one-time preparation or multiple preparations per capsule.

Since the capsule contains all ingredients inside the receptacles and not separately, there is no need for the user to manage ingredients separately and to level his supplies for specific optional formulas. Since the capsule contains an integral mixer inside, and since the capsule is external to the mixer device, the mixer device may be used repeatedly with no need of cleaning in between capsules. The mixer device may not require any setup by the user. The device may provide ready preparations within a very short time. Most of the mixture types may be ready within 30 to 60 seconds from turning on the device.

The preparations that may be made using the capsules and mixer device include, for example, Toiletries—personal hygiene for washing and preventing unpleasant smells such as soap, shampoo, deodorants and perfumes, Personal care—for beautification use (skin care, hair care, cosmetics) and/or preparations for dermatology (derma-cosmetics), Food additives—such as substances added to food to preserve flavor or enhance its taste, appearance, or other qualities, Nutritional supplements—for example taken orally, and usually contains one or more dietary ingredients (vitamins, minerals, herbs, amino acids, and enzymes), Pharma—such as medications or drugs, homeopathy, oral care, or dental preparations and Drinks—such as a cocktail made from different alcoholic and/or non-alcoholic liquids.

For example, the device may be used to create hair dyes that are made in specifically selected colors and/or shades. A hair dye capsule may include ingredients in different colors that are sealed inside the receptacles of the capsule. According to the selected color, a specific amount of each ingredient is inserted into the main chamber to create the desired color. The device may be used at home by the end user to create a different color of hair dye according to the user's choice, or may be used for example at a hair salon, to provide a different color of hair dye for each costumer.

For another example, the device may be used to create personalized medication for a patient. A medication capsule may contain several active pharmaceutical ingredients (APIs) and/or supplements, each stored inside one of the receptacles of the capsule. A medication and/or a mix of medications may be prepared for a patient, based for example on specific physician prescription and/or real-time measurements of a patient's medical data. A mix with the right doses and combination of drugs may be prepared for a specific patient at a specific time, and may be optimized and/or modified accordingly, by adjusting the quantity extracted from each receptacle into the chamber. This provides personalized, precise, on-demand medications, and/or a medication mix which is easier to take than multiple separate medications, and may also improve adherence of patients.

For another example, the device may be used to create a preparation (such as a cream) from pre-formulation ingredients. Each of the ingredient receptacles of a capsule may contain one pure ingredient or a mix of ingredients and/or additives, which are only raw materials and not formulations by themselves. When combined and mixed, the ingredients are turned into a formulation. For example, a water-based ingredient and an oil-based ingredient may be mixed to create a cream. In addition to modularity and personalization, this may reduce the required regulatory requirements, as the ingredients are not considered a formulation, such as cosmetic products, and potentially reduce cost.

Use of the capsules and mixer device may provide solutions to several needs of consumers. Users may want to have products that are self-prepared in real time, for example for reasons of freshness by mixing their ingredients just before use, minimizing the use of preservations and/or sensitive active raw materials that must be stored in sealed tubes with no contact with air/light for preventing oxidation or other instability reaction (for example antioxidants and/or vitamins). The capsule preserves chemical freshness by preventing instability on a molecular level (molecular change), physical freshness by preventing phase separation (such as with oil & water), biological freshness by preventing active ingredient loss of activity, and microbiological freshness (vegan ingredients and/or saving preservatives) by preventing product contamination and microorganisms growth. Users may want to choose ingredients having specific characteristics, for example, vegan (doesn't contain any animal products and/or doesn't contain products that were tested on animals) and/or organic (certified by an authorized certification organization). Users may want to use the capsules to mix ingredients that otherwise have to be mixed manually, such as baby formulas. Users may want to use products that have a “green” product life-cycle (no disposables). Users may want to have products that are custom made and/or personalized specifically for them. Users may want to control color, odor level, active ingredients ratios, sunscreens addition (and other personal care products) and/or any self-determined desired ratio of raw ingredients. Users may want to choose between available preparations formulas, define new formulas for their own use, use social network or the Internet to download a formula, use diagnostic tools with interfaces that support recommended formulas according to the user's special needs (such as skin analysis by camera scan) and/or use artificial intelligence (AI) which may provide deeper level of formulas recommendations and deeper insights about the user's needs.

The application may provide the user with the ability to use other users' data, insights and recommendations of formulas and treatments' results that are shared in large seale through social media and web-based communities and/or to connect and exchange data, creating opportunities for more direct integration of the physical world to other users, resulting in efficiency improvements and economic benefits.

Referring now to FIGS. 1A and 1B, capsule 100 includes body 117, a first end 112 and a second end 111. Capsule 100 further includes a chamber 101, into which ingredients for a formulation may be dispensed and mixed.

As used in the present disclosure, the “first end” is the end that engages with the mixer device, and the “second end” is the end adjacent to the mixer element and through which a mixed formulation may be dispensed. As used in the present disclosure, the terms “top” and “bottom” are used to refer to the orientation of the first end 112 and second end 111, relative to a floor, when the capsule 100 is engaged with the mixer device. For example, in the capsule of FIGS. 1A and 1B, the “first end” is on the “top” and the “second end” is on the “bottom.” As used in the present disclosure, the term “proximal” refers to a direction closer to the first end 112, and the term “distal” refers to a direction closer to the second end 111.

Capsule 100 may be made of any material, for example, acrylic glass (methyl methacrylate), polyethylene terephthalate glycol, polypropylene, acrylonitrile styrene (acrylate), polystyrene, aluminum, acrylonitrile butadiene styrene, polyethylene, terephthalate, or glass. Different preparations and different raw ingredients require different storage materials, such as chemical resistant materials to acids or bases, bio-safe materials especially for medical and/or nutritional supplements preparations and/or antioxidants or vitamins that need an oxygen barrier to preserve stability. The mixing and preparing process may also require specific material characteristics, for example thermal resistance. Optionally, an internal face of chamber 101 and internal components of capsule 100 may be produced from various materials according to specifications and requirements for storing certain ingredients. In addition, the structure of chamber 101 and internal components of the capsule 100 may be designed to withstand internal forces without deformation, for example when viscosity of the substances is high or increased, for example during refrigeration.

Capsule 100 includes a flat cover 115. Cover 115 includes a central aperture 116 for receiving therein a torque arm of a mixer device. Cover 115 also includes peripheral apertures 128 for receiving therein one or more pushing rods of the mixer device. The central aperture 116 and peripheral apertures 128 may be sealed with a perforated seal. For example, the seal may include scored lines arranged in an “x” configuration, such that the seal breaks easily upon application of pressure from pushing rods or a torque arm of a mixer device, and without causing chipping of the material of the cover 115 into the chamber 101.

Capsule 100 further includes a piston 105 fitted in the chamber 101. The piston 105 has a proximal end facing the first end 112 and a distal end facing the second end 111. The piston 105 is generally cylindrical, seating in a fluid-tight fashion against the walls of chamber 101, and has an aperture 125 through which a mixer rod 106 passes. Piston 105 includes a plurality of receptacles 102. Capsule 100 further includes a proximal pistons arrangement 122. Proximal pistons arrangement 122 includes a plurality of proximal pistons 103, with each proximal piston 103 arranged corresponding to a receptacle 102. Proximal pistons arrangement 122 also optionally includes plate 109, to which proximal pistons 103 are optionally secured.

Mixer element 107 is arranged within chamber 101 between the piston 105 and the second end 111, and includes a plurality of blades. Mixer element 107 may be of any shape or type, structure, or material, as needed for different types of preparations. The mixer element 107 is disposed at a distal end of mixer rod 106. Mixer rod 106 includes a torque adapter 108 for connecting to a linear and rotational actuator of a mixer device.

Capsule 100 further includes an exit opening 113, for dispensing mixed substances from the capsule. Exit opening 113 may be sealed, for example with a membrane or any other type of seal. Alternatively, the seal may be a bottom piston, such as that described in FIGS. 23A-24C of International Patent Publication WO2020/105053. Exit opening 113 may include a single opening, as in the depicted embodiments, or may be comprised of multiple adjacent openings.

FIG. 2A depicts capsule 100 with its cover removed. Mixer rod 106 is visible in the center of the capsule, with torque adapter 108 extending outward and available to be connected to a clamp of a mixer device. In the embodiment of FIG. 2A, there are eight proximal pistons 103b. FIG. 2B depicts capsule 100 with a plate 109a of the proximal pistons arrangement 122a. Six proximal pistons 103a are visible.

FIGS. 3A-3D provide further views of the proximal pistons arrangement 122 and pistons 105. Each proximal piston 103 is aligned with a respective cavity 102 of piston 105. The cavities 102 are mechanically separated, so each may contain a different ingredient substance without any contact between the substances. Each cavity 102 may be a cylindrical aperture having a proximal opening at a proximal end of the piston 105 and a distal opening at a distal end of the piston 105. In FIGS. 3A and 3C, there are six proximal pistons 103a and six cavities 102a. In FIGS. 3B and 3D, there are eight proximal pistons 103b and eight cavities 102b. The use of six or eight proximal pistons 103 and cavities 102 is merely exemplary, and any suitable number of proximal pistons and cavities may be used. Optionally, a single cavity and a single proximal piston are used. The proximal pistons 103 may be attached to the plate 109, such that all the proximal pistons 103 are depressed simultaneously when the plate 109 is depressed. Alternatively, the proximal pistons 103 may be separable from the plate 109, or the plate 109 may be absent entirely, such that each proximal piston 103 is a separate piston. In such embodiments, each proximal piston 103 is separately movable relative to a respective cavity 102. Optionally, the cavities 102 are long enough to include the entire length of the proximal pistons 103 when the cavities 102 are full. Optionally, each of the cavities 102 includes a top seal which is covering the top of the cavity, including the proximal piston 103. The top seal may be broken, for example, by the pushing rods or by a second proximal pistons arrangement pushed by the pushing rods.

Optionally, the number of proximal pistons 103 and cavities 102 is the same as the number of pushing rods of the mixer device, and each pushing rod is aligned with a respective piston 103 and cavity 102. In this case, each pushing rod is pushing the respective piston 103 directly without a plate 109. To ensure alignment between the pushing rods and the respective pistons 103, the capsule 100 may include an alignment element that forces the piston 105 into one orientation, or one of several orientations. The alignment element may be, for example, elongated protrusions on the inside surface of the main chamber 101, which compatible with depressions on the outer part of the piston 105.

The proximal pistons arrangement 122a, 122b includes a central aperture 124a, 124b through which mixer rod 106 passes. Similarly, piston 105a, 105b includes a central aperture 125a, 125b through which the mixer rod 106 passes. As a result, the mixer element 107, proximal pistons arrangement 122, and piston 105 are all separately displaceable relative to each other along the axis of mixer rod 106.

Piston 105a, 105b may also include a gasket 123a, 123b, on a lateral edge thereof, for maintaining a fluid seal between the lateral edge of the piston and the interior face of chamber 101.

Optionally, the proximal pistons 103 and cavities 102 are arranged in two or more concentric circular arrangements around the central aperture 125 of the piston 105. Each circular arrangement may be pushed separately by a respective plate 109. This provides more control over the insertion of the ingredient substances into the main chamber 101. For example, when ingredient substances stored inside cavities 102 of one circular arrangement need to be mixed before ingredient substances stored inside cavities 102 of another circular arrangement, the plate 109 of one circular arrangement is pushed first, and the plate 109 of the other circular arrangement is pushed later.

FIG. 4 depicts the mixer rod 106 and mixer element 107. Mixer rod 106 includes torque adapter 108. Mixer element 107 may be of any shape or type, structure and/or material, for example for different types of preparations. Different preparation types (made of liquids or liquids and powder) that are mixed inside the chamber 101 have different viscosities and levels of stickiness. For example, hair color preparations and many kinds of creams, whose ingredients have a higher viscosity, are harder to mix effectively than perfumes and toiletries. The same is true for syrups of nutritional supplements and/or food additives, for which some of their ingredients are relatively sticky. The choice of mixer elements type and blades width is influenced by the type of preparation ingredients to achieve effective process (homogeneous preparation and quick mixing).

Mixer element 107 includes blades 140. Mixer element 107 may also include a sharp tip 142. The sharp tip 142 may be used, in certain embodiments, to penetrate a seal closing opening 113 (shown in FIG. 1B), to permit dispensing of mixed formulation from the chamber 101. Mixer element 107 may also include flexible blades 143. The flexible blades 143 may aid in mixing by preventing “dead zones” inside chamber 101 where unmixed materials may stick together. The flexible blades 143 may be flattened to be coplanar with the other blades 140, for example, when the mixer element 107 is compressed during extraction of formulation substances from the capsule 100, as will be discussed further herein.

Mixer element 107 may also include sharp tips 126, which are piercing a seal of the receptacles 102 and/or frangible containers as described below, allowing ingredient substances to be released. The sharp tips may be of any shape and size, as exemplified below. The sharp tips may pierce foil sealing the receptacles 102 by an upward motion of the mixer element 107 and/or cut the foil by a turning motion of mixer element 107.

FIG. 5A shows capsule 100 filled with one or more ingredient substances. Cavities 102 of the piston 105 are filled with ingredient substances 118. Thus, the cavities 102 themselves are ingredient receptacles, with the top of the ingredient receptacles formed by the ends of the proximal pistons 103. The ingredient substances 118 may be different from each other or the same as each other. Optionally, cavities 102 are sealed with a frangible seal 130, for example made of foil, arranged at the distal end of the piston 105, to retain the ingredient substances 118 within the cavities 102. The foil 130 may be sufficiently resilient to prevent foil 130 from being burst inadvertently, e.g., despite the force exerted on the foil 130 by the ingredient substances 118. Chamber 101 also optionally includes a base substance 120. The base substance 120 may be a relatively generic material, such as a cream, into which other ingredients are mixed. The base substance 120 may be an ingredient of all formulations made with the capsule 100, and thus may be stored in the chamber 101, without requiring an additional step of inserting the base substance 120 into the chamber 101. In addition or in the alternative, base substance 120 is a substance that is crystallized when refrigerated, such as a substance based on petroleum jelly, which cannot be easily extracted from cavities 102. The crystallization may be reversed when other ingredient substances 118 are mixed with base substance 120. Base substance 120 may also, be, for example, a powder.

When proximal pistons 103 are depressed downward relative to piston 105, the proximal pistons 103 optionally burst the foil 130, and expel the ingredient substances 118 out of the cavities 102 and into the chamber 101. Subsequently, the mixer element 107 is rotated, to mix the expelled ingredient substances 118 with each other and/or with the base substance 120.

Referring now to FIG. 5B, instead of ingredient substances 118 being filled directly into cavities 102, the ingredient substances 118 may be filled into frangible containers 119, which are then placed into cavities 102. Frangible containers 119 may be made of any suitable material, such as a foil or a plastic. The frangible containers 119 may be of a material which preserves sterility of ingredient substances 118, preventing the ingredient substances 118 from interacting with the material of capsule 100 during storage. Frangible containers 119 may be designed to burst when subjected to a predetermined minimum pressure, thereby releasing the ingredient substances from the frangible containers 119 and into the chamber 101. This minimum pressure is greater than an ambient pressure exerted by other contents of the capsule 100 on the frangible containers 119. This minimum pressure is delivered when the mixer element 107 and the proximal pistons 103 are moved toward each other, thereby compressing the frangible containers 119 in between the proximal pistons 103, piston 105, and the mixer element 107. In addition or in the alternative, the frangible containers 119 may be burst with sharp tips, as will be discussed further herein.

Typically, when foils 130 or frangible containers 119 are burst, the ingredient substances 118 contained in receptacles 102 are released in their entirety into chamber 101. Because capsule 100 is oriented with the first end 112 at the top and the second end 111 at the bottom, once the receptacles 102 are open, the force of gravity may operate on the ingredient substances 118 to release the ingredient substances into the chamber 101. Thus, the embodiments of capsule 100 are particularly suited to formulations in which all ingredients are measured and included in the capsule 100 in their desired quantities in advance.

Referring now to FIG. 5C, frangible containers 119 may additionally or alternatively be located in the space between piston 105 and mixer element 107. As shown in FIG. 5C, there are a plurality of frangible containers 119 in the chamber 101, and, in addition, ingredient substances 118 are filled within cavities 102. When mixer element 107 and proximal pistons 103 are compressed relative to each other, the frangible containers 119 burst, and both the ingredient substances 118 in the cavities 102, and the ingredient substances 118 in the frangible containers 119, are released into the chamber 101. As discussed above, this bursting may be caused through pressure alone, or there may be sharp tips arranged on the mixer element 107, with the sharp tips being long enough to pierce both the frangible containers 119 and a foil 130 covering the cavities 102. The embodiment of FIG. 5C is particularly advantageous when many unique ingredients are to be included in the formulation.

FIGS. 6A and 6B depict a second embodiment of a capsule 200. Capsule 200 is similar in most respects to capsule 100, and accordingly similar reference numerals refer to similar elements, except that they begin with the number “2.” Capsule 200 includes a plate 225 in between the mixer element 207 and the piston 205, with sharp tips 226 directed toward the piston. In addition, the proximal pistons 203 of the proximal pistons arrangement 222 include substantially conical cavities 227, which serve as receptacles 202. The conical cavities 227 are sized and shaped to receive therein the sharp tips 226 when the piston 205 and mixer element 207 are compressed relative to each other. Frangible containers 219 are stored in the cavities 202, or, in the alternative, ingredient substances 218 are stored directly in receptacles 202 which are sealed by foils 230. In operation, when the piston 205 and mixer element 207 are compressed relative to each other, each sharp tip 226 pierces a frangible container 219 or a foil, allowing ingredient substances within the frangible container 219 or receptacle 202 to be released. The sharp tip 226 may be further inserted into the receptacles 202, applying additional pressure on the frangible container 219 to further extract substances therefrom. The conical cavities 227 serve as a backstop for the sharp tips 226, allowing for complete compression of the frangible containers 219 and complete extraction of the ingredient substances by the sharp tips 226. Plate 225 may also include holes and/or may be made of a grid, to allow the ingredient substances to be easily moved through into chamber 101.

Sharp tips 226 may be shaped in any suitable fashion for piercing containers 219. Similarly, various mechanisms for piercing may be employed. For example, the tips 226 may penetrate the containers 219 or foils 230 with a vertical movement. In addition, the tips 226 may penetrate containers 219 or foils 230 while turning, for example, in a scratching motion.

Optionally, plate 225 further includes alignment rods 231, and piston 205 includes alignment slots 233. The piston 205 and mixer element 207 are compressible relative to each other only when the alignment rods 231 are aligned with alignment slots 233, and thus the sharp tips 226 are aligned with the conical cavities 227.

Sharp tips 226 may alternatively be located on any other surface that comes into contact with frangible containers 219. For example, as shown in FIG. 6C, the sharp tips 226 may be placed on the proximal pistons 203. Alternatively, the sharp tips may be installed directly on a proximal surface of the mixer element 207.

FIG. 7 depicts a third embodiment of a capsule 300. Capsule 300 is similar in many respects to capsule 200 and accordingly similar reference numerals are used to refer to similar elements, except that they are preceded with “3”. In particular, capsule 300 includes sharp tips 326 on mixer element 307, and ingredient substances 318 stored in cavities 302 in piston 305. Capsule 300 differs from capsule 200 in that, while the ingredient substances 318 are stored in cavities 302 in piston 305, there are no proximal pistons for extracting ingredient substances 318 out of cavities 302. Instead, as soon as sharp tips 326 pierce foil 330, ingredient substances 318 descend into chamber 301 by the force of gravity. Capsule 300 is particularly suited for ingredient formulations in which the ingredients are liquid.

FIGS. 8A-11B depict four additional embodiments of a capsule 400. These embodiments are similar in most respects to the previous embodiments, and to each other, and accordingly similar reference numerals are used to refer to similar elements, except that they are preceded with “4.” Each of these embodiments is depicted with its first end facing up and its second end facing down, similar to capsules 100 and 200.

Capsule 400 differ from the prior embodiments in that only a single piston is included in the capsule. Taking the example of FIG. 8A, piston 405 is arranged within capsule 400 between first end 412 and mixer element 407. A plurality of ingredient receptacles 419 are arranged between the distal end of piston 405 and the mixer element 407. In the embodiment of FIG. 8A, the ingredient receptacles 419 are discs with a central aperture 428 (shown in FIG. 8B) for receiving the mixer rod 406 therein. Discs 419 may be substantially cylindrical, bagel-shaped, or torus-shaped, as shown in FIG. 8B, and may be sized to fit the dimensions of chamber 401. Discs 419 are stacked one on top of the other. Capsule 400 may also include a base substance (not shown) within chamber 401 between piston 405 and the second end 411.

When piston 405 and mixer element 407 are compressed relative to each other, the plurality of frangible containers 419 burst, releasing ingredient substances into the chamber 401. Specifically, each of the frangible containers 419 may be configured to burst when subjected to a predetermined pressure, which is greater than an ambient pressure exerted by the other contents of the capsule 400 on the frangible containers 419.

Referring to FIGS. 9A and 9B, capsule 400 includes a single, accordion-shaped receptacle 429. Accordion-shaped receptacle 429 also includes a central aperture 458 for receiving the mixer rod therein. Folds of the accordion-shaped receptacle 429 are pressed together when the piston and mixer element are compressed relative to each other. Optionally, one or more additional frangible seals are placed internal to the accordion-shaped receptacle, to keep different ingredients hermetically sealed from each other prior to preparation of the formulation. An advantage of this accordion-shaped receptacle 429 is that to assemble capsule 400, it is necessary to insert only a single ingredient receptacle 429.

Referring to FIGS. 10A and 10B, capsule 400 includes a plurality of narrow wedge-shaped receptacles 439. The wedge-shaped receptacles 439 together form a central aperture 458 through which the mixer rod passes. The wedge-shaped receptacles 439 have a length approximately equivalent to a radius of the chamber, such that the receptacles fit between the mixer rod and the wall of the chamber. While a single level of wedge-shaped receptacles 439 are illustrated, there may also be multiple levels of wedge-shaped receptacles 439 arranged one on top of the other.

Referring to FIGS. 11A and 11B, capsule 400 includes a plurality of spherule-shaped receptacles 449. As shown in FIG. 11A, there may be multiple spherule-shaped receptacles 449 arranged alongside each other. Spherule-shaped receptacles 449 may be substantially rounded, may have some edges and/or may alternatively be of any other shape. While several spherule-shaped receptacles 449 are illustrated, there may be any number of spherule-shaped receptacles 449 arranged in any manner inside the chamber 401.

FIGS. 12A and 12B show an alternative embodiment of a capsule 500. Capsule 500 is similar in many respects to capsule 400, and thus similar reference numerals are used to refer to similar elements, except that they begin with “5.” In FIG. 12A, mixer element 507 has a plurality of sharp tips 526 arranged on a proximal end thereof, and the piston 505 has a plurality of conical cavities 527. When the piston 505 and mixer element 507 are compressed relative to each other, the sharp tips 526 puncture the frangible containers 519, causing the ingredient substances therein to enter the chamber 501. Optionally, a protective layer 525 is arranged between the sharp tips 526 and the frangible containers 519. The protective layer 525 is pierceable by the sharp tips only upon application of a predetermined pressure, which is greater than a pressure required to pierce the frangible containers 519. The protective layer 525 thus prevents accidental piercing of the frangible containers 519 by the sharp tips 526.

FIG. 13 depicts another embodiment of a capsule 600. Capsule 600 is similar in most respects to the previous embodiments of capsules, and thus similar reference numerals are used to refer to similar elements, except that they begin with “6.” In particular, the internal components of capsule 600 may be identical to any of those described in connection with the other embodiments. Furthermore, like the previously described embodiments, capsule 600 is arranged with the first end 612 at the top and the second end 611 at the bottom. Capsule 600 differs from the previously described embodiments in that there is no exit opening at the second end 611. Instead, cover 615 is removable. In addition, cover 615 is generally rounded or hat-shaped and is configured to receive therein certain internal components of capsule 600 prior to removal of cover 615, as will be discussed further herein. Like cover 115, cover 615 includes a central aperture 616 for receiving therein a torque arm of a mixer device, and peripheral apertures 628 for receiving therein one or more pushing rods of the mixer device.

FIGS. 14A-14C depict another embodiment of a capsule 800. Capsule 800 is similar in most respects to the previous embodiments of capsules, and thus similar reference numerals are used to refer to similar elements, except that they begin with “8.” Capsule 800 differs from the other embodiments in that the first end 812 is oriented at the bottom of the capsule 800 and the second end 811 is oriented at the top of the capsule 800. Capsule 800 also includes a cup-shaped reservoir 810 having a reservoir bottom opening 814, for receiving mixed substances from the exit opening 813. Cup-shaped reservoir 810 may have any concaved shape, whereby the rim of the reservoir 810 is higher than the center of the reservoir 810. The shape may include a substantially flat bottom and substantially vertical walls, or may include a gradual angle, for example at least 1 degree. The reservoir bottom is fixated to the top of chamber 801 such that the reservoir bottom opening 814 is aligned with the exit opening 813. Reservoir bottom opening 814 may be sealed, for example, by a membrane and/or any other seal. Reservoir bottom opening 814 may include a single opening, as in the depicted embodiments, or may be comprised of multiple adjacent openings. Reservoir 810 may be detachably fixated to the top of chamber 801, or may be permanently fixated to the top of chamber 801. In exemplary embodiments, the cup-shaped reservoir 810 and chamber 801 are manufactured as one casted part.

FIG. 14B illustrates certain internal components of capsule 800, including piston 805 having central aperture 825, mixer element 807, and mixer rod 806 with torque adapter 808. In general, the internal components of capsule 800 may be identical to those described and illustrated in connection with capsules 100, 200, 300, 400, 500, or 600, except that they are inverted 180 degrees. An advantage of this configuration is that it is possible to control the volumes of the ingredient substances that are dispensed from the cavities of capsule 800. This is because, in the absence of an external source of pressure, the ingredient substances remain in place due to gravity. Also, in FIG. 14B, there is no plate, and each proximal piston 803 is supported in place solely by being partially inserted into piston 805.

FIG. 14C illustrates a partial exploded view of mixer element 807 and piston 805. Optionally, mixer element 807 includes a nub 844, and piston 805 may optionally include a slot 845. The slot 845 is sized to receive the nub 844 therein. When the nub 844 is within the slot 845, piston 805 is rotationally fixed to the mixer element 807, such that rotation of the mixer rod 806 also causes rotation of the piston 805. Optionally, there are more than one nub 844 and slot 845. The rotation of the piston 805 may be useful in order to align different cavities with pushing rods of a mixer device, as will be discussed further herein. Apart from a nub 844 and slot 845, there are various alternative options for engaging and rotationally fixing the mixer element 807 and the piston 805. For example, there may be a magnetic connection, or an engagement that is effected through rotation of the mixer element 807 rather than, or in addition to, vertical movement of mixer element 807.

In exemplary embodiments, in the process of assembling any of capsules 100-800, components arranged near the second end are inserted before components arranged near the first end. Taking capsule 100 as an example, the capsule body 117 is first provided, with chamber 101 defined therein. Optionally, opening 113 is then sealed for example by foil. Mixer element 107 and mixer rod 106 are then inserted into the chamber 101 from the first end 112 and positioned next to the second end 111. Optionally, at least one frangible ingredient container 119 is inserted in the chamber 101 proximal to the mixer element 107. Optionally, a plurality of frangible containers 119 are stacked around the mixer rod 106, as illustrated in FIG. 5C, FIG. 8A, FIG. 10A, and FIG. 11A. Piston 105 is then inserted into the chamber 101, with aperture 125 arranged around mixer rod 106. Each of the frangible ingredient containers 119 is configured between the proximal end of the piston 105 and the mixer element 107. Optionally, instead of placing the frangible ingredient containers 119 before the piston 105 (as would be done in the embodiment of FIG. 5C), the frangible containers 119 may be inserted into cavities 102 in the piston 105 (as in the embodiment of FIG. 5B), and the piston 105 and frangible containers 119 are simultaneously inserted into the chamber 101. In addition, as discussed above, instead of inserting frangible containers 119 into cavities 102 of the piston 105, ingredient substances are filled directly into ingredient receptacles arranged in the respective cavities 102. After all of the internal components of the capsule are inserted, a cover 115 is secured at the first end 112.

FIG. 15 is a flow chart depicting steps of a method 900 for mixing substances within capsules and extracting mixed formulations from the capsules. FIG. 16 schematically depicts operational elements of a mixer device 1000 that is used for mixing substances within any of the embodiments of capsules described above. FIG. 17 illustrates performance of steps of method 900 that are specific to capsule 600. FIGS. 18A-M depict stages of a mixer device 1100 mixing substances within capsule 100 and similar embodiments, with the first end at the top and the second end at the bottom. FIGS. 19A-L depict stages of a mixer device 1200 mixing substances within capsule 800 and similar embodiments with the first end at the bottom and the second end at the top. Method 900 is applicable to mixing formulation substances in each of these mixer devices. For ease reference, the method steps are introduced first in reference to schematic mixer device 1000. Specific variations are then described with reference to mixer devices 1100 and 1200.

At step 901, a user places the capsule to be fixed into the mixer device 1000. The fixing may include, for example, a movement of a tray with the capsule into a position within the mixer device. In some embodiments, the engagement of the mixer rod by the torque arm 1002 may be considered as the fixing of the capsule.

Mixer device 1000 is shown acting on a capsule having the external features of capsule 100. Mixer device 1000 includes two linear actuators 1006 and 1008, which move up and down along axis A. Linear actuator 1006 adjusts the height of torque arm 1002, which is attachable to the torque adapter of the mixer rod. Once the torque arm 1002 is attached to the mixer rod, rotation of the torque arm causes corresponding rotation of the mixer element. Linear actuator 1008 adjusts the height of pushing rods 1004. Each pushing rod 1004 is aligned with a peripheral aperture 128, and is configured to push a proximal piston and/or a piston within the capsule. Mixer device 1000 also includes a rotational actuator 1010 for rotating the torque arm 1002.

Notably, pushing rods 1004 are substantially co-radial relative to a center of a capsule, and they are the only type of pushing rods that are used in mixer device 1000. Because the capsules used with mixer device 1000 do not have any peripheral chambers, there is no need to have inner pushing rods and peripheral pushing rods.

At step 902, the mixer device 1000 extracts ingredient substances from the ingredient receptacles and release the ingredient substances into the chamber. Depending on the type of capsule that is used, this step may be performed in multiple sub-steps and in different ways.

For example, at step 902a, mixer device 1000 compresses the piston and mixer element relative to each other. The piston may be moved toward the second end by pushing rods 1004 while the mixer element remains stationary, held in place by torque arm 1002. Alternatively, the mixer element may be withdrawn toward the first end with torque arm 1002 while the piston remains stationary. In certain embodiments of capsules, this compressing is sufficient to extract the ingredient substances, for example, when the ingredient substances are stored in frangible containers between the piston and the mixer element.

In addition or in the alternative, at step 902b, the mixer device 1000 compresses the proximal pistons assembly having a plate and proximal pistons, and/or separate proximal pistons, relative to the piston. The proximal piston may be moved toward the second end by pushing rods 1004 while the piston remains in place, held in place by the mixer element, which is in turn held in place by the torque arm 1002. In certain embodiments, the pushing rods 1004 push a plate to which proximal pistons are connected, causing all of the proximal pistons to be simultaneously compressed relative to the piston. Alternatively, one or more pushing rods 1004 may separately push individual proximal pistons relative to the piston. An example of such alternative embodiments is illustrated in FIGS. 19A-19L.

As in step 902a, step 902b may alternatively be performed with a withdrawing action. For example, the mixer element may be withdrawn toward the first end and press against the piston, causing withdrawal of the piston relative to the proximal piston.

During the extracting step 902, at step 902c, the mixer device 1000 may burst or puncture ingredient receptacles. The ingredient receptacles may be burst with pressure or may be punctured with sharp tips, as discussed above.

Referring back to FIG. 15, at step 903, mixer device 1000 mixes the ingredient substances within the chamber. Mixing is performed by using rotational actuator 1010 and torque arm 1002 to rotate the mixer rod.

At steps 904-907, the mixed substances are extracted out of the capsule. Depending on the type of capsule that is used, this process is performed differently.

For capsules with removable covers, such as capsule 600, each of the internal components of the capsule 600—namely, the piston 605, mixer element 607, and proximal pistons arrangement (when present) may optionally be withdrawn into a recess of the rounded cover 615. This removal is indicated at step 904. Then, at step 905, the cover 615 with the piston 605, mixer element 607, and proximal piston stored therein is removed from the capsule 600. A view of the cover 615 and capsule 600 following this removal is illustrated in FIG. 16. At step 906, the capsule is released from the mixer device, so the user may remove the capsule and accesses the mixed substances out of the now-opened capsule 600.

For capsules with exit openings, the mixed substances are extracted through the exit opening. This extraction is indicated at step 907, and is illustrated in FIGS. 18A-M and 19A-L, below.

FIGS. 18A-18M depict stages of mixing a formulation within capsule 100, using mixer device 1100. Mixer device 1100 operates similarly in many respects to the mixer device described at International Patent Publication WO2020/105053, in FIGS. 7A-7B and 9A-9I.

Mixer device 1100 includes a controller (not shown). The controller may include a processing circuitry which executes software that includes instructions for performing a method according to some embodiments of the present invention. The processing circuitry may include a computer readable storage medium (or media) having computer readable program instructions thereon for causing a processor to carry out aspects of the present invention. The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the processing circuitry, partly on the processing circuitry, as a stand-alone software package, partly on the processing circuitry and partly on a remote computer or entirely on the remote computer or server. In the latter scenario, the remote computer may be connected to the processing circuitry through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

In exemplary embodiments, the controller includes a communication module, which may connect via a network to a computing device operated by the user, such as a mobile phone. The user may provide instructions to the controller via a user interface of the computing device, for example by a software application installed on the mobile phone. The user may select the properties of the desired mixture, and the application and/or controller may calculate the correct movements of components of mixer device 1100 to create the desired mixture.

As seen in FIG. 18A, mixer device 1100 includes a tray 1101. Tray 1101 includes a central opening through which the body 117 of capsule 100 is inserted. The opening is large enough to accommodate the body of capsule 100, but not large enough to accommodate a rim 150 of capsule 100. Therefore, rim 150 of capsule 100 extends over the edges of the opening of tray 1101, to secure the capsule 100 in place. Other mechanisms for fixing the capsule in place may include, for example, rails on device 1100 on which capsule 100 may slide, a threaded opening for attaching the capsule 100 in a screwing motion, or clips for locking the capsule 100 in place.

Tray 1101 has an open position, shown in FIG. 18A, wherein capsule 100 may be inserted or removed, and a closed position, shown in FIG. 18B, wherein the capsule 100 is fixed inside mixer device 1100. The tray 1101 is movable between the open and closed positions via operation of a gear system 1112, which may include rack-and-pinion gears. In addition or in the alternative, the tray is movable using rails. Opening and closing of tray 1101 may be performed manually or with the controller.

Optionally, capsule 100 fixed in tray 1101 is identified by the controller, for example by scanning a barcode printed on the capsule 100, such as a quick response (QR) code. This may be done, for example, by an imaging sensor (not shown) included in mixer device 1100. Optionally or alternatively, capsule 100 is identified by device 1100 using a radio-frequency identification (RFID) chip included in the capsule, and an RFID reader included in device 1100.

FIG. 18C is a cross-section view of mixer device 1100 with capsule 100 therein. Mixer 1100 includes torque arm 1102. Torque arm 1102 is attached to linear actuator 1106 via lateral arm 1116. Torque arm is also attached to rotational actuator 1110. Mixer 1100 further includes one or more pushing rods 1104, which are attached to linear actuator 1108 via lateral arm 1114. In the illustrated embodiment, two pushing rods 1104 are visible. Torque adapter 1103 is attached to the lower end of torque arm 1102, and is configured to secure torque adapter 108 of capsule 100.

As seen in FIG. 18C, capsule 100 includes mixer rod 106 with mixer element 107 disposed at a distal end thereof; bottom opening 113; piston 105; receptacles 102, foil 130, proximal pistons 103, and plate 109 of a proximal pistons arrangement 122, the functions of which have all been previously described. Mixer element 107 may also include sharp tips (not shown).

At FIG. 18D, linear actuator 1106 is lowered, as indicated by the downward pointing arrow. This lowering causes torque arm 1102 to be lowered, such that adapter 1103 is aligned with torque adapter 108. Adapter 1103 is secured to torque adapter 108. The specific securing mechanism may include, for example, one or more pins, slots, or clamps, as illustrated at International Patent Publication WO2020/105053 in FIGS. 14A and 14B. For example, pins of adapter 1103 are inserted into slots of torque adapter 108 and locked by rotation. In another example, adapter 1103 is a clamp which is attached to torque adapter 108 when torque arm 1102 is moved down.

At FIG. 18E, linear actuator 1106 is raised, as indicated by the upward arrow. This, in turn, causes mixer element 107 to be raised relative to piston 105. Optionally, when capsule 100 includes foil 130 and mixer element 107 includes sharp tips, the sharp tips on mixer element 107 burst foil 130. Also, linear actuator 1108 is lowered, as indicated by the downward arrow. This downward movement causes pushing rods 1104 to press against plate 109. The pushing rods 1104 may provide a stabilizing counter-pressure on plate 109 and/or may further push piston 105 upwards.

At FIG. 18F, linear actuator 1106 is further raised, as indicated by the upward arrow, while linear actuator 1108 remains in place. As a result, mixer element 107 pushes piston 105 upward, such that proximal pistons 103 enter receptacles 102 and expel ingredient substances out of receptacles 102. The stabilizing counterpressure of pushing rods 1104 ensures that, when the mixer element 107 is further raised, the internal components of the capsule 100 do not burst through the cover of the capsule 100. Optionally, as discussed above, linear actuator 1108 is lowered in addition or in the alternative, causing proximal pistons 103 to be lowered relative to receptacles 102. Also, as discussed above, one or more frangible receptacles is placed between mixer element 107 and piston 105, and is burst when mixer element 107 and piston 105 are compressed relative to each other. Furthermore, as discussed above, mixer element 107 or proximal pistons 103 may include sharp tips for bursting the ingredient receptacles.

At FIG. 18G, linear actuator 1106 is lowered, thereby lowering torque arm 1102 and mixer element 107. This places the mixer element 107 at a central location within chamber 101, to allow sufficient space within chamber 101 for mixing. Then, rotational actuator 1110 is rotated, causing mixer element 107 to be rotated, as indicated by the curved arrow. This rotation causes the extracted ingredient substances to be mixed into a formulation.

At FIG. 18H, optionally, mixer rod 106 is raised and lowered during the mixing, as indicated by the two-headed arrow. This pushing and pulling of the mixer rod 106 may improve the mixing process and help ensure that a uniform composition is achieved in the formulation.

At FIG. 18I, following completion of the mixing, linear actuator 1106 is further lowered, to cause lowering of the torque arm 1102. As a result, sharp tip 142 (previously described in FIG. 4) is lowered to penetrate or otherwise open a seal closing opening 113 of capsule 100. This permits dispensing of the mixed formulation from the chamber 101.

At FIG. 18J, with the mixer element 107 remaining in place at the bottom of chamber 101, linear actuator 1108 is lowered, as indicated by the downward arrow. As a result, pushing rods 1104 are lowered onto plate 109, causing plate 109 and piston 105 to be lowered downward into chamber 101. As a result of the increase in pressure in chamber 101, the mixed formulation begins to exit the exit opening 113.

At FIG. 18K, linear actuator 1108 is further lowered, causing further depression of plate 109 with pushing rods 1104, until piston 105 is pressed against mixer element 107 at the bottom of the chamber. As a result, all of the mixed formulation is expelled from the chamber 101.

At FIG. 18L, linear actuator 1108 is raised, so as to remove pushing rods 1104 from the capsule 100.

At FIG. 18M, adapter 1102 is disengaged from torque adapter 108, and linear actuator 1106 is raised, thereby permitting the empty capsule 100 to be removed from mixer device 1100.

FIGS. 19A-L illustrate a process of mixing and extracting formulations using mixer device 1200 and capsule 800. Mixer device 1200 operates similarly in many respects to the mixer device described at U.S. Provisional Application 63/030,580 in FIGS. 8A-8M. Mixer device 1200 is particularly suited for selective depression of particular proximal pistons 803 in order to control which ingredient substances are included in a formulation and their respective amounts.

As shown in FIG. 19A, capsule 800 is fixed to mixer device 1200. For example, the first end 812 of capsule 800 is fixed to a tray 1201 of mixing device 1200. The attachment may be through any suitable mechanism, such as through screw threads, protrusions, or clamps, as discussed in connection with tray 1101.

Mixer device 1200, similar to device 1100, further includes a torque arm 1202, with an adapter 1203, for example a clamp or pins, adapted to be attached to torque adapter 808 of capsule 800. The torque arm 1202 is movable linearly by actuator 1206 and rotationally by actuator 1210. Mixer device 1200 also includes pushing rods 1204. In the illustrated embodiment, two pushing rods 1204a and 1204b are shown, each actuated by its own respective linear actuator 1208a and 1208b. In addition, mixer device 1200 has a controller similar to that described in connection with mixer device 1100.

Capsule 800 further includes proximal pistons 803a, 803b, which are separately movable relative to receptacles 802a, 802b in piston 805. While only two proximal pistons 803 and receptacles 802 are visible in the cross-section view of FIG. 19A, there may be, for example, 6 or 8 pairs of proximal pistons 803 and receptacles 802, as discussed above in connection with FIGS. 3A-3D. Capsule 800 further includes mixer rod 806, mixer element 807, and exit opening 813 of chamber 101 at the second end 811. A reservoir 810 has a reservoir bottom opening 814 parallel to exit opening 813, as discussed above in connection with FIGS. 14A and 14B.

At FIG. 19B, linear actuator 1206 is moved upward, as indicated by the upward arrow. This upward movement raises torque arm 1202 such that adapter 1203 is aligned with torque adapter 808. Adapter 1203 is attached to torque adapter 808, for example, in the manner described above in connection with FIG. 18D.

At FIG. 19C, linear actuator 1206 is moved downward, as indicated by the downward arrow. This downward movement lowers torque arm 1202, which correspondingly lowers mixer element 807 so that mixer element 807 comes into contact with piston 805, as shown in FIG. 19D. Optionally, as also shown in FIG. 14C, mixer element 807 includes a nub 844, and piston 805 includes slot 845. At this stage, nub 844 may be inserted into slot 845. Following this insertion, the mixer element 807 and piston 805 are rotationally fixed to each other. Alternatively, this step is unnecessary when the initial state of the capsule 800 has the mixer element 807 positioned so the nub 844 is pre-inserted in slot 845. The correct rotational orientation of mixer element 807 relative to piston 805, and/or the orientation of element 807 and piston 805 relative to the mixer device 1200, may be determined in different ways. For example, this is done by using optical sensor, magnetic sensor, electromagnetic sensor, micro switch, via the orientation of the mixer rod when engaged, and/or any other way, including in a manner similar to those described at U.S. Provisional Application 63/030,580 in FIGS. 11-13.

At FIG. 19E, linear actuators 1208a and 1208b are raised, which correspondingly causes pushing rods 1204a and 1204b to be raised, as indicated by the upward arrow. This, in turn, causes proximal pistons 803a and 803b to rise and expel ingredient substances out of receptacles 802a. 802b. Optionally, the ingredient substances are in frangible containers, as discussed above in connection with FIGS. 5A-5C and 6A-6C. In addition, as shown in FIG. 19D, the linear actuators 1208a and 1208b are separately controlled, enabling pushing rod 1204a to be pushed higher than pushing rod 1204b. As a result, more ingredient substance is pushed out of receptacle 802a than receptacle 802b. Advantageously, the mixer device 1200 is thus able to control a volume of each ingredient substance that is introduced into a formulation.

At FIG. 19F, linear actuators 1208a and 1208b are lowered, causing rods 1204a and 1204b to be lowered, as indicated by the downward arrow. Proximal pistons 803a and 803b remain in place. Proximal pistons 803a and 803b are held in place by any suitable mechanism, for example, due to friction with piston 805, a spring, locking teeth, or any other suitable locking mechanism for preventing retrograde motion. The mechanism may include locking elements such as disclosed at U.S. Provisional Application 63/030,580 in FIGS. 14A and 14B.

At FIG. 19G, rotational actuator 1206 is rotated, causing corresponding rotation of torque arm 1202, mixer rod 806, and piston 805, which, as discussed above, is rotationally fixed to the mixer rod 806. As a result of this rotation, proximal pistons 803c and 803d are now aligned with pushing rods 1204a and 1204b. In alternative embodiments, proximal pistons 803c and 803d may be brought into alignment with pushing rods 1204a, 1204b, through rotation of the entire capsule 800. For example, mixer device 1200 may include a rotatable tray upon which the capsule 800 may be rotated, similar to that disclosed at U.S. Provisional Application 63/030,580 in FIGS. 8A and 8F.

At FIG. 19H, pushing rods 1204a, 1204b are once again raised. This causes proximal pistons 803c, 803d to be pushed into receptacles 802c, 802d, thereby extracting ingredient substances out of the receptacles. Notably, in this example, pushing rod 1204b is raised higher than pushing rod 1204a, causing a larger quantity of substance to be extracted from receptacle 802d than from receptacle 802c. In addition, as seen in the back of capsule 800, proximal pistons 803c and 803f remain at their original heights. The steps at FIGS. 19E and 19F may be repeated additional times in order to extract ingredient substances out of additional receptacles, as desired.

At FIG. 19I, pushing rods 1204a, 1204b are again withdrawn from the capsule 800, similar to FIG. 19E. In addition, rotational actuator 1210 is rotated, thereby rotating piston 805. Piston 805 is rotated to a position whereby the pushing rods 1204a, 1204b are directly aligned with a proximal face of piston 805, rather than any of the proximal pistons 803.

At FIG. 19J, linear actuator 1206 raises torque arm 1202, thereby raising mixer rod 806 and mixer element 807. As a result, mixer element 807 is raised to a more central location within chamber 801, and released from its rotational fixation with the piston 805. Through rotational movement of torque arm 1202 by rotational actuator 1210, mixer element 807 is rotated within the chamber 801, thereby mixing the extracted ingredient substances into a formulation. Optionally, while mixer rod 806 is rotated, mixer rod 806 is moved upward and downward by torque arm 1202, along the axis of mixer rod 806, to move mixer element 807 upward and downward inside chamber 801.

At FIG. 19K, linear actuator 1206 further raises torque arm 1202. This, in turn, raises mixer rod 806 and mixer element 807 to the top of chamber 801. Optionally, sharp tip 842 of mixer rod 806 punctures a membrane sealing exit opening 813, and/or a membrane sealing reservoir bottom opening 814.

At FIG. 19L, linear actuators 1208a, 1208b move pushing rods 1204a, 1204b upwards. The pushing rods 1204a, 1204b push piston 105 upward, as indicated by the arrow, until it is flush with mixer element 807. This, in turn, causes the mixed formulation substance to be extracted from the chamber 801 and into reservoir 810, where it may be accessed by a user. Proximal pistons 803 that were not previously depressed continue to remain in the same positions relative to piston 805, and are raised upward together with piston 805. For example, proximal piston 803e is visible below piston 805. This ensures that no unwanted ingredients enter the formulation mixture when the formulation is extracted into reservoir 810.

FIGS. 20A-20H depict another embodiment of a capsule 700 and a method of mixing substances to make a formulation with capsule 700. Capsule 700 is similar in many respects to the previously described embodiments of capsules, and accordingly similar reference numerals are used to describe similar elements, except that they begin with “7.” Capsule 700 differs from the other embodiments in that instead of a single piston, there are two pistons 705a, 705b, each with ingredient receptacles therein. The embodiment of FIGS. 20A-H is particularly advantageous when many unique ingredients are to be included in the formulation.

As seen in FIG. 20A, piston 705a includes receptacles 702a, which may be penetrated by proximal pistons 703a. Each receptacle 702a is sealed by seal 730a. Piston 705b includes receptacles 702b, which may be penetrated by proximal pistons 703b, and which are sealed by seals 730b. Seals 730a, 730b may be, for example, foils. Mixer element 707 includes sharp tips 726a, which are configured to puncture seal 730a, and sharp tips 726b, which are configured to puncture seal 730b. Mixer element 707 may also optionally include sharp tip 742 at a distal end thereof. Piston 705b also includes a central exit chute 732, which is in fluid communication with exit opening 713.

Capsule 700 may be used with a mixer device similar to any of the mixer devices described above, for mixing ingredient substances into a formulation mixture and extracting the mixture out of the capsule 700.

At FIG. 20B, mixer element 707 is raised relative to piston 705a, as indicated by the upward arrow. As a result, sharp tips 726a penetrate seals 730a.

At FIG. 20C, mixer element 707 is further raised, causing piston 705a to be raised relative to proximal pistons 703a, as indicated by the upward arrow. Pushing rods of the mixer device may supply a counterpressure to hold piston 705a in place. As a result, all of the ingredient substances that had been stored in receptacles 702a are extracted into chamber 701.

At FIG. 20D, mixer element 707 is lowered, as indicated by the downward arrow. Mixer element 707 is lowered sufficiently that sharp tips 726b penetrate seals 730b. Piston 705a remains in its position at the first end 712 of the capsule 700.

At FIG. 20E, mixer element 707 is further lowered, causing piston 705b to be lowered relative to proximal pistons 703b, as indicated by the downward arrow. Proximal pistons 703b are pushed toward the second end 711 of capsule 700, wherein the bottom of chamber 701 supplies a counterpressure. As a result, all of the ingredient substances that had been stored in receptacles 702b are extracted into chamber 701.

At FIG. 20F, mixer element 707 is raised to a central location within chamber 701, as indicated by the upward arrow. Mixer element 707 is rotated within chamber 701, as indicated by the curved arrows, to mix the extracted ingredient substances into a formulation. As seen in this view, each of seals 730b is drawn with a puncture opening, indicating that the seal 730b has been punctured. However, seal 734 of exit chute 732 is still intact. As a result, substances are mixed within chamber 701 without exiting the chamber 701 through exit chute 732.

At FIG. 20G, seal 734 is opened. For example, mixer rod 706 may be lowered to exert sufficient pressure such that sharp tip 742 penetrates seal 734. In such embodiments, seal 734 may be made of a more resilient material than seals 730b, such that seal 734 is not accidentally penetrated at step 20D or 20E. In addition or in the alternative, sharp tip 742 is not as sharp as sharp tips 726b, or is recessed relative to sharp tips 726b. As an alternative mechanism for opening seal 734, a sharp object may be inserted through exit opening 713 and chute 732.

At FIG. 20H, piston 705a is depressed, for example with pushing rods entering the capsule through apertures 728, as indicated by the downward arrow. As a result, piston 705a, mixer element 707, and piston 705b are all compacted at the bottom end 711 of capsule 700. The mixed ingredient substances are extracted through exit chute 732 and bottom opening 713.

Optionally, the mixer rod includes a barcode which may be detected by optical sensor(s) of the mixer device. FIG. 21 depicts a mixer rod 2106 having a barcode 2126 thereon. When a torque arm 1302 of a mixer device 1300 (not shown) is pulling the mixer rod 2106 upwards, the optical sensors 1330 of the mixer device 1300 are reading the barcode 2126. For example, the optical sensors may be emitting light and measuring the light which is reflected from the surface of the mixer rod 2106. Light may be reflected differently from different parts of the barcode. For example, the light is reflected well from the bright areas of the surface of the mixer rod 2106, while not reflecting well from the dark areas of the surface of the mixer rod 2106, thus the sensors may detect the different colors of the barcode 2126. Alternatively, a difference in surface elevation may be used to create differentiation in light reflection. The optical sensor(s) may also include, for example, a laser scanner, a CCD (charge-coupled device) reader, a passive optical sensor and/or any element using any other barcode reading technology.

In this example, the barcode is a linear barcode, wherein the barcode lines are circumferential stripes around the mixer rod 2106. The stripes may be printed on the mixer rod 2106, may be made of material inserted into grooves on the surface of the mixer rod 2106, or may be applied or created in any other way.

The information encoded in the barcode may include information regarding the structure and/or content of the capsule (the ingredient substances). For example, the barcode may include information regarding the length and/or orientation of the capsule, which may be used by the mixer device 1300 to determine the length of movement of the torque arm 1302.

Optionally, the capsule and the mixer device may be operating horizontally. FIG. 22A depicts a horizontal mixer device 1400 which is similar in most respects to the previous embodiments of mixer devices. In particular, the internal components of mixer device 1400 may be identical to any of those described in connection with the other embodiments, and may be used with capsules similar to the capsules described in previous embodiments. FIG. 22A shows a central opening 1409 through which the torque arm 1402 is moving, and peripheral openings 1404 through which pushing rods are moving.

The horizontal mixer device 1400 also includes a shoulder 1401. FIG. 22B depicts the horizontal mixer device 1400 with a capsule 2200 attached. The shoulder 1401 is supporting a rim 2250 of capsule 2200, so the capsule 2200 is secured in place. The rim 2250 is adjacent to the surface of the horizontal mixer device 1400 and the capsule 2200 is aligned to the central opening 1409 and the peripheral openings 1404.

Alternatively, other mechanisms for fixing the capsule 2200 in place may be used, for example, rails on device 1400 on which capsule 2200 may slide, a locking mechanism using half or quarter rotation, screw threads, protrusions, clamps, and/or any other mechanism. Also, the capsule 2200 may be inserted into the mixer device from a side opening or a top opening.

Capsule 2200 may also include an exit opening 2213, for dispensing mixed formulation from the capsule. The exit opening 2213 may have any shape, for example may be structured as a cut on the edge of the capsule 2200. Optionally, the capsule 2200 may be fixed in a specific orientation so the exit opening 2213 is located on the bottom side, to allow direct dropping of the mixed formulation from the capsule. Exit opening 2213 may be sealed, for example with a membrane or any other type of seal. Optionally, the seal may be broken by the blades of the mixer element when the mixer rod is rotating and pushed by the torque arm 1402. Optionally, the blades of the mixer element are serrated, to easily break the seal.

Optionally, the capsule includes a detachable container into which the mixed formulation is pushed. The container is attached to the exit opening of the capsule, so the container is filled with the mixed formulation, and may be then dispensed as needed by a user. The detachable container may be of any size or shape, and may be made of any material, such as plastic, metal, and/or any other material. The detachable container may be flexible and/or rigid.

When the container is flexible, the container may be squeezed and empty of air in an initial state, before being filled with the mixed formulation. This provides a way to avoid a situation where the container is initially filled with air that may push against the mixed formulation. Optionally, the detachable container may include a flexible inner part which air-sealed, for example a plastic bag, and a rigid outer part which is not air-sealed.

Alternatively, some of these embodiments may also be described as a container having a closure (a capsule) which includes

FIG. 23A depicts a capsule 2300 having a squeeze tube 2310 (or “container body”), and FIG. 23B is a cross section drawing of the capsule 2300. Squeeze tube 2310 is attached to the exit opening 2313 via a screw thread 2314. The body 2317 of the capsule 2300 (or “container closure”) serves as a closure for the squeeze tube 2310. After the substances are mixed, the mixed formulation is pushed by the main piston through the exit opening 2313 into the squeeze tube 2310. The exit opening 2313 may be sealed, for example by foil, which is broken by a sharp tip 2342. The seal may include two foil layers, one attached to the body 2317 and one attached to the squeeze tube 2310. Then, a user may detach the squeeze tube 2310 from the body 2317 of the capsule 2300 by a screwing motion, and then dispense and apply the formulation as needed. Optionally, the screw thread 2314 serves as a nozzle for the squeeze tube 2310. Optionally, the squeeze tube 2310 includes a one-way valve for extracting air from the tube. Other types of attachments may be used, for example a clip mechanism.

FIGS. 24A, 24B, 24C and 24D depict a capsule 2400 having a detachable container 2410 which has a stretchable accordion structure. When the detachable container 2410 is filled, it is starched to accommodate the mixed formulation. FIG. 24C is a section view of the capsule 2400 in a starting position, when the ingredient substances are still inside the containers 2402, and detachable container 2410 is shrunken in size. FIG. 24D is a section view of the capsule 2400 in a final position, after the ingredient substances are mixed inside the main chamber 2401 and extracted into the detachable container 2410. In this state, the detachable container 2410 is expanded in size. Optionally, the detachable container 2410 includes a rigid outer shell, for example bottle shaped, to provide structure and/or aesthetic properties for the detachable container 2410 when the detachable container 2410 is empty.

According to some embodiments of the present disclosure, the mixer rod of the capsule moves helically, so the mixer rod moves linearly (optionally in sync with pushing rods), and simultaneously rotating the mixer element to mix the ingredient substances inside the main chamber. Several exemplary embodiments are presented herein, having different mechanisms, and different ways to create the helical movement of the mixer rod. The helical movement is generally created by an arrangement of a leadscrew, screw thread(s), helical grooves and ridges, and/or protrusion(s), which is combining a linear component and a rotational component of the helical movement. Combinations of these embodiments are possible, as well as other structures of capsules and methods of mixing and extracting formulations using the capsules.

FIG. 25 depicts a mixer device 11000 with a capsule 10100. FIGS. 26A-26G illustrate the capsule 10100 and a process of mixing and extracting formulations using mixer device 11000 and capsule 10100. Similar to previously presented mixer devices, mixer device 11000 includes a torque arm 11002 and pushing rods 11004. Unlike previously presented mixer devices, mixer device 11000 includes one motor 11010 which is rotating the torque arm 11002, while simultaneously driving a linear actuator 11006, for example via a timing belt 11011. The linear actuator 11006 is linearly moving both the torque arm 11002 and pushing rods 11004 simultaneously. The linear actuator 11006 converts the rotatory movement of the motor 11010 into linear movement, for example using a leadscrew and nut assembly. Other methods for converting rotatory movement into linear movement may be used. The torque arm 11002 is simultaneously rotated by the motor 11010 and moved linearly by the linear actuator 11006, so the movement of the torque arm 11002 is helical. The pitch of the helical movement of the torque arm 11002 is designed to fit the structure of the capsule 10100. Optionally, the pitch may be adjustable to accommodate capsules of different structures. The torque arm 11002 includes a torque adapter 11003 adapted to engage, but not lock, to torque adapter 10108 of capsule 10100.

Optionally, the linear actuator 11006 also moves a tray pushing rod, simultaneously to the movement of the torque arm 11002 and the pushing rods 11004. The tray pushing rod is pressed against a tray of the mixer device 11000 and preventing the tray from being opened. This locking of the tray may be performed when a capsule 10100 is inside the mixer device 11000, or when the tray is empty.

The capsule 10100 is similar in most respects to the previous embodiments of capsules, and includes a main chamber 10101, a main piston 10105 with cavities 10102, inner pistons 10103, plate structure 10109, and a mixer rod 10106 with a mixer element 10107. The mixer rod 10106 includes a mixer tube 10126 which is adapted to incorporate an exit tube 10144 positioned around the exit opening 10113. Inside the mixer tube 10126 is a sharp tip 10142 which is adapted to break the seal 10145 of the exit tube 10144 and be inserted into exit tube 10144. Optionally, the exit tube 10144 includes a screw thread for connecting a detachable container into which the mixed formulation is pushed, as described above. FIGS. 27A and 27B are perspective and side drawings of the mixer rod 10106 with torque adapter 10108 and mixer element 10107. The torque adapter 10108 includes notches that are adapted to accept protrusions of torque adapter 11003.

At FIG. 26A, the torque arm 11002 and pushing rods 11004 are at a starting point above the capsule.

At FIG. 26B, the torque arm 11002 and pushing rods 11004 are moved downward, so torque adapter 11003 is engaged with the torque adapter 10108.

At FIG. 26C, the torque arm 11002 and pushing rods 11004 are further lowered. Pushing rods 11004 are pushing plate structure 10109 downward, which in turn pushes the inner pistons 10103. This in turn causes ingredient substances to be pushed out of cavities 10102 into the main chamber 10101. During this process, the mixer rod 10106 is rotating so the mixer element 10107 is mixing the ingredient substances inside the main chamber 10101. The mixer rod 10106 is rotated by the torque arm 11002, as the protrusions of torque adapter 11003 are pushing the sides of the notches of torque adapter 10108.

At FIG. 26D, the inner pistons 10103 are at the lowest end of the cavities 10102, and all of the ingredient substances are inside the main chamber 10101. Optionally, also, the protrusions of torque adapter 11003 are at the lowest end of the notches of torque adapter 10108.

At FIG. 26E, the torque arm 11002 and pushing rods 11004 are moved upward and downward multiple times, thereby rotating the mixer element 10107 to mix the ingredient substances inside the main chamber 10101. When moving downward, the torque adapter 11003 may push the mixer rod 10106 downwards, however not enough for the sharp tip 10142 to reach the seal 10145. Optionally, the mixer element 10107 is pushed against the bottom of the main chamber 10101 while rotating, and compress by the pressure. When moving upward, the flexibility of the mixer element 10107 may push the mixer rod 10106 upward against the bottom of the main chamber 10101.

At FIG. 26F, the torque arm 11002 and pushing rods 11004 are further moved downward. This downward movement causes two simultaneous actions. One, the sharp tip 10142 is pushing against the seal 10145 and breaking the seal 10145, thereby allowing mixed formulation to exit from exit opening 10113. Two, the pushing rods 11004 are pushing plate structure 10109, inner pistons 10103 and main piston 10105 downward, thereby pushing the mixed formulation through the exit tube 10144 to exit opening 10113.

At FIG. 26G, the torque arm 11002 and pushing rods 11004 are at the lowest position, the main piston 10105 to the lowest position, and substantially all the mixed formulation is extracted from the capsule.

FIGS. 28A-28H illustrate the capsule 10200 and elements of a mixer device 12000, and a process of mixing and extracting formulations using mixer device 12000 and capsule 10200. Similar to mixer device 11000, mixer device 12000 includes one linear actuator which is linearly moving both an arm 12002 and pushing rods 12004 simultaneously. Unlike mixer device 11000 wherein the torque arm 11002 is moving in a helical motion, in the mixer device 12000 the arm 12002 only moves linearly, along with the pushing rods 12004. Helical movement is created using a screw-like arrangement inside the capsule 10200 which is converting the linear movement of the arm 12002 of the mixer device 12000 into helical movement of the mixer rod 10206.

The arm 12002 includes an adapter 12003 adapted to engage, but not lock, an adapter 10208 of the mixer rod 10206. The mixer device adapter 12003 and the capsule adapter 10208 are structured to allow the mixer rod 10206 to freely rotate relative to the arm 12002, but be linearly locked to the arm 12002, so that the mixer rod 10206 moves linearly with the arm 12002. The engagement between the mixer device adapter 12003 and the capsule adapter 10208 may be done in any way. In this example, the adapter 12003 includes a wide cavity 12051 and a narrow cavity 12052 which are compatible with a wide round element 10251 and a narrow round element 10252. When the capsule 10200 is inserted into the mixer device 12000, the capsule 10200 moves horizontally (as shown by an arrow in FIG. 28B), for example by a tray of the mixer device 12000. Simultaneously, the arm 12002 moves downward (together with the pushing rods 12004), so that the wide round element 10251 is inserted into the wide cavity 12051 and the narrow round element 10252 is inserted into the narrow cavity 12052. FIG. 28C depicts the adapter 12003 and the adapter 10208 in an engaged position. The central aperture 10216 of the cover 10215 is shaped to allow engagement of the adapter 12003 from four different directions relative to the capsule 10200, depending on the orientation of the capsule 10200 relative to the mixer device 12000. The peripheral apertures 10228 of the cover 10215 are aligned to the pushing rods 12004 in all four possible orientations.

FIGS. 28D-28H are section view illustrations. At FIG. 28D, the arm 12002 and pushing rods 12004 are lowered, so the arm 12002 is pushing the mixer rod 10206 and the pushing rods 12004 are inside the peripheral apertures 10228, touching the inner pistons 10203. The cavities 10202 may include channels 10230 which may be sealed, for example by foil. The foil may be broken by any means, as described above for previously presented embodiments.

FIGS. 29A and 29B are illustrations depicting the mixer rod 10206 and the mixer element 10207. The mixer rod 10206 includes protrusions 10246. FIGS. 29C and 29D are illustrations depicting the main piston 10205. The main piston 10205 includes helical grooves 10244 which are disposed at an inner surface of the aperture 10225. When the mixer rod 10206 passes through aperture 10225, the protrusions 10246 of the mixer rod 10206 are engaged inside the helical grooves 10244 of the main piston 10205. The force applied by the arm 12002 on the mixer rod 10206 in the direction of the axis of the mixer rod 10206 (in this case downward) causes the mixer rod 10206 to move helically inside the piston aperture 10225. The helical movement of the mixer rod 10206 is rotating mixer element 10107 so the mixer element 10107 is mixing the ingredient substances inside the main chamber 10101. The mixer element 10107 is separately displaceable relative to the mixer rod 10206 to allow the mixer element 10107 to be moved upward and downward independently. In this example, the mixer element 10107 includes an aperture 10247 through which the sharp tip 10242 is passing.

At FIG. 28E, the arm 12002 and pushing rods 12004 are further lowered. The arm 12002 is pushing the mixer rod 10206, thus also rotating the mixer element 10207. Pushing rods 12004 are pushing the inner pistons 10203 to the lowest end of the cavities 10202, which is causing ingredient substances to be pushed out of cavities 10202 via channels 10230 into the main chamber 10201.

At FIG. 28F, the arm 12002 and pushing rods 12004 are moved upward and downward multiple times, thereby rotating the mixer element 10207 to mix the ingredient substances inside the main chamber 10201. When moving downward, the torque adapter 12003 pushes the mixer rod 10206 downwards, however not enough for the sharp tip 10242 to reach the seal 10245. Optionally, the flexibility the mixer element 10207 allows the mixer element 10207 to compress by the pressure and return upward as described above for the mixer element 10107.

At FIG. 28G, the torque arm 12002 and pushing rods 12004 are further moved downward. This downward movement causes two simultaneous actions. One, the sharp tip 10242 is pushing against the seal 10245 and breaking the seal 10245, thereby allowing mixed formulation to exit from exit opening 10213. Two, the pushing rods 12004 are pushing inner pistons 10203 and main piston 10205 downward, thereby pushing the mixed formulation through the exit opening 10213.

At FIG. 28H, the main piston 10205 is at the lowest position and substantially all the mixed formulation is extracted from the capsule. The arm 12002 and pushing rods 12004 are moved upwards, to allow the capsule 10200 to be extracted from the mixer device 12000. The mixer rod 10206 is pulled upward by the arm 12002, separating from the mixer element 10207 which is left at the bottom of the capsule 10200.

When the capsule 10200 is extracted from the mixer device 12000, the capsule 10200 moves horizontally, while simultaneously, the arm 12002 moves upward (together with the pushing rods 12004). This creates a disengagement action between the mixer device adapter 12003 and the capsule adapter 10208, which is reversed to the engagement action described above, wherein the wide round element 10251 is pulled out of the wide cavity 12051 and the narrow round element 10252 is pulled out of the narrow cavity 12052.

FIGS. 30A-30E illustrate a capsule 10300 and a process of mixing and extracting formulations using mixer device 13000 and capsule 10300. Unlike mixer devices 11000 and 12000, mixer device 13000 does not include pushing rods, only a torque arm 13002. The mixer device 13000 includes one engine which is rotating the torque arm 13002. Helical movement is created using a screw-like arrangement (screw thread) inside the capsule 10300 which is converting the rotational movement of the torque arm 13002 of the mixer device 13000 into helical movement of the mixer rod 10306.

FIG. 30A depicts the capsule 10300 and the torque arm 13002 of the mixer device 13000. The torque arm 13002 is structured to engage into an adapter 10308 of the capsule 10300. In this example, the torque arm 13002 is a hexagonal rod and the adapter 10308 includes a hexagonal cavity into which the torque arm 13002 may be inserted. Other shapes and/or structures of the torque arm and adapter may be used, for example square-shaped rod and cavity or any other connection. The torque arm 13002 may be inserted into the adapter 10308 by a single downward movement, for example initiated by a spring of the mixer device 13000 when the capsule 10300 is inserted into the mixer device 13000.

FIGS. 31A-31C are illustrations depicting a plate 10309, the mixer rod 10206 and the mixer element 10207. The plate 10309 is disposed at the proximal end of a mixer rod 10306, wherein the adapter 10308 includes a cavity which is passing through the plate 10309 and into the mixer rod 10306. The plate 10309 may be part of the mixer rod 10206, may be rigidly connected to the mixer rod 10206, or may be separated from the mixer rod 10206.

FIGS. 30B-30E are section view illustrations. At FIG. 30B the torque arm 13002 is inserted into the adapter 10308. The plate 10309 includes an outer screw thread 10310 on an outer edge of the plate 10309, which is compatible with an internal screw thread 10311 disposed at an inner surface of the main chamber 10301.

When the torque arm 13002 is rotating clockwise, the outer screw thread 10310 is engaged with the internal screw thread 10311, thereby causing the plate and the mixer rod to move helically, similar to the motion of a screw. As shown at FIG. 30C, the helical movement causes two simultaneous actions. One, the plate 10309 is moving downward and pushing the inner pistons 10303 downward, which is causing the ingredient substances to be pushed out of cavities 10302 into the main chamber 10301. Two, the mixer rod 10306 is rotating the mixer element 10307 to mix the ingredient substances inside the main chamber 10301.

At FIG. 30D the inner pistons 10303 are at the lowest end of the cavities 10302, and all of the ingredient substances are inside the main chamber 10301. The mixer rod 10306 is structured so that when the pistons 10303 are at the lowest end of the cavities 10302, the sharp tip 10342 does not reach the seal 10345 so seal 10345 is not broken.

Optionally, the torque arm 13002 is rotating in both directions sequentially, counterclockwise and clockwise, thereby rotating the mixer rod 10306 and the mixer element 10307 to mix the ingredient substances inside the main chamber 10301, while still not breaking the seal 10345.

Then, the torque arm 13002 further rotates clockwise causing two simultaneous actions. One, the sharp tip 10342 is pushing against the seal 10345 and breaking the seal 10345, thereby allowing mixed formulation to exit from exit opening 10313. Two, the plate 10309 is pushing the inner pistons 10303 and the main piston 10305 downward, thereby pushing the mixed formulation through the exit opening 10313.

At FIG. 30E, the main piston 10305 is at the lowest position and substantially all the mixed formulation is extracted from the capsule. The torque arm 13002 is moved upwards by a single upward movement, to allow the capsule 10300 to be extracted from the mixer device 13000.

FIGS. 32A and 32B illustrate a mixer device 14000 and a capsule 10400. The mixer device 14000 operates similarly in many respects to the mixer device 1100 described above, while the capsule 10400 is similar in some respects to capsules described at International Patent Publication WO2020/105053.

Unlike the mixer device 1100, the mixer device 14000 includes a linear actuator 14008 which is linearly moving both the torque arm 14002 and inner pushing rods 14004 simultaneously, via lateral arm 14014. The torque arm 14002 is also rotated by a rotary actuator 14010, so the combined movement of the torque arm 14002 is helical, as described above for the torque arm 11002. A second linear actuator 14006 is moving a set of outer pushing rods 14005 via lateral arm 14016.

Torque adapter 14003 is attached to the lower end of torque arm 14002, and is configured to engage with a torque adapter 10408 of capsule 10400. The mixer device 14000 may also include a controller, a tray, motor(s), and/or any other part not shown in the figures, for example as described for mixer device 1100.

The capsule 10400 includes repository tubular chambers 10402, each containing an ingredient substance and sealed by a repository tubular piston 10403. Passages 10404 are fluidly connecting each repository tubular chamber 10402 to a main chamber 10401.

FIGS. 33A-33E illustrate a process of mixing and extracting formulations using mixer device 14000 and capsule 10400.

At FIG. 33A, the torque arm 14002, pushing rods 14004, and pushing rods 14005 are at a starting point above the capsule 10400.

At FIG. 33B, the pushing rods 14005 are lowered and are pushing the inner pistons 10403. This in turn causes ingredient substances to be pushed out of the repository tubular chambers 10402 via passages 10404 into the main chamber 10401.

At FIG. 33C, the pushing rods 14005 are moved upwards and out of the repository tubular chambers 10402. The torque arm 14002 and pushing rods 14004 are lowered so torque adapter 14003 is engaged with the torque adapter 10408. During this process, the mixer rod 10406 is rotating so the mixer element 10407 is mixing the ingredient substances inside the main chamber 10401. The mixer rod 10406 is rotated by the torque arm 14002, as the protrusions of torque adapter 14003 are pushing the sides of the notches of torque adapter 10408. Optionally, the torque arm 14002 and pushing rods 14004 are moved upward and downward multiple times, thereby rotating the mixer element 10407 to mix the ingredient substances inside the main chamber 10401. When moving downward, the torque adapter 14003 may push the mixer rod 10406 downwards, however not enough for the sharp tip 10442 to reach the seal 10445.

At FIG. 33D, the torque arm 14002 and pushing rods 14004 are further moved downward. This downward movement causes the sharp tip 10442 to break the seal 10445, and the pushing rods 14004 are pushing piston 10405 downward, thereby pushing the mixed substances through the exit tube 10444 to exit opening 10413.

At FIG. 33E, the torque arm 14002 and pushing rods 14004 are at the lowest position and substantially all the mixed substances are extracted from the capsule.

Optionally, the capsule also includes cavities each containing additional ingredient substance, and sealed by inner pistons. The ingredient substances are extracted from the cavities by the pushing rods 14004, as described above for mixer device 11000 and capsule 10100.

According to some embodiments the mixer device includes only a linear actuator for mixing ingredient substances in a capsule, and the linear actuator moves the mixer rod of the capsule upward and downward. In such embodiments, the capsule may optionally include a mixer element that is mixing ingredient substances with linear movement, without rotation. The mixer element may include, for example, one or more plate(s) and/or net(s) which include holes wherein the ingredient substances may be pushed through when the plate(s) and/or net(s) are moved against the main piston, the bottom of the main chamber and/or each other.

According to some embodiments of the present disclosure, the capsule includes a dispensing mechanism to extract the mixed formulation by a user. The dispensing mechanism may be used instead of the extraction of the mixed formulation performed by the mixer device by pushing of the main piston. The dispensing mechanism may include pump(s), roll(s), valve(s), plunger(s) screw(s) and/or any type of mechanism for extracting material out of a container, such as. Below are described capsules having different dispensing mechanisms. The capsules are described at a state wherein a finished mixed formulation is at the main chamber, ready to be dispensed and used by a user, and the capsule is out of the mixer device.

Optionally, the dispensing mechanism is comprised of a hand-operated reciprocating pump. The reciprocating pump may be of any kind, for example airless pump, lotion or cream pump, spray pump, atomizer pump, trigger pump, foam pump, crimp pump, treatment pump, dosing pump, foundation pump push down pump and/or any other dispensing pump.

FIGS. 34A, 34B and 34C are side illustration and two section illustrations, respectively, of a capsule 10500 which includes an airless pump 10510. The capsule 10500 may include a seal 10545 which is broken by the sharp tip 10542 of the mixer rod 10506. When the pushing button 10511 of the airless pump 10510 is pressed by a user, the flexible element 10512 is pushed and creates pressure inside the main chamber 10501. The pressure causes some of the mixed formulation to exit the main chamber 10501 via the nozzle 10513. When the pushing button 10511 is released, the flexible element 10512 is returning to the original position, thus creating sub-pressure inside the main chamber 10501. A one-way valve (not shown) prevents the mixed formulation from returning into the main chamber 10501. The sub-pressure causes the main piston 10505 to move, as shown at FIG. 34C. This process may be repeated until the main chamber 10501 is empty.

Optionally, the main piston 10505 includes a one-way locking element 10516. The locking element 10516 may be moved in the direction of the airless pump 10510, but cannot move in the other direction. For example, the locking element 10516 may be made of metal and include locking teeth 10517 which are pressing on an inner surface of the main chamber 10501. When the main piston 10505 is moved in the direction of the airless pump 10510 the flexibility of locking teeth 10517 causes the locking element 10516 to slide on the inner surface of the main chamber 10501. However, when the main piston 10505 is pushed in the direction away from the airless pump 10510, the locking teeth 10517 are cutting into the inner surface of the main chamber 10501 and preventing any movement.

FIGS. 35A and 35B are side and section illustrations, respectively, of a capsule 10600 which includes a mist spray pump 10610. The mixer rod 10606 also includes a blocked end 10641 which is creating a chamber inside the mixer rod 10606. The mixer rod 10606 also includes an open end 10642 and passages 10643 which fluidly connect the chamber inside the mixer rod 10606 with the main chamber 10601. A tube 10611 of the pump 10610 is positioned inside the mixer rod 10606, having an opening in proximity to the blocked end 10641.

When the formulation is mixed, the capsule is inside the mixing device in an orientation wherein the pump 10610 is at the bottom. When the user is ready to use the mixed formulation, the capsule is held by the user in an orientation wherein the pump 10610 is at the top. In this orientation, the mixed formulation may flow from the main chamber 10601 via the passages 10643 into the now-lower end of the mixer rod 10606.

When a user presses down on the actuator 10612 of the pump 10610, the pump piston 10613 moves to compress the spring 10614 and an upward air pressure draws the ball 10615 upwards, and also the draws mixed formulation into the tube 10611 and subsequently into the pump chamber 10616. This also causes the gasket 10617 to move, allowing air to flow into the main chamber 10601 to replace the mixed formulation. When the user releases the actuator 10612, the spring 10614 returns the pump piston 10613 and the actuator 10612 into the starting position, and the ball 10615 is returned to the resting position wherein it is sealing the pump chamber 10616 and preventing the mixed formulation from flowing back down into the main chamber 10601. When the user presses down on the actuator 10612 again, the mixed formulation that is already inside the pump chamber 10616 is drawn from the pump chamber 10616, through the pump piston 10613 and the actuator 10612, and dispenses out. As mixed formulation is extracted, the mixed formulation which is still in the main chamber 10601 continues to flow into the lower end of the mixer rod 10606, where it is then pulled into the tube 10611, until the capsule is empty of mixed formulation.

FIGS. 36A and 36B are side and section illustrations, respectively, of a capsule 10700 which includes a Roll-on ball 10710. The capsule 10700 may include a seal 10745 which is broken by the sharp tip 10742 of the mixer rod 10706. The ball 10710 may be held in place by a structure 10711. When the ball 10710 is rolling on a user's body, the mixed formulation is flowing from the main chamber 10701 on the surface of the ball 10710 and onto the user's skin. Since the ball 10710 is not sealing the main chamber 10701, air enters the main chamber 10701 when the mixed formulation is extracted, until the main chamber 10701 is empty of mixed formulation.

Optionally, the cover of the capsule and/or the main piston of the capsule include a screw-like arrangement which is creating helical movement relative to the body of the capsule, when the cover and/or main piston is rotated by a user. The helical movement created by the rotation causes the main piston to move towards the exit opening, while pushing the mixed formulation out of the capsule.

It is expected that during the life of a patent maturing from this application many relevant motors, clamps, and actuators will be developed that are suitable for the functions described herein, and the scope of the terms motor, clamp, and actuator is intended to include all such new technologies a priori.

As used herein the term “about” refers to +10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A capsule for mixing substances, comprising:
a chamber having a first end and a second end;
a piston fitted in the chamber, the piston having a proximal end facing the first end, and a distal end facing the second end;
a mixer element arranged within the chamber between the piston and the second end, wherein the mixer element is disposed at a distal end of a mixer rod, and the piston has an aperture through which the mixer rod passes, and wherein the piston and the mixer element are separately displaceable relative to the first and second ends and relative to each other; and
a plurality of cavities within the piston, such that one cavity is separated from another cavity and filled with a different ingredient substance.

2. The capsule of claim 1, wherein each of the plurality of cavities is a cylindrical aperture having a proximal opening at a proximal end of the piston and a distal opening at a distal end of the piston.

3. The capsule of claim 2, wherein at least one of the proximal opening and the distal opening of each of the plurality of cavities is sealed by a frangible seal.

4. The capsule of claim 1, wherein the mixer rod having an adapter disposed at a proximal end thereof which is adapted to connect to an arm of a mixer device and transfer motion from the mixer device to the mixer rod.

5. The capsule of claim 1, further comprising a proximal pistons arrangement closer to the first end than the piston, wherein the proximal pistons arrangement comprises a plurality of proximal pistons, each proximal piston aligned with a respective cavity, such that depression of the proximal pistons relative to the piston causes the proximal pistons to enter the cavities.

6-7. (canceled)

8. The capsule of claim 2, wherein each cavity comprises a frangible container containing an ingredient substance and arranged within the cavity.

9-10. (canceled)

11. The capsule of claim 1, wherein the mixer rod is moving helically relative to the piston and thereby rotating the mixer element.

12. The capsule of claim 11, further comprising a screw-like arrangement of helical grooves and helical ridges which is converting movement of an arm of a mixer device into helical movement of the mixer rod.

13. The capsule of claim 11, wherein helical movement of the mixer rod is created using one of helical grooves and helical ridges of the mixer rod.

14. The capsule of claim 11, wherein helical movement of the mixer rod is created using one of helical grooves and helical ridges rigidly connected to the mixer rod.

15. The capsule of claim 11, wherein the mixer rod is engaged with an arm of a mixer device, wherein the arm is moving helically and thereby causing the mixer rod to move helically.

16. The capsule of claim 11, wherein the aperture includes one of helical grooves, helical ridges, and at least one protrusion; and the mixer rod includes a corresponding one of helical grooves, helical ridges, and at least one protrusion; so that force applied on the mixer rod in the direction of the axis of the mixer rod causes the mixer rod to move helically inside the aperture.

17. The capsule of claim 11, further comprising a plate disposed at the proximal end of a mixer rod which includes an adapter aligned to receive therein an arm of a mixer device and an outer screw thread on an outer edge of the plate, wherein when the arm is rotating, the outer screw thread is engaged with an internal screw thread disposed at an inner surface of the main chamber, thereby causing the plate and the mixer rod to move helically.

18. The capsule of claim 17, wherein when the plate is moving helically, the plate is pushing at least one elongated chamber piston into the at least one elongated chamber to extract the ingredient substance into the main chamber.

19. The capsule of claim 1, wherein the mixer element and the mixer rod are separately displaceable relative to each other.

20-28. (canceled)

29. The capsule of claim 1, further comprising a hand-operated reciprocating pump which is extracting substance from the chamber and out of the capsule.

30. (canceled)

31. A method of mixing substances in a capsule, comprising:
fixing a capsule to a mixer device having a linear actuator, the capsule comprising a chamber having a first end and a second end, a piston fitted in the chamber and having a proximal end facing the first end, and a distal end facing the second end, and a mixer element arranged within the chamber between a distal end of the piston and the second end, wherein the mixer element is disposed at a distal end of a mixer rod, and the piston has an aperture through which the mixer rod passes, and wherein the piston and the mixer element are separately displaceable relative to the first and second ends and relative to each other, and a plurality of cavities within the piston, each filled with an ingredient substance; and
with the linear actuator, extracting the ingredient substances from the plurality of cavities and releasing the ingredient substances into the chamber.

32. The method of claim 31, wherein the capsule further comprises a proximal pistons arrangement closer to the first end than the piston, wherein the proximal pistons arrangement comprises a plurality of proximal pistons, each of the plurality of proximal pistons is aligned with a respective cavity, and the method further comprises moving the plurality of proximal pistons and the piston relative to each other, thereby causing each of the proximal pistons to enter the respective cavity.

33-40. (canceled)

41. A method of assembling a capsule for mixing substances, comprising:
(i) forming a chamber having a first end and a second end;
(ii) inserting a mixer element into the chamber, wherein the mixer element is disposed at a distal end of a mixer rod;
(iii) filling a plurality of ingredient substances into a plurality of cavities within a piston, wherein the piston comprises an aperture; and
(iv) inserting the piston into the chamber such that the piston has a proximal end facing the first end, and a distal end facing the second end, the mixer rod passes through the aperture, and the plurality of cavities are configured between the proximal end of the piston and the mixer element.

42. The method of claim 41, wherein the plurality of ingredient substances are filled inside frangible containers, and the filling step comprises inserting filled frangible containers into the cavities.
